(19) United States
(12) Patent Application Publication
(10) Pub. No.: US 2022/0207570 A1
(43) Pub. Date: Jun. 30, 2022

(54) CONTROL METHOD, PROGRAM, AND TERMINAL

(71) Applicant: LINE CORPORATION, Tokyo (JP)

(72) Inventor: Kazutaka KIMURA, Tokyo (JP)

(73) Assignee: LINE CORPORATION, Tokyo (JP)

(21) Appl. No.: 17/697,457

(22) Filed: Mar. 17, 2022

Related U.S. Application Data
(63) Continuation of application No. PCT/JP2019/051254, filed on Dec. 26, 2019.

(30) Foreign Application Priority Data
Sep. 30, 2019 (JP) 2019-179395

(51) Int. Cl. G06Q 30/02; G06F 3/0485; G06F 3/0488

(52) U.S. Cl. CPC G06Q 30/0273; G06Q 30/0277; G06F 3/0488; G06F 3/0485

(57) ABSTRACT

Methods, devices, and computer-readable mediums for displaying content by a terminal in a display region having a longitudinal direction and a lateral direction are provided. A control method for a terminal for displaying content in a display region of a display of the terminal include: receiving, via a communication device of the terminal, first content data of first content information, the first content information being an image having a first side and a second side that is shorter than the first side; displaying, in a first area of the display region, first information which is a portion of the first content information that is based on the first content data; displaying, in a second area of the display region, second content information, the second area being different from the first area; based on a first input performed by a user of the terminal on the display region, moving, by a controller of the terminal, the first information and the second content information in the display region; and based on a second input performed by the user on the first information, displaying the first content information in the display region with the first side arranged along a longitudinal direction and the second side arranged along a lateral direction.

### CROSS-REFERENCE TO RELATED APPLICATIONS

This application is a Continuation Application of International Application PCT/JP2019/051254, filed on Dec. 26, 2019, which claims priority to Japanese Patent Application No. 2019-179395, filed on Sep. 30, 2019, in the Japan Patent Office, the disclosures of which are incorporated by reference herein in their entireties.

### BACKGROUND

### 1. Technical Field

The present disclosure relates to a control method, a program, and a terminal for displaying content.

### 2. Description of the Related Art

In recent years, there have been more and more opportunities for users to display and browse various types of content such as web pages and advertisements on terminals such as smartphones, mobile phones (feature phones), and computers.

### SUMMARY

According to an aspect of the disclosure, there is provided a control method for a terminal for displaying content in a display region of a display of the terminal, the display region having a longitudinal direction and a lateral direction, the control method including: receiving, via a communication device of the terminal, first content data of first content information, the first content information being an image having a first side and a second side that is shorter than the first side; displaying, in a first area of the display region, first information which is a portion of the first content information that is based on the first content data; displaying, in a second area of the display region, second content information, the second area being different from the first area; based on a first input performed by a user of the terminal on the display region, moving, by a controller of the terminal, the first information and the second content information in the display region; and based on a second input performed by the user on the first information, displaying the first content information in the display region with the first side arranged along the longitudinal direction and the second side arranged along the lateral direction.

According to another aspect of the disclosure, there is provided a non-transitory computer-readable recording medium having recorded thereon a program to be executed by a terminal for displaying content in a display region of a display of the terminal, the display region having a longitudinal direction and a lateral direction, the program, when executed, causing the terminal to: receive, via a communication device of the terminal, first content data of first content information, the first content information being an image having a first side and a second side that is shorter than the first side; display, in a first area of the display region, first information which is a portion of the first content information that is based on the first content data; display, in a second area of the display region, second content information, the second area being different from the first area; based on a first input performed by a user of the terminal on the display region, move, by a controller of the terminal, the first information and the second content information in the display region; and based on a second input performed by the user on the first information, display the first content information in the display region with the first side arranged along the longitudinal direction and the second side arranged along the lateral direction.

According to another aspect of the disclosure, there is provided a terminal for displaying content, the terminal including: a communication device configured to receive first content data of first content information, the first content information being an image having a first side and a second side that is shorter than the first side; a display having a display region having a longitudinal direction and a lateral direction; and a controller configured to: control the display to display, in a first area of the display region, first information which is a portion of the first content information that is based on the first content data; and control the display to display, in a second area of the display region, second content information, the second area being different from the first area; and based on a first input performed by a user of the terminal on the display region, move the first information and the second content information in the display region, and based on a second input performed by the user on the first information, display the first content information in the display region with the first side arranged along the longitudinal direction and the second side arranged along the lateral direction.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram showing an example of a configuration of a communication system according to an aspect of an embodiment;

FIG. 2 is a diagram showing an example of functions realized by a controller of a server according to a first embodiment;

FIG. 3 is a diagram showing an example of information stored in a storage of the server according to the first embodiment;

FIG. 4 is a diagram showing an example of functions realized by the controller of the terminal according to the first embodiment;

FIG. 5 is a diagram showing an example of information stored in the storage of the terminal according to the first embodiment;

FIG. 6 is a diagram showing an example of content information displayed on a display of the terminal according to the first embodiment;

FIG. 7 is a flowchart showing an example of a flow of processing executed by each device according to the first embodiment;

FIG. 8 is a diagram showing an example of a display screen of a terminal according to a second embodiment;

FIG. 9 is a diagram showing an example of the display screen of the terminal according to the second embodiment;

FIG. 10 is a flowchart showing an example of a flow of processing executed by each device according to the second embodiment;

FIG. 11 is a diagram showing an example of a display screen of a terminal according to a third embodiment;

FIG. 12 is a flowchart showing an example of a flow of processing executed by each device according to the third embodiment;

FIG. 13 is a diagram showing an example of a display screen of a terminal according to a third variation;

FIG. 14 is a diagram showing an example of the display screen of the terminal according to the third variation;

FIG. 15 is a diagram showing an example of information stored in a storage of a server according to a fourth embodiment;

FIG. 16 is a diagram showing an example of content information displayed on a display of a terminal according to the fourth embodiment;

FIG. 17 is a diagram showing an example of a display screen of the terminal according to the fourth embodiment;

FIG. 18 is a diagram showing an example of the display screen of the terminal according to the fourth embodiment;

FIG. 19 is a flowchart showing an example of a flow of processing executed by each device according to the fourth embodiment;

FIG. 20 is a diagram showing an example of a display screen of a terminal according to a fifth embodiment;

FIG. 21 is a flowchart showing an example of a flow of processing executed by each device according to the fifth embodiment;

FIG. 22 is a diagram showing an example of a main content database according to a sixth embodiment;

FIG. 23 is a diagram showing an example of a whole advertisement database according to the sixth embodiment;

FIG. 24 is a diagram showing an example of a partial advertisement database according to the sixth embodiment;

FIG. 25 is a diagram showing an example of a relationship between a partial advertisement image and a billing amount according to the sixth embodiment;

FIG. 26 is a figure showing an example of a display screen of a terminal according to a sixth variation;

FIG. 27 is a diagram showing an example of the display screen of the terminal according to the sixth variation;

FIG. 28 is a diagram showing an example of the display screen of the terminal according to the sixth variation;

FIG. 29 is a diagram showing an example of a relationship between a partial advertisement image and a billing amount according to the sixth variation;

FIG. 30 is a diagram showing an example of information arranged in a layer according to a seventh variation;

FIG. 31 is a diagram showing an example of a display screen of a terminal according to the seventh embodiment;

FIG. 32 is a flowchart showing an example of a flow of processing executed by each device according to the seventh embodiment;

FIG. 33 is a diagram showing an example of the display screen of the terminal according to the seventh variation;

FIG. 34 is a diagram showing an example of information arranged in a layer according to the seventh variation;

FIG. 35 is a diagram showing an example of the display screen of the terminal according to the seventh variation;

FIG. 36 is a diagram showing an example of the information arranged in the layer according to the seventh variation;

FIG. 37 is a diagram showing an example of the display screen of the terminal according to the seventh variation;

FIG. 38 is a diagram showing an example of the display screen of the terminal according to the seventh variation;

FIG. 39 is a diagram showing an example of a display screen of a terminal according to an eighth embodiment;

FIG. 40 is a flowchart showing an example of a flow of processing executed by each device according to the eighth embodiment;

FIG. 41 is a diagram showing an example of a main content database according to a ninth embodiment;

FIG. 42 is a diagram showing an example of a main content management database according to the ninth variation;

FIG. 43 is a diagram showing an example of a relationship between a main content category and an advertisement content category according to the ninth variation;

FIG. 44 is a diagram showing an example of an advertisement content management database according to the ninth variation;

FIG. 45 is a diagram showing an example of a relationship between a partial advertisement count, a display position, and a billing amount according to the ninth variation;

FIG. 46 is a flowchart showing an example of a flow of processing executed by each device according to the ninth variation;

FIG. 47 is a flowchart showing an example of a flow of processing executed by a server according to the ninth variation;

FIG. 48 is a flowchart showing an example of the flow of processing executed by each device according to the ninth variation;

FIG. 49 is a flowchart showing an example of the flow of processing executed by the server according to the ninth variation;

FIG. 50 is a flowchart showing an example of the flow of processing executed by the server according to the ninth variation;

FIG. 51 is a flowchart showing an example of a flow of processing executed by each device according to a tenth embodiment;

FIG. 52 is a diagram showing an example of a display screen of a terminal according to the tenth variation;

FIG. 53 is a diagram showing an example of the display screen of the terminal according to the tenth variation;

FIG. 54 is a diagram showing an example of a display screen of a terminal according to an eleventh embodiment;

FIG. 55 is a flowchart showing an example of a flow of processing executed by the terminal according to the eleventh embodiment;

FIG. 56 is a diagram showing an example of a display screen of a terminal according to a twelfth embodiment;

FIG. 57 is a diagram showing an example of the display screen of the terminal according to the twelfth embodiment;

FIG. 58 is a flowchart showing an example of a flow of processing executed by each device according to the twelfth embodiment;

FIG. 59 is a drawing showing an example of a display screen of a terminal according to the twelfth variation;

FIG. 60 is a diagram showing an example of the display screen of the terminal according to the twelfth variation;

FIG. 61 is a diagram showing an example of information arranged in a layer according to the twelfth variation;

FIG. 62 is a diagram showing an example of the display screen of the terminal according to the twelfth variation;

FIG. 63 is a diagram showing an example of the display screen of the terminal according to the twelfth variation;

FIG. 64 is a diagram showing an example of the display screen of the terminal according to the twelfth variation;

FIG. 65 is a flowchart showing an example of a flow of processing executed by each device according to the twelfth variation;

FIG. 66 is a diagram showing an example of a display screen of a terminal according to a thirteenth embodiment;

FIG. 67 is a diagram showing an example of a main content database according to a fourteenth embodiment;

FIG. 68 is a diagram showing an example of a table for setting a playback start condition of a partial moving image according to the fourteenth variation;

FIG. 69 is a diagram showing an example of a table for setting a vertical width of a transparent region according to the fourteenth variation;

FIG. 70 is a diagram showing an example of content information displayed on a display of a terminal according to a fifteenth embodiment;

FIG. 71 is a diagram showing an example of a display screen of the terminal according to the fifteenth embodiment;

FIG. 72 is a diagram showing an example of the display screen of the terminal according to the fifteenth embodiment;

FIG. 73 is a flowchart showing an example of a flow of processing executed by each device according to the fifteenth embodiment;

FIG. 74 is a flowchart showing an example of a flow of processing executed by each device according to the fifteenth embodiment;

FIG. 75 is a diagram showing an example of a main content database according to a sixteenth embodiment; and

FIG. 76 is a diagram showing an example of a partial advertisement database according to the sixteenth embodiment.

### DETAILED DESCRIPTION

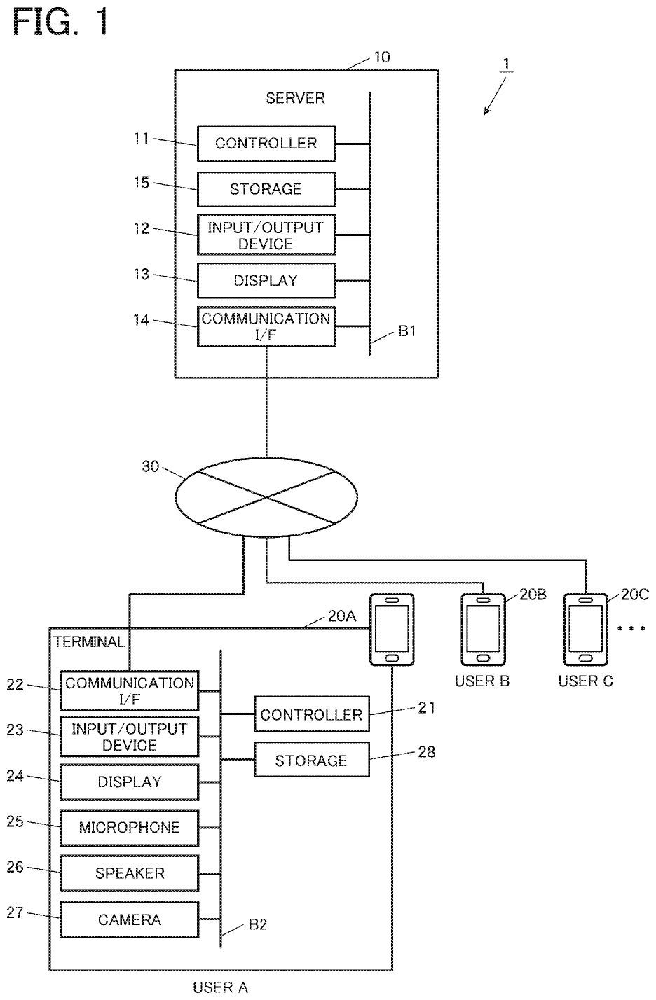

FIG. 1 is a diagram showing an example of a configuration of a communication system 1 according to an embodiment of the present disclosure.

In the communication system 1, a server 10 and terminals 20 (e.g., terminal 20A, terminal 20B, terminal 20C, etc.) are connected to each other via a network 30, for example, without limitation thereto.

The server 10 (a non-limiting example of an electronic device, a server, an information processing device, and an information management device) is configured to distribute various types of content data (a non-limiting example of main content data and advertisement content data) to the terminal 20.

The terminal 20 (a non-limiting example of a terminal or an information processing device) is configured to display information (for example, a web page or an advertisement image) based on various types of content data distributed from an external device, such as the server 10. Alternatively or additionally, the terminal 20 may be further configured to update the information displayed on the display 24 of the terminal 20 based on an operation performed by a user (e.g., user A, user B, user C, etc.).

The network 30 serves to connect one or more servers 10 and one or more terminals 20 to each other. That is, the network 30 refers to a communication network that provides a connection route so that data can be transmitted and received after the above-mentioned various devices are connected.

It is to be understood that there is no limitation on the number of various devices connected to the network 30.

One or more portions of the network 30 may optionally be a wired network and/or a wireless network. Non-limiting examples of the network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of a public switched telephone network (PSTN), a mobile phone network, an integrated service digital network (ISDN), a radio LAN, a long term evolution (LTE) network , a code division multiple access (CDMA) network , a BLUETOOTH™ network, a satellite communication, and/or a combination of two or more of these networks. The network 30 may be constituted by a single network 30 or a plurality of networks 30.

The terminals 20 (e.g., terminal 20A, terminal 20B, terminal 20C, etc.) may be any information processing terminal capable of implementing functions described in the embodiments of the present disclosure. Non-limiting examples of the terminals 20 include a smartphone, a mobile phone (e.g., a feature phone), a computer (non-limiting examples of which include a desktop, a laptop, and a tablet), a media computer platform (non-limiting examples of which include cable and satellite set-top boxes and a digital video recorder), a handheld computer device (non-limiting examples of which include a personal digital assistant (PDA) and an electronic mail client), a wearable terminal (non-limiting examples of which include an eyeglasses-type device, a watch-type device, etc.), and other types of computers and communication platforms. The terminals 20 may also be referred to as “information processing terminals”.

Configurations of the terminals 20A, 20B, and 20C may be substantially the same, or at least similar, as each other. A terminal that is used by a user X will be referred to as a “terminal 20X”, and user information that is associated with the user X or the terminal 20X in a predetermined service will be referred to as “user information X”, as necessary. The user information may be information regarding a user associated with an account that is employed by the user in the predetermined service. Non-limiting examples of the user information include information that is input by the user and/or is assigned by the predetermined service, and is associated with the user, such as a name of the user, an age of the user, a gender of the user, an address of the user, hobbies/preferences of the user, and a user identifier. Alternatively or additionally, the user information may be any one of or a combination of two or more of these pieces of information.

The server 10 (a non-limiting example of a server, an information processing device, or an information management device) may be configured to provide a predetermined service to the terminal 20. The server 10 may be any information processing device capable of implementing functions described in the embodiments of the present disclosure. Non-limiting examples of the server 10 include a server device, a computer (non-limiting examples of which include a desktop, a laptop, and a tablet), a media computer platform (non-limiting examples of which include cable and satellite set-top boxes and a digital video recorder), a handheld computer device (non-limiting examples of which include a PDA and an electronic mail client), and other types of computers and communication platforms. Alternatively or additionally, the server 10 may be referred to as an “information processing device”.

Hardware (HW) Configurations of Devices

HW configurations of the devices included in the communication system 1 are described below.

(1) HW Configuration of Terminal

FIG. 1 shows an example of the HW configuration of the terminal 20.

The terminal 20 includes a controller 21 (e.g., a central processing unit (CPU)), a storage 28, a communication interface (I/F) 22, an input/output (I/O) device 23, a display 24, a microphone 25, a speaker 26, and a camera 27. The HW constituent elements of the terminal 20 are connected (e.g., communicatively coupled) to each other via a bus B2, for example, without limitation thereto. It is to be understood that the HW configuration of the terminal 20 does not necessarily need to include all of the constituent elements. The terminal 20 may optionally be configured such that one or more constituent elements, such as the microphone 25 and the camera 27, are removable.

The communication I/F 22 is configured to transmit and/or receive various types of data via the network 30. The communication may be carried out in a wired and/or wireless manner, and may be based on any communication protocol that enables mutual communication to be carried out. The communication I/F 22 may be configured to communicate with various types of devices such as the server 10 via the network 30. The communication I/F 22 transmits various types of data to the various types of devices, such as the server 10, in accordance with instructions from the controller 21. Alternatively or additionally, the communication I/F 22 receives various types of data transmitted from the various types of devices, such as the server 10, and conveys the received data to the controller 21. In some embodiments, the communication I/F 22 may be referred to as a “communication interface”. In other embodiments, the communication I/F 22 may be referred to as a “communication circuit,” for example, in cases where the communication I/F 22 is constituted by a physically structured circuit.

The input/output device 23 includes a device that inputs various operations made to the terminal 20 and a device that outputs a result of processing performed by the terminal 20. In some embodiments, the input/output device 23 may be constituted by an input device and an output device that are configured as a single device and/or are separate from each other.

The input device may be implemented by any one of or a combination of two or more types of devices capable of accepting input from a user and/or conveying information regarding the input to the controller 21. Non-limiting examples of the input device include a touch panel, a touch display, hardware keys of a keyboard or the like, a pointing device such as a mouse, a camera (input of operations via moving images), and a microphone (e.g., input of operations using sound).

The output device may be implemented by any one of or a combination of two or more types of devices capable of outputting a result of processing performed by the controller 21. Non-limiting examples of the output device include a touch panel, a touch display, a speaker (e.g., audio output), a lens (non-limiting examples of which include three-dimensional (3D) output and hologram output), and a printer.

The display 24 may be implemented by any one of or a combination of two or more types of devices capable of providing display in accordance with display data written in a frame buffer. Non-limiting examples of the display 24 include a touch panel, a touch display, a monitor (non-limiting examples of which include a liquid crystal display and an organic electroluminescence display (OELD)), a head mounted display (HDM), a heads up display (HUD), and devices capable of displaying images, text information, and the like using projection mapping or holograms, or in the air (may optionally be a vacuum). In some embodiments, the display 24 may be capable of displaying display data in a 3D format (e.g., hologram).

If the input/output device 23 is a touch panel, the input/output device 23 and the display 24 may have substantially the same size and shape and be arranged opposing each other.

Non-limiting examples of the controller 21 include a CPU, a microprocessor, a processor core, a multiprocessor, an Application-Specific Integrated Circuit (ASIC), and a Field Programmable Gate Array (FPGA).

The storage 28 is configured to store various programs and various types of data that may be necessary for the terminal 20 to operate. Non-limiting examples of the storage 28 include various storage media such as a Hard Disk Drive (HDD), a Solid State Drive (SSD), a flash memory, a Random Access Memory (RAM), and a Read Only Memory (ROM). In some embodiments, the storage 28 may be referred to as a “memory”.

The terminal 20 stores a program P in the storage 28, and the controller 21 executes the program P to execute processing while serving as units that are included in the controller 21. That is, the program P stored in the storage 28 causes the terminal 20 to implement functions executed by the controller 21. In some embodiments, the program P may be referred to as a “program module”.

The microphone 25 is configured to input audio data. The speaker 26 is—configured to output audio data. The camera 27 may be configured to acquire moving image data. In some embodiments, the camera 27 may be further configured to detect 3D information using invisible light, such as infrared rays.

(2) HW Configuration of Server

FIG. 1 shows an example of the HW configuration of the server 10.

The server 10 includes a controller (e.g., CPU) 11, a storage 15, a communication I/F 14, an input/output device 12, and a display 13. The HW constituent elements of the server 10 are connected to each other via a bus B1, for example, without limitation thereto. It is to be understood that the HW configuration of the server 10 does not necessarily need to include all of the constituent elements. In some embodiments, the HW of the server 10 may be configured such that the display 13 is removable.

The controller 11 may include a physically structured circuit for executing functions that are implemented in accordance with codes or commands included in a program, and may be implemented by a data processing device embedded in hardware, for example, without limitation thereto.

The controller 11 may typically be a CPU, and may optionally be a microprocessor, a processor core, a multiprocessor, an ASIC, or an FPGA. In the present disclosure, the controller 11 is not limited to these examples.

The storage 15 may be configured to store various programs and various types of data that are necessary for the server 10 to operate. The storage 15 is implemented by various storage media such as an HDD, an SSD, and a flash memory. However, in the present disclosure, the storage 15 is not limited to these examples. In some embodiments, the storage 15 may be referred to as a “memory”.

The communication I/F 14 transmit and/or receives various types of data via the network 30. The communication may be carried out in a wired and/or wireless manner, and may be based on any communication protocol that enables mutual communication to be carried out. The communication I/F 14 is configured to communicate with various types of devices such as the terminal 20 via the network 30. The communication I/F 14 transmits various types of data to the various types of devices such as the terminal 20 in accordance with instructions from the controller 11. Alternatively or additionally, the communication I/F 14 receives various types of data transmitted from the various types of devices such as the terminal 20 and conveys the data to the controller 11. In some embodiments, the communication I/F 14 may be referred to as a “communication interface”. In other embodiments, the communication I/F 14 may be referred to as a “communication circuit,” for example, in cases where the communication I/F 14 is constituted by a physically structured circuit.

The input/output device 12 is implemented by a device that inputs various operations that are made to the server 10. The input/output device 12 may be implemented by any one of or a combination of two or more of all types of devices capable of accepting input from a user and conveying information regarding the input to the controller 11. The input/output device 12 may implemented by hardware keys, a typical example of which is a keyboard, and a pointing device such as a mouse. In some embodiments, the input/output device 12 may include a touch panel, a camera (e.g., input of operations via moving images), or a microphone (e.g., input of operations using sound). In the present disclosure, the input/output device 12 is not limited to these examples.

The display 13 may typically be implemented by a monitor (non-limiting examples of which include a liquid crystal display and an OELD). In some embodiments, the display 13 may be implemented by a head mounted display (HDM) or the like. In other embodiments, the display 13 may be configured to display data in a 3D format (e.g., hologram). In the present disclosure, the display 13 is not limited to these examples.

The server 10 stores the program P in the storage 15, and the controller 11 executes the program P to execute processing while serving as units that are included in the controller 11. That is, the program P stored in the storage 15 causes the server 10 to implement functions executed by the controller 11. The program P may optionally be referred to as a “program module”.

(3) Others

Embodiments of the present disclosure will be described assuming that the embodiments are implemented as a result of CPU(s) of the server 10 and/or of the terminal 20 executing the program P.

In some embodiments, the controller 11 of the server 10 and/or the controller 21 of the terminal 20 may implement processing using not only the CPU(s) including a control circuit, but also a logic circuit (e.g., hardware) and/or a dedicated circuit that is formed on an integrated circuit (e.g., an Integrated Circuit (IC) chip or a Large Scale Integration (LSI) chip) or the like. Alternatively or additionally, these circuits may be implemented by one or more integrated circuits, and a plurality of types of processing described in the embodiments may optionally be implemented by a single integrated circuit. LSI may be referred to as Very Large Scale Integration (VLSI), super LSI, ultra LSI, or the like depending on the degree of integration. Accordingly, the controller 11 may optionally be referred to as a “control circuit”.

The program P (non-limiting examples of which include a software program, a computer program, and a program module) in the embodiments of the present disclosure may optionally be provided in a state where the program is stored in a computer-readable storage medium. That is, the program P can be stored in a “non-transitory tangible medium”. Alternatively or additionally, the program P may be a program for implementing some of the functions described in the embodiments of the present disclosure. Furthermore, the program P may optionally be a differential file (e.g., a differential program) that is configured to implement the functions described in the embodiments of the present disclosure in combination with a program P that is already recorded in a storage medium.

The storage medium may include one or more semiconductor-based or other integrated circuits (ICs, non-limiting examples of which include field-programmable gate arrays (FPGAs) and application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, secure digital cards, drives, any other appropriate storage media, and a suitable combination of two or more of these storage media. Where appropriate, the storage medium may consist of a volatile storage medium or a non-volatile storage medium, or a combination of volatile and non-volatile storage media. The storage medium is not limited to these examples, and may be any device or medium that is capable of storing the program P. Alternatively or additionally, the storage medium may be referred to as a “memory”.

The server 10 and/or the terminal 20 can implement functions of a plurality of functional units described in the embodiments by reading the program P stored in the storage medium and executing the read program P.

The program P according to the present disclosure may optionally be provided to the server 10 and/or the terminal 20 via any transmission medium (e.g., a communication network, broadcast waves, etc.) that is capable of transmitting the program. The server 10 and/or the terminal 20 implement the functions of the functional units described in the embodiments by executing the program P downloaded via the Internet or the like, for example, without limitation thereto.

The embodiments of the present disclosure can also be implemented in the form of a non-transitory data signal in which the program P is embodied through electronic transmission.

At least a portion of processing in the server 10 and/or the terminal 20 may be implemented through cloud computing constituted by one or more computers.

At least a portion of processing in the terminal 20 may be carried out by the server 10. In this case, the server 10 may carry out at least a portion of processing carried out by functional units of the controller 21 of the terminal 20.

At least a portion of processing in the server 10 may optionally be carried out by the terminal 20. In this case, the terminal 20 may optionally carry out at least a portion of processing carried out by functional units of the controller 11 of the server 10.

In the embodiments of the present disclosure, configurations for determination are not essential unless explicitly mentioned otherwise, and predetermined processing may be activated in case a determination condition is satisfied, or predetermined processing may be activated in case a determination condition is not satisfied, without limitation thereto.

The program according to the present disclosure may be implemented using a script language such as ActionScript or JavaScript™, a compiler language such as Objective-C or Java™, or a markup language such as HyperText Markup Language 5 (HTML5), for example, although there is no limitation thereto.

Overview

First, an overview of the present embodiment will be described.

Main content data including data relating to a program that is executed by the terminal 20 (non-limiting examples of which include an application of a web browser of the terminal 20) based on a markup language (non-limiting examples of which include HTML5) and data regarding a program executed by the terminal 20 (non-limiting examples of which include an application of a web browser of the terminal 20) based on a scripting language (non-limiting examples of which include JavaScript™) is distributed from the server 10 to the terminal 20, for example, without limitation thereto.

Due to the main content data being distributed to the terminal 20, on the terminal 20, the main content information (non-limiting examples of which include a web page including text or an image) may be displayed by executing the program based on the markup language (non-limiting examples of which include HTML5), and the advertisement content information (non-limiting examples of which include an advertisement image) may be displayed by executing the program based on the scripting language (non-limiting examples of which include JavaScript™).

For example, the terminal 20 to which the main content data is distributed also executes a program that is based on a scripting language (non-limiting examples of which include JavaScript™) associated with the program (HTML5 description) accompanying the program that is based on the markup language (non-limiting examples of which include HTML5) being executed. An advertisement image (e.g., advertisement information) that is based on the advertisement content data (image data) acquired from a Uniform Resource Identifier (URI) designated or generated by the program that is based on the script language (non-limiting examples of which include JavaScript™) is displayed on the terminal 20 (web browser).

Hereinafter, as described above, the main content information is described as being substantially synonymous with a web page, based on a web page including main content information, non-limiting examples of which include text and an image, being displayed by executing the program that is based on the markup language (non-limiting examples of which include HTML5).

Non-limiting examples of the web page include a web page of a news site, a web page of a video distribution site, a web page of a Social Networking Service (SNS) site, a web page of a physical store, a web page of an Electric Commerce (EC) site, a web page of search results that are based on word search, and the like.

The main content information may optionally be information for content that the user intentionally displays on the terminal 20.

The main content data is distributed to the terminal 20 based on the URI designated or generated through an operation performed by the user of the terminal 20, for example, without limitation thereto. This URI includes a URI serving as a link destination that is designated or generated based on (1) link information that is included in a site being browsed by the user (including search results of a web search), (2) link information included in a document being browsed by the user, (3) an access history of a website, and/or (4) a bookmark for a website, and the like.

In the present disclosure, the advertisement content data may include data (e.g., image data) relating to a product or a service, the data being data for content to be distributed to the terminal 20 in association with the main content information (e.g., main content data) based on display of the main content information on the display 24 of the terminal 20, and/or a determination that the main content information is displayed on the display 24 of the terminal 20.

The advertisement content data includes text data, image data, or the like for displaying the advertisement content information that is based on the advertisement content data on the display 24 of the terminal 20, for example, without limitation thereto. The advertisement content data includes image data of the whole advertisement image.

The advertisement content data may optionally include data that is stored in the storage 28 in the initial state of the terminal 20 before the user starts using the terminal 20. Alternatively or additionally, the advertisement content data may optionally include data to be distributed to the terminal 20 based on a URI designated or generated based on the information stored in the storage 28 in the initial state of the terminal 20.

Non-limiting examples of the advertisement content information that is based on the advertisement content data include an advertisement image relating to a product or a service. The advertisement content information may be content information accompanying the main content information.

Alternatively or additionally, although not limited, the advertisement content information may be content information that can be changed according to the terminal on which it is to be displayed, with respect to the same main content information, and may be content information for which a plurality of types can simultaneously be displayed with respect to the same main content information.

### First Embodiment

The first embodiment is an embodiment in which the terminal 20 receives the main content data (a non-limiting example of second content data) and the advertisement content data (a non-limiting example of first content data). The terminal 20 displays, on the display 24, main content information that is based on the received main content data (a non-limiting example of second content information that is based on second content data) and a whole advertisement image (a non-limiting example of first content information that is based on first content data) having a horizontal width and a vertical width corresponding to a display region of the web page displayed as the main content information (a non-limiting example of a horizontal width and a vertical width that are substantially the same as the display region of the web page).

In the first embodiment, the whole advertisement data including the data of the whole advertisement image is transmitted from the server 10 to the terminal 20, and in the terminal 20, the whole advertisement image that is based on the received whole advertisement data is displayed behind the main content information (e.g., web page). The main content information (e.g., web page) has a transparent region, and the user can view the whole advertisement image behind the transparent region through this transparent region. Subsequently, the whole advertisement image is moved together with the main content information according to a scroll operation performed by the user, for example, without limitation thereto.

The features described in the first embodiment can also be applied to and/or combined with other embodiments and variations.

The scroll operation refers to an operation in which the user moves a finger upward or downward while the finger touches the screen.

The scroll operation can also refer to a swipe operation and/or a flick operation.

When the terminal 20 receives the main content data (a non-limiting example of the second content data) from the server 10, the terminal 20 executes a program based on the markup language (non-limiting examples of which include HTML5) and displays a web page (a non-limiting example of second content information) in a web browser, for example, without limitation thereto. In this case, in the web browser, the web page is arranged on the frontmost (nearest) layer on a Z axis in the depth direction of the screen, the layer being perpendicular to a plane formed by an X axis in the lateral direction of the screen and a Y axis in a longitudinal direction of the screen, for example, without limitation thereto.

This layer is information regarding the display position in the Z-axis direction regarding the information to be displayed, which is designated by the program in the markup language (as a non-limiting example, designated by a property of HTML5), for example, without limitation thereto. In the present disclosure, the layers of information to be displayed (non-limiting examples of which include a web page or an advertisement image) being different refers to the display position in the Z-axis direction of the information to be displayed being different.

The terminal 20 executes a program that is based on the script language (non-limiting examples of which include JavaScript'), which is associated with a program that is based on the markup language (non-limiting examples of which include HTML5) accompanying the program being executed, acquires the data of the advertisement image (a non-limiting example of the first content data) from the advertisement server (non-limiting examples of which include the server 10), and arranges the advertisement image based on the data (a non-limiting example of the first content information) in a layer behind the web page, for example, without limitation thereto.

As a result, the advertisement image and the web page are displayed in a superimposed manner on the X-Y plane, and the advertisement image is displayed behind the web page.

In the following description, information arranged in a lower layer (non-limiting examples of which include the first layer) is assumed to be displayed behind (on the far side relative to) information arranged in an upper layer (non-limiting examples of which include the second layer). It is possible to use a configuration in which the larger the value for the Z-axis direction designated by the program in the markup language (non-limiting examples of which include a value of a z-index designated by a property of HTML5), the more the information to be displayed is arranged toward the front (forward) in the Z-axis direction, for example, without limitation thereto.

Alternatively or additionally, non-limiting examples of a web page (e.g., main content information) having a transparent region include at least a portion of an image displayed as a background on a web page being set to a transparent region by a program based on a markup language (non-limiting examples of which include HTML5).

Alternatively or additionally, non-limiting examples of setting the entirety of the main content information (web page) to a transparent region include setting the entirety of an image displayed as a background on a web page to a transparent region by a program based on a markup language (non-limiting examples of which include HTML5).

Alternatively or additionally, non-limiting examples of executing a layer change in which an advertisement image arranged in a lower layer is arranged in an upper layer and a web page arranged in an upper layer is arranged in a lower layer may include switching values relating to the Z-axis direction designated by the program of the markup language (non-limiting examples of which include values of the z-index specified by the HTML5 property).

Alternatively or additionally, one web page may be constituted by the main content information arranged on the front layer and the advertisement image (advertisement information) arranged on the back layer.

Alternatively or additionally, the main content data may include data stored in the storage 28 in the initial state before the user starts using the terminal 20. Alternatively or additionally, the main content data may include data to be distributed to the terminal 20 based on a URI designated or generated based on the information stored in the storage 28 in the initial state of the terminal 20.

Alternatively or additionally, in the embodiments described below, an embodiment assuming a case where the terminal 20 displays various types of web content such as a news site using a web browser (non-limiting examples of which include a web application) will be described, but there is no limitation to this.

It is also possible to apply the present disclosure to a native application that is installed on the terminal 20 and runs on an OS of the terminal 20, for example, without limitation thereto.

In this case, in the native application installed on the terminal 20, information on the transparent region can be associated with the second content information (non-limiting examples of which include content information provided by the application) arranged and displayed in the upper layer, and the user can browse the first content information (non-limiting examples of which include advertisement content information) arranged in the lower layer via the transparent region.

It is also possible to apply the present disclosure to a hybrid application, which is a combination of a web application and a native application.

Functional Configuration

(1) Functional Configuration of Server

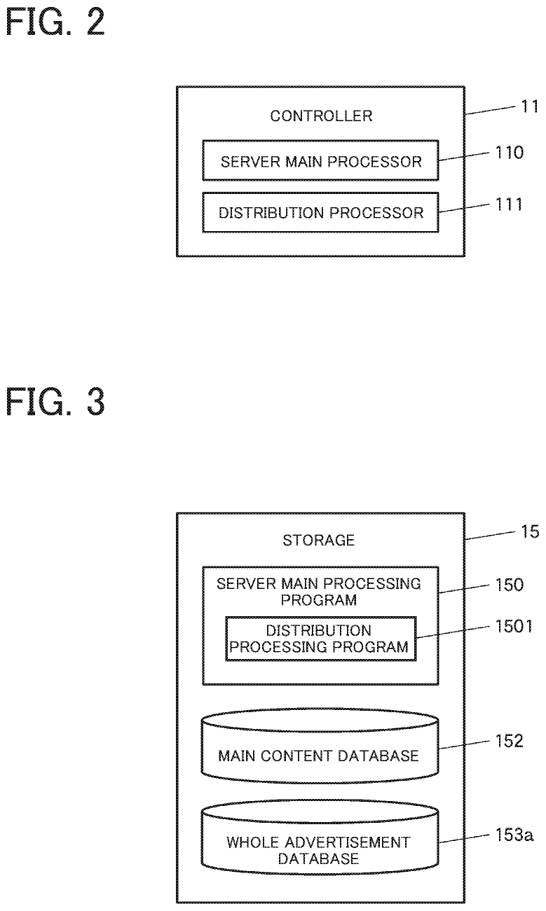

As functions realized by the controller 11, the server 10 has a server main processor 110 and a distribution processor 111, as shown in FIG. 2, for example, without limitation thereto.

The server main processor 110 is configured to execute server main processing, which is processing for comprehensively controlling the server 10, according to a server main processing program 150 stored in the storage 15.

The distribution processor 111 executes distribution processing of content data to the terminal 20 according to a distribution processing program 1501 stored in the storage 15. The distribution processor 111 distributes the main content data stored in the storage 15 to the terminal 20 and distributes the advertisement content data stored in the storage 15 to the terminal 20, for example, without limitation thereto.

As shown in FIG. 3, the storage 15 of the server 10 stores the server main processing program 150, which is read by the controller 11 and executed as the server main processing, as a program, for example, without limitation thereto. Alternatively or additionally, the server main processing program 150 includes, as a subroutine program, the distribution processing program 1501 that is read by the controller 11 and is executed as distribution processing.

Alternatively or additionally, the storage 15 stores a main content database 152 and a whole advertisement database 153a as data, for example, without limitation thereto.

The main content database 152 is a database that cumulatively stores the main content data. The server 10 selects the requested main content data from the main content data stored in the main content database 152 based on a main content distribution request transmitted from the terminal 20, and distributes the requested main content data to the requesting terminal 20.

The whole advertisement database 153a is a database that cumulatively stores the whole advertisement data including the data of the whole advertisement image.

When the whole advertisement data is distributed to the terminal 20, the whole advertisement image is displayed in the entire display region (hereinafter referred to as “page display region” as appropriate) of the web page in the web browser, for example, without limitation thereto.

In this example, the display 24 has a screen with a vertical width that is larger than its horizontal width, and the page display region is also a display region with a vertical width that is larger than its horizontal width. For this reason, the whole advertisement image is also an image with a vertical width that is larger than its horizontal width.

The whole advertisement image is an example of advertisement content information that is based on the whole advertisement data, and may be a still image or a moving image.

Alternatively or additionally, the display 24 may optionally be configured to have a screen with a horizontal width that is larger than its vertical width.

Alternatively or additionally, a display region with a horizontal width that is larger than its vertical width may optionally be formed as the page display region.

Alternatively or additionally, an image with a horizontal width that is larger than its vertical width may optionally be applied as the whole advertisement image.

The features described in this embodiment may also apply to other embodiments and each variation described hereinafter.

The main content database 152 stores an advertisement number according to which it is possible to identify the advertisement content data (including the whole advertisement data) in association with the main content data, for example, without limitation thereto. As a result, the main content information to be displayed on the terminal 20 that is the distribution target and the advertisement content information (including the whole advertisement image) to be displayed in association with the main content information are associated with each other.

(2) Functional Configuration of Terminal

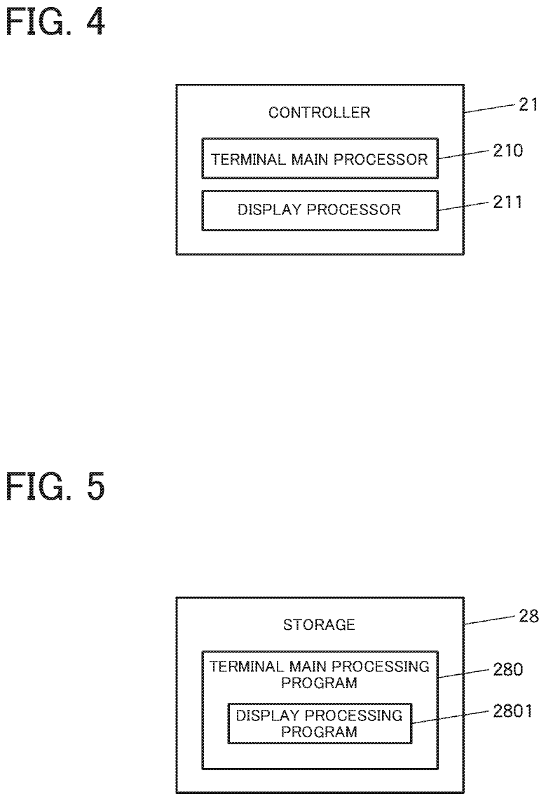

As functions realized by the controller 21, as shown in FIG. 4, the terminal 20 has a terminal main processor 210 and a display processor 211, for example, without limitation thereto.

The terminal main processor 210 is configured to execute terminal main processing, which is processing for comprehensively controlling the terminal 20, according to the terminal main processing program 280 stored in the storage 28. If the terminal 20 is a mobile phone, control for making a call with another mobile phone, a fixed telephone, or the like via the communication I/F 22 is performed, control for accessing various websites via the communication I/F 22 is performed, control for displaying various types of information on the display 24 is performed, processing for analyzing various types of sound data input from the microphone 25 is performed, or processing for analyzing still images and moving images captured using the camera 27, or the like is executed, for example, without limitation thereto.

The display processor 211 executes display processing of various types of content information including the main content information and the advertisement content information in the display 24 according to a display processing program 2801 stored in the storage 28. Performing control for displaying the web page of the main content information on the web browser corresponds to an example of processing for displaying the main content information on the display 24, and performing control for displaying the advertisement content information (whole advertisement image) associated with the web page of the main content information on the web browser corresponds to an example of processing for displaying the advertisement content information on the display 24.

As shown in FIG. 5, the storage 28 of the terminal 20 stores, as a program, the terminal main processing program 280, which is read out by the controller 21 and executed as the terminal main processing, for example, without limitation thereto. Alternatively or additionally, the terminal main processing program 280 includes, as a subroutine program, the display processing program 2801 to be read out by the controller 21 and executed as display processing.

Display Screen Example

In the following description, on the screen of the display 24, the direction from the top portion [TOP] to the final portion [END] of the main content information (the direction from the upper side to the lower side of the web browser) is described as a screen downward direction, and the opposite direction is described as a screen upward direction. Alternatively or additionally, the direction from the left side to the right side of the main content information (the direction from the left side to the right side of the web browser) is described as a screen rightward direction, and the opposite direction is described as a screen leftward direction.

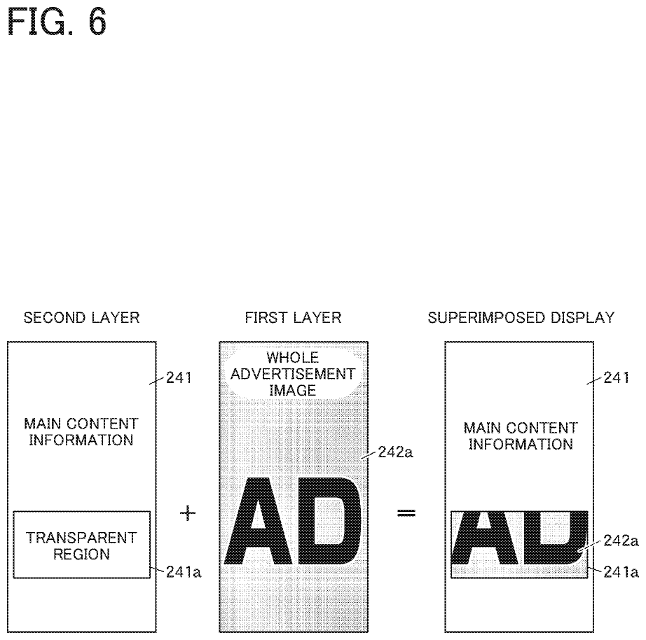

FIG. 6 is an illustrative diagram showing the relationship between the information arranged in the first layer and the information arranged in the second layer in this example.

In this embodiment, based on the terminal 20 receiving the main content data, the main content information (e.g., web page 241) based on the main content data is arranged in the second layer, and the whole advertisement image 242a based on the whole advertisement data distributed in association with the main content data is arranged in the first layer, which is lower than the second layer.

A transparent region 241a is formed in the main content information in some cases, and when the main content information having the transparent region 241a is arranged in the second layer, the image arranged in the first layer, which is lower than the second layer, may be viewed via the transparent region 241a.

In this example, a portion of the whole advertisement image 242a arranged in the first layer overlaps with the transparent region 241a. As such, the user can see a portion of the whole advertisement image 242a via the transparent region 241a together with the main content information.

Processing

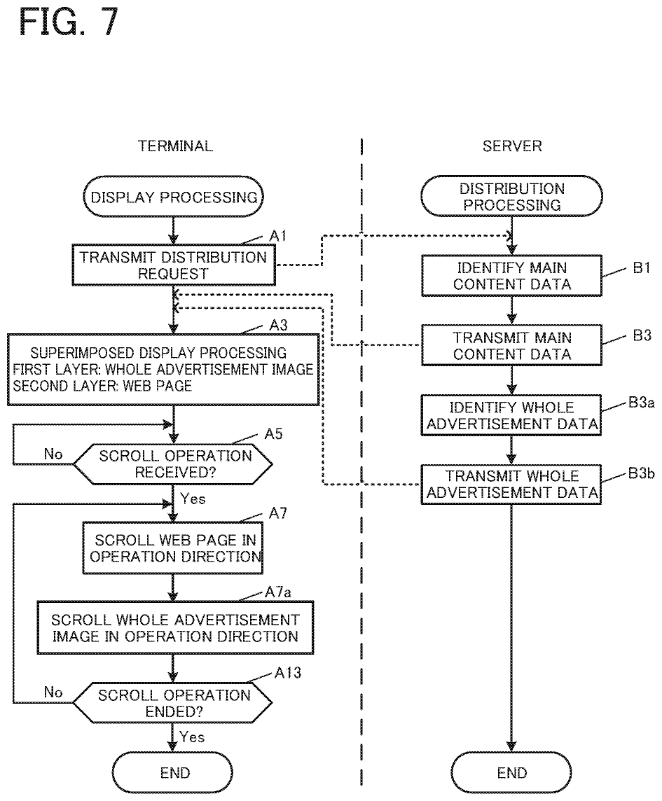

FIG. 7 is a flowchart showing an example of a flow of processing executed by each device in this embodiment.

In this figure, the distribution processing executed by the distribution processor 111 of the server 10 is shown on the right side, and the display processing executed by the display processor 211 of the terminal 20 is shown on the left side.

Each step in each process is indicated by a combination of uppercase letters and numbers, and the word “step” is omitted in the present specification.

Alternatively or additionally, all of the flowcharts described below merely illustrate the processing in each embodiment, and in the flowcharts described below, some steps need not be executed, and additional steps may be inserted.

Alternatively or additionally, the processing of the terminal 20 described below may be processing in which all steps are executed by the application of the web browser installed in the terminal 20, or may be processing in which some steps are executed by the application of the web browser. Alternatively or additionally, the processing of the terminal 20 does not necessarily need to be processing executed by the application of the web browser installed in the terminal 20.

First, when the user of the terminal 20 performs an operation for accessing a site to be browsed (non-limiting examples of which include a bookmark selection operation or a link information selection operation), the terminal 20 transmits a distribution request including the URI of the site that is the access destination to the server 10 using the communication I/F 22 (via the communication I/F 22) (A1).

When the server 10 receives a distribution request from the terminal 20 using the communication I/F 14 (via the communication I/F 14), the server 10 identifies the main content data to be distributed from the main content database 152 based on the received distribution request (B1). Then, the main content data to be distributed (non-limiting examples of which include data relating to the web page 241 of the news site) is transmitted to the terminal 20 through the communication I/F 14 (B3).

Alternatively or additionally, the server 10 identifies the whole advertisement data associated with the main content data to be distributed from the whole advertisement database 153a (B3a). Then, the identified whole advertisement data (non-limiting examples of which include the data of the whole advertisement image 242a) is transmitted to the terminal 20 through the communication I/F 14 (B3b), and the distribution processing ends.

It is to be understood that the distribution method for the main content data and the advertisement content data is not limited to such a method. After the main content data is distributed from the server 10 to the terminal 20, a distribution request for the advertisement content data associated with the main content data (non-limiting examples of which include the advertisement content data associated with the URI included in the main content data or the URI generated based on the program included in the main content data) is transmitted to the server 10, for example, without limitation thereto. Then, the server 10 may optionally distribute the advertisement content data to the terminal 20 based on the distribution request for the advertisement content data.

Alternatively or additionally, the main content data and the advertisement content data may optionally be distributed to the terminal 20 from different server devices. The server 10 may optionally be constituted by a plurality of server devices including a main content server and an advertisement content server, for example, without limitation thereto.

The main content server that received the distribution request for the main content data from the terminal 20 may optionally identify the main content data corresponding to the distribution request from the main content database and distribute the identified main content data to the terminal 20. The terminal 20 that received the main content data from the server 10 may optionally transmit a distribution request for the advertisement content data associated with the main content data (non-limiting examples of which include the advertisement content data associated with the URI included in the main content data or the URI generated based on the program included in the main content data) to the advertisement content server. The advertisement content server that received the distribution request of the advertisement content data from the terminal 20 may optionally identify the advertisement content data corresponding to the distribution request from the advertisement content database and distribute the identified advertisement content data to the terminal 20, for example, without limitation thereto.

When the terminal 20 receives the main content data and the whole advertisement data from the server 10, the terminal 20 may arrange the whole advertisement image 242a based on the whole advertisement data in the first layer and arranges the web page 241 based on the main content data in the second layer, for example, without limitation thereto (A3).

As a result, the web page 241 is superimposed on the whole advertisement image 242a. In the first layer, the bottom side of the whole advertisement image 242a is arranged along the bottom side of the page display region, for example, without limitation thereto, and therefore at the time of A3, the whole advertisement image 242a is arranged in the entire page display region.

Since the web page 241 (main content information) has the transparent region 241a, the user can view a portion of the whole advertisement image 242a via the transparent region 241a.

After A3, the terminal 20 determines whether or not a scroll operation has been performed (A5).

If a scroll operation has not been performed (A5: No), the scroll operation is waited for.

If a scroll operation has been performed (A5: Yes), the web page 241 is moved in the direction of the scroll operation (A7). Alternatively or additionally, the whole advertisement image 242a is moved in the direction of the scroll operation together with the web page 241 (A7a).

Thereafter, the terminal 20 determines whether or not the scroll operation has ended (A13).

If the scroll operation has ended (A13: Yes), display processing is ended.

If the scroll operation has not ended (A13: No), the processing is returned to A7.

### Effects of First Embodiment

In the first embodiment, the terminal 20 displays a partial region (a non-limiting example of first information) of the whole advertisement image 242a (a non-limiting example of first content information) in at least the page display region (a non-limiting example of a display region of a terminal), and displays the main content information (web page) (a non-limiting example of second content information) that is superimposed on at least a portion of the whole advertisement image 242a, and at least partially includes the transparent region 241a, in the page display region. Alternatively or additionally, a configuration is shown in which the terminal 20 executes control for moving in the page display area on the transparent region 241a and at least a portion of the whole advertisement image 242a based on the scroll operation (a non-limiting example of first input) performed by the user on the page display region.

As an example of an effect obtained by such a configuration, at least a portion of the second content information and the first information move in the display region based on the first input to the display region, and therefore linkage can be generated between at least a portion of the second content information and the first information, and the display effect of the information on the terminal can be improved.

Revenue Resulting from Advertisement Provision

In this example and the examples described below, a business operator who provides second content (non-limiting examples of which include a web page for business news) can obtain performance-based compensation from an advertiser, for example, without limitation thereto.

Specifically, the number of instances of accessing a web page that is provided by a business operator and on which an advertisement image of the advertiser can be viewed via a transparent region is aggregated by the server 10, for example, without limitation thereto. Then, based on the aggregation result, the business operator that provides the second content can receive compensation from the advertiser (e.g., an affiliate).

More specifically, the amount of money agreed upon between the business operator providing the second content and the advertiser can be billed to the advertiser by the business operator for each instance of accessing the web page, and the advertiser can pay the billing amount to the business operator, for example, without limitation thereto.

By doing so, the business operator that provides the second content (non-limiting examples of which include a web page for business news) can obtain a profit (compensation) based on the advertisement image of the advertiser being displayed.

### Second Embodiment

The second embodiment is an embodiment in which first information (non-limiting examples of which include a portion of a whole advertisement image 242a), which is a portion of advertisement content information (a non-limiting example of first content information) and a transparent region (an entire transparent region or a portion of a transparent region) of the main content information (a non-limiting example of second content information) are moved according to a scroll operation (a non-limiting example of first input) performed by a user, based on superimposition of the first information and the transparent region on each other.

The second embodiment differs from the first embodiment in that control for moving in the display region in a state in which at least a portion of the first information overlaps with the transparent region is executed in the terminal 20 based on the positional relationship between the transparent region and the first information and the first input.

The features described in the second embodiment can also be applied to and/or combined with other embodiments and variations.

Constituent elements that are the same as those already mentioned are denoted by the same reference numerals, and redundant description thereof is omitted.

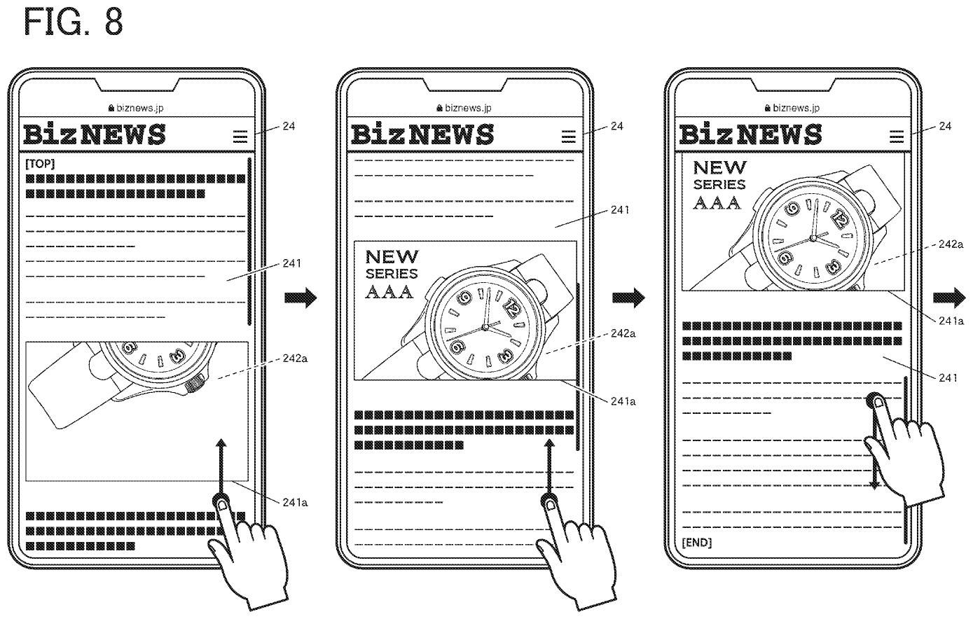

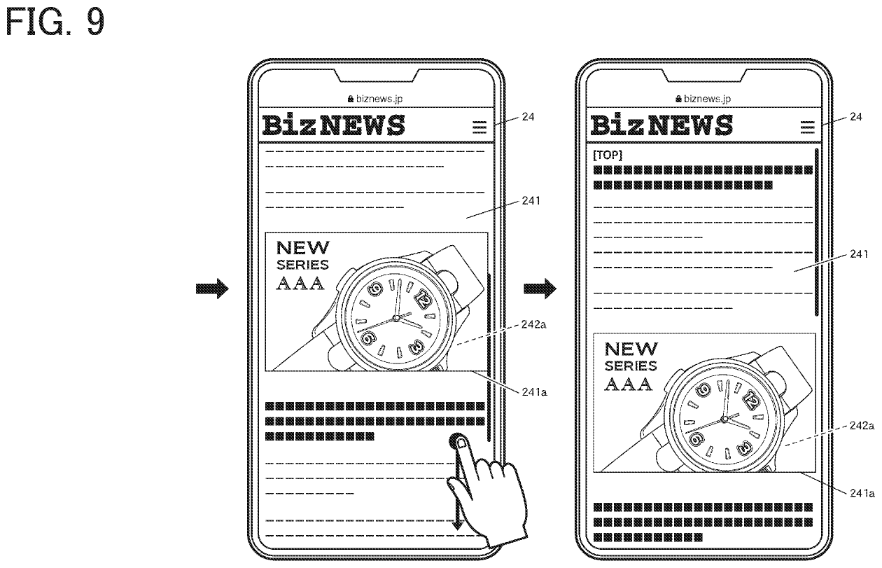

In the examples shown in FIGS. 8 and 9, the whole advertisement image 242a is arranged as the advertisement content information in the first layer, and the web page 241 for the business news site is arranged as the main content information in the second layer. The web page 241 includes text (a non-limiting example of text information included in the second content information) and images (a non-limiting example of image information included in the second content information) that constitute a news article, but these are all arranged in the second layer.

The page display region is a vertically elongated region with a vertical width that is longer than its horizontal width, and the whole advertisement image 242a is a vertically elongated image with a vertical width that is longer than its horizontal width. In this example, the whole advertisement image 242a is an image of an analog wristwatch. This whole advertisement image 242a includes the appearance and product name of the analog watch as information, as well as a release date and website information.

As shown in FIG. 8, due to the user accessing the business news site using the web browser of the terminal 20, the web page 241 is displayed in the page display region, and a portion of the whole advertisement image 242a becomes visible via the transparent region 241a. In such an example, the transparent region 241a is a horizontally elongated region with a horizontal width that is larger than its vertical width.

In this example, the vertical width of the web page 241 is larger than the vertical width of the page display region, and therefore the entirety of the web page 241 cannot fit in the page display region. As a result, a portion of the web page 241 including the top portion [TOP] of the web page 241 is initially displayed in the page display region, and the rest including the final portion [END] of the web page 241 is not displayed. The described state of the web page 241 is a state in which the web page 241 is in the initial position.

If the web page 241 is in the initial position, the user touches the page display region (i.e., a region different from the transparent region 241a) and performs a scroll operation of moving his or her finger in the screen upward direction, whereby the web page 241 scrolls in the screen upward direction. Accompanying this, the transparent region 241a moves to a position of overlapping with a region of interest of the whole advertisement image 242a.

Here, the region of interest is a region set for the purpose of attracting the attention of the user (e.g., an area to which the attention of the user is to be drawn), and is a region that corresponds to a portion of the whole advertisement image 242a (a non-limiting example of first information that is a portion of first content information). The region of interest is a region set in the whole advertisement image 242a, and can be set in advance by the advertiser, for example, without limitation thereto.

Alternatively or additionally, the region-of-interest information for identifying the region of interest (non-limiting examples of which include vertex coordinates of the region of interest, center coordinates of the region of interest, etc.) is information associated with the whole advertisement image 242a. The area-of-interest information can be stored as metadata of the whole advertisement image 242a, for example, without limitation thereto.

As a result, in the terminal 20 that has received the whole advertisement image 242a, the region of interest of the whole advertisement image 242a can be identified.

Here, the position of the whole advertisement image 242a with respect to the transparent region 241a is fixed based on movement of the transparent region 241a to a position overlapping with the region of interest of the whole advertisement image 242a.

That is, the relative positions of the main content information of the second layer and the advertisement content information of the first layer are fixed based on the region of interest of the whole advertisement image 242a being included in the transparent region 241a.

In this example, the region of the watch face portion is set as the region of interest of the whole advertisement image 242a. As a result, the position of the whole advertisement image 242a with respect to the transparent region 241a is fixed based on the watch face portion becoming visible, and that is likely to be noticed by the user.

When the user continues the scrolling operation and moves the final portion [END] of the web page 241 to the page display region, the transparent region 241a and the whole advertisement image 242a move in the screen upward direction in a fixed state accompanying the web page 241 scrolling in the screen upward direction. Accordingly, the user can continuously view the region of interest via the transparent region 241a.

Alternatively or additionally, when the user switches to the scroll operation in the screen downward direction, as shown in FIG. 9, the transparent region 241a and the whole advertisement image 242a move in the screen downward direction in a fixed state accompanying the web page 241 scrolling in the screen downward direction.

Furthermore, due to the user continuing the scrolling operation and moving the top portion [TOP] of the web page 241 to the uppermost portion of the page display region, the web page 241 returns to the initial position.

Even if the web page 241 has returned to the initial position, the user can continue to view the region of interest via the transparent region 241a.

In this manner, if the web page 241 is at the initial position, and if the transparent region 241a and the whole advertisement image 242a have not yet been fixed (see FIG. 8), the portion other than the region of interest is viewed via the transparent region 241a. However, if the transparent region 241a and the whole advertisement image 242a are fixed (see FIG. 9), the region of interest is viewed via the transparent region 241a.

Processing

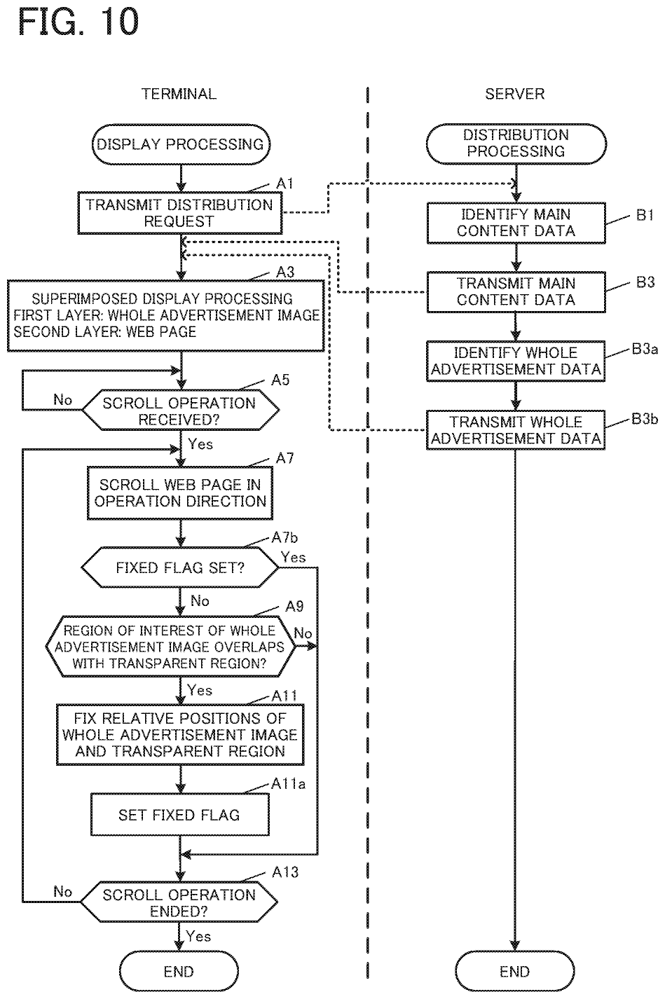

FIG. 10 is a flowchart showing an example of a flow of processing executed by each device in this embodiment.

In this diagram, the distribution processing executed by the distribution processor 111 of the server 10 is shown on the right side, and the display processing executed by the display processor 211 of the terminal 20 is shown on the left side.

The flowchart of FIG. 10 is a flowchart in which step A7a in the flowchart of FIG. 7 is replaced with A7b to A11a.

When the user of the terminal 20 performs an operation for accessing a site to be browsed (non-limiting examples of which include a bookmark selection operation or a link information selection operation), the terminal 20 transmits a distribution request including the URI of the site that is the access destination to the server 10 through the communication I/F 22 (via the communication I/F 22) (A1).

When the server 10 receives a distribution request from the terminal 20 through the communication I/F 14, the server 10 executes the same processing as B1, B3, B3a and B3b shown in FIG. 7 based on the received distribution request and ends the distribution processing.

When the terminal 20 receives the main content data and the whole advertisement data from the server 10, terminal 20 arranges the whole advertisement image 242a based on the whole advertisement data in the first layer, and the web page 241 based on the main content data is arranged in the second layer (A3).

As a result, the web page 241 is superimposed on the whole advertisement image 242a. In the first layer, the bottom side of the whole advertisement image 242a is arranged along the bottom side of the page display region, and therefore, at the time of A3, the whole advertisement image 242a is arranged in the entire page display region.

Since the web page 241 has the transparent region 241a, the user can view a portion of the whole advertisement image 242a via the transparent region 241a.

The terminal 20 determines whether or not a scroll operation has been performed (A5).

If the scroll operation has not been performed (A5: No), the terminal 20 waits for the scroll operation.

If a scroll operation has been performed (A5: Yes), the terminal 20 moves the web page 241 in the direction of the scroll operation (A7).

Next, the terminal 20 determines whether or not the fixed flag has been set (A7b).

The “fixed flag” in this process may refer to a flag set when the relative positions of the whole advertisement image 242a and the transparent region 241a are fixed. After this fixed flag is set, the web page 241 is moved in the direction of the scroll operation while the relative position of the transparent region 241a with respect to the whole advertisement image 242a is fixed.

If the fixed flag is set (A7b: Yes), the processing is advanced to A13.

If the fixed flag has not been set (A7b: No), it is determined whether or not the region of interest of the whole advertisement image 242a is superimposed on the transparent region 241a as a result of the web page 241 scrolling (A9). In A9, it is determined whether or not the entirety of the region of interest is included in the transparent region 241a, for example, without limitation thereto.

It is to be understood that there is no limitation to this, and it may optionally be determined whether or not a predetermined percentage (non-limiting examples of which include 70%) of the vertical width of the region of interest overlaps with the transparent region 241a, for example, without limitation thereto.

If the region of interest overlaps with the transparent region 241a (A9: Yes), the terminal 20 fixes the relative position of the transparent region 241a with respect to the whole advertisement image 242a (A11), sets a fixed flag (A11a), and advances the processing to A13.

If the processing of A11 and A11a has been executed, thereafter, even if the scroll operation is performed and the web page 241 scrolls, the region of the whole advertisement image 242a that is viewed via the transparent region 241a does not change from the region of interest.

If the region of interest of the whole advertisement image 242a does not overlap with the transparent region 241a (A9: No), the terminal 20 advances the processing to A13.

The terminal 20 determines whether or not the scroll operation has ended (A13).

If the scroll operation has not ended (A13: Yes), the processing ends.

If the scroll operation has not ended (A13: No), the processing is returned to A7.

It is to be understood that in this processing, it was assumed that the relative position of the transparent region with respect to the whole advertisement image is fixed on condition that the region of interest overlaps with the transparent region, but the present disclosure is not limited to this.

Specifically, the condition may optionally be that a portion of the whole advertisement image overlaps with the transparent region, for example, without limitation thereto.

Alternatively or additionally, the condition may optionally be that the distance between the region of interest and the transparent region is a set distance or less (or less than a set distance), for example, without limitation thereto.

### Effects of Second Embodiment

The second embodiment shows a configuration in which the terminal 20 displays at least the region of interest (a non-limiting example of first information) of the whole advertisement image 242a (a non-limiting example of first content information) in at least the page display region (a non-limiting example of a display region of a terminal), and displays main content information (a non-limiting example of second content information), which is superimposed on at least a portion of the region of interest and at least partially includes the transparent region 241a, in the page display region. Alternatively or additionally, the terminal 20 executes control for moving in the page display region based on a scroll operation (a non-limiting example of first input) performed on the page display region by the user, on at least a portion of the transparent region 241a and the region of interest.

As an example of an effect obtained by such a configuration, at least a portion of the second content information and the first information move in the display region based on the first input to the display region, and therefore linkage can be generated between at least a portion of the second content information and the first information, and the display effect of the information on the terminal can be improved.

The second embodiment shows a configuration in which control for moving the region of interest in the page display region is executed based on the positional relationship between the transparent region 241a and the region of interest and the scroll operation.

As an example of the effect obtained by such a configuration, by executing control for moving the first information in the display region based on the positional relationship between the transparent region and the first information and the first input, it is possible to improve the display effect of information on the terminal.

The second embodiment indicates a configuration in which control for moving the region of interest on the page display region is executed based on movement of the transparent region 241a on the page display region based on the scroll operation, and superimposition of at least a portion of the transparent region 241a on the region of interest.

As an example of the effect obtained by such a configuration, the transparent region and the first information can be integrated.

The second embodiment shows a configuration in which control for moving the region of interest in the page display region is executed in a state where at least a portion of the region of interest is superimposed on the transparent region 241a based on the scroll operation.

As an example of the effect obtained by such a configuration, it is possible to further integrate the transparent region and the first information.

The second embodiment shows a configuration in which the controller 21 executes control for moving in the page display region on the transparent region 241a and the region of interest based on the direction of the scroll operation.

As an example of the effect obtained by such a configuration, by changing the direction of the scroll operation, it is possible to change the movement direction of the transparent region and the first information, and the attention of the user can be continuously drawn to the first information.

The second embodiment shows a configuration in which the transparent region 241a and the region of interest are moved in a direction based on the scroll operation.

As an example of the effect obtained by such a configuration, the attention of the user can be continuously drawn to the first information due to the transparent region and the first information moving in the direction intended by the user.

The second embodiment shows a configuration in which the transparent region 241a and the region of interest are moved based on a scroll operation in a direction along the longitudinal direction of the display region.

As an example of the effect obtained by such a configuration, it is possible to increase the movement distance of the first information, and as a result, the first information is viewed for a long period of time, and therefore the display effect can be improved.

The second embodiment shows a configuration in which the first content information is advertisement information (non-limiting examples of which include the whole advertisement image 242a), and the first information (non-limiting examples of which include the region of interest) is a portion thereof.

As an example of the effect obtained by such a configuration, it is possible to generate linkage between the transparent region and the advertisement information and improve the advertisement effect.

The second embodiment shows a configuration that includes the terminal 20 receiving the second content data (non-limiting examples of which include main content data) through the communication I/F 22, and in which the second content information (non-limiting examples of which include a web page for business news or the like) is based on the second content data.

As an example of the effect obtained by such a configuration, the second content information can be displayed based on the data received from outside of the terminal.

The second embodiment shows a configuration in which the second content information (non-limiting examples of which include a web page for business news) includes text information or image information, and the transparent region 241a does not include text information or image information.

As an example of the effect obtained by such a configuration, it is easier to distinguish between the second content information and the first information that can be viewed via the transparent region.

Second Variation (1)

In the second embodiment, an example was shown in which the web page 241 is superimposed on the entirety of the whole advertisement image 242a, but there is no limitation to such a configuration, and the web page 241 may be superimposed on only a portion of the whole advertisement image 242a.

The web page 241 may be superimposed only on a portion of the region of interest, and the web page 241 may not be superimposed on the other portion of the region of interest, for example, without limitation thereto.

Second Variation (2)

In the second embodiment, an example was shown in which the entirety of the transparent region 241a is moved using the scroll operation, but there is no limitation to such a configuration, and a portion of the transparent region 241a may move according to the scroll operation.

In the second embodiment, an example was shown in which the transparent region 241a on the web page 241 and other regions (text, images, etc. of a news article) move together due to a scroll operation, but there is no limitation to such a configuration, and the transparent region 241a may move independently of the other regions.

When the scroll operation is performed, the transparent region 241a may move while the other regions (text, images, etc. of the news article) may not move, for example, without limitation thereto. In such a configuration, the main content information (text, images, etc. of the news article) in the other regions may be prevented from being arranged on the movement path of the transparent region 241a in advance, and may move in the regions that do not overlap with the transparent region 241a accompanying the movement of the transparent region 241a.

Second Variation (3)

In the second embodiment, the first content information is advertisement information, but the first content information is not limited to advertisement information and may be other content information. The first content information may be content information relating to the second content information, and if the second content information is the text of the news article, the first content information may be a news image relating to the news article and the first information may be a portion of the news image, for example, without limitation thereto.

As an example of the effect obtained by such a configuration, it is possible to diversify the display mode of the information related to the second content information.

Second Variation (4)

In the second embodiment, an example was shown in which the relative positions of the transparent region 241a and the whole advertisement image 242a are fixed based on the transparent region 241a being superimposed on the region of interest.

This also means that the scroll speeds of the transparent region 241a and the whole advertisement image 242a based on the subsequent scroll operation are the same.

There is no limitation to such a configuration, and the scroll speeds of the transparent region 241a and the whole advertisement image 242a based on the scroll operation need not be the same. As an example, the scroll speed of the transparent region 241a based on the scroll operation may be faster than the scroll speed of the whole advertisement image 242a.

Conversely, the scroll speed of the transparent region 241a based on the scroll operation may be slower than the scroll speed of the whole advertisement image 242a.

However, it is assumed that at least the transparent region 241a and the whole advertisement image 242a move in the same direction (scrolling direction) due to the scroll operation.

As an example of the effect obtained by such a configuration, it can be clarified that the transparent region 241a and the whole advertisement image 242a are arranged in different layers.

It is to be understood that there is no limitation to the above configuration, and due to the scroll operation, the transparent region 241a may be moved in the scroll direction specified by the scroll operation, whereas the whole advertisement image 242a may be moved in the direction opposite to the scroll direction.

Second Variation (5)

In the second embodiment, an example was shown in which the region of interest is not superimposed on the transparent region 241a of the web page 241 in the state where the web page 241 is in the initial position, but there is no limitation to such a configuration, and the region of interest may already be superimposed on the transparent region 241a in the state where the web page 241 is in the initial position.

That is, even if the scroll operation is performed while the web page 241 is in the initial position, the whole advertisement image 242a may move together with the transparent region 241a according to the scroll operation.

Second Variation (6)

In the second embodiment, the region of interest was the central region of the whole advertisement image 242a, but the region of interest may be any of the upper region, the central region, and the lower region of the whole advertisement image 242a. Alternatively or additionally, the region of interest is not limited to a rectangular region, and may be a region within an outline of a feature portion of an image (non-limiting examples of which include the region of the watch face portion of the wristwatch). Alternatively or additionally, the region of interest may not include a plurality of pixels, and may be a region composed of only the pixel located at the center coordinates of the whole advertisement image 242a, for example, without limitation thereto.

In the second embodiment, an example was shown in which the region of interest is a region set by the advertiser, but the present disclosure is not limited in this regard, and the region may be automatically set by the terminal 20 or the server 10. For example, if the terminal 20 or the server 10 cannot identify the region-of-interest information associated with the whole advertisement image 242a (including a case where the region of interest is not set), the pixel at the center coordinates of the whole advertisement image 242a may be set to the region of interest, for example, without limitation thereto. That is, the default region of interest in the whole advertisement image 242a may be the central region including the center coordinates.

Alternatively or additionally, the terminal 20 or the server 10 may set the region of interest by executing image processing targeting the whole advertisement image 242a, and estimating the contour of the feature portion through edge detection using filtering or the like, for example, without limitation thereto. Alternatively or additionally, if the whole advertisement image 242a is a moving image, a region in which the difference (variation) in pixel values is large between prior and subsequent images based on the display order or between prior and subsequent frames based on the display order may be estimated as a feature portion, and the region of interest may be set so as to include the estimated feature portion, for example, without limitation thereto. Alternatively or additionally, the region of interest may be an area that can be set by the user of the terminal 20 by operating the terminal 20.

Second Variation (7)

In the second embodiment, the region-of-interest information for identifying the region of interest is stored as the metadata of the whole advertisement image 242a, but there is no limitation to such a mode. The region-of-interest information may be stored in association with the image identification information of the whole advertisement image 242a in the whole advertisement database 153a in which the whole advertisement image 242a is accumulated, for example, without limitation thereto. Then, when the whole advertisement image 242a is transmitted to the terminal 20, the region-of-interest information associated with the image identification information of the whole advertisement image 242a may be transmitted in association with the whole advertisement image 242a. As a result, in the terminal 20 that has received the whole advertisement image 242a, the region of interest of the whole advertisement image 242a can be identified.

### Third Embodiment

A third embodiment is an embodiment in which the terminal 20 makes the entirety of the whole advertisement image 242a (a non-limiting example of first content information) visible based on a touch operation (a non-limiting example of second input) performed by a user on a region of interest (a non-limiting example of first information) of the whole advertisement image 242a. The control of the third embodiment is executed after the execution of superimposed display processing (A3) shown in FIG. 10, for example, without limitation thereto.

The third embodiment is an embodiment in which control for making the entirety of the second content information visible based on the second input has been added to the control of the terminal 20 in the second embodiment.

The features described in the third embodiment can also be applied to and/or combined with other embodiments and variations.

Constituent elements that are the same as those already described are denoted by the same reference numerals, and redundant description thereof is omitted.

Display Screen Example

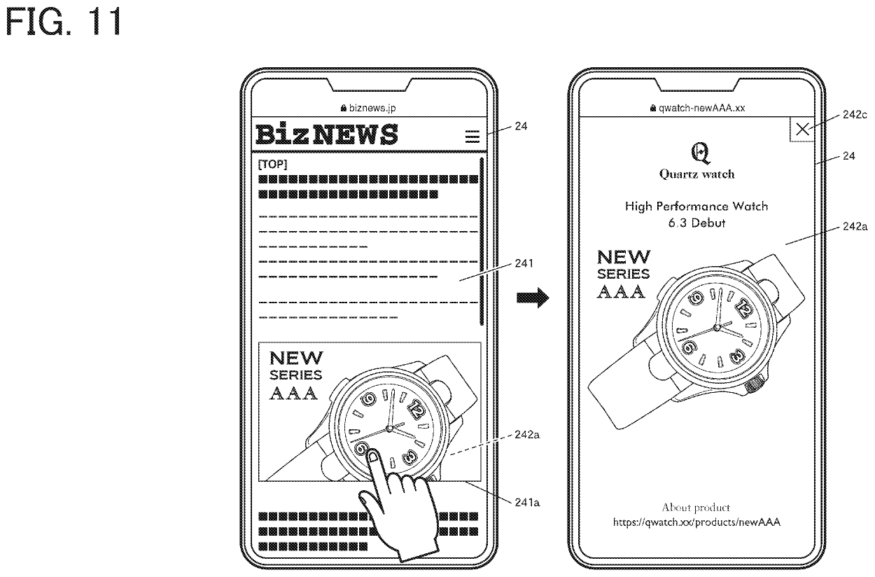

In the display screen shown in FIG. 11, the transparent region 241a and the region of interest are fixed due to the scroll operation having been performed after the superimposed display processing (A3) is executed (A11). For this reason, although the web page 241 is in the initial position, the region of interest is visible via the transparent region 241a.

In this state, the user can view the entirety of the whole advertisement image 242a including the region of interest by performing a touch operation (a non-limiting example of second input performed on the first information) of touching the region of interest on the touch panel.

The whole advertisement image 242a is an image including a region of interest and a region different from the region of interest. In this example, the only information included in the region of interest is the appearance and product name of the analog wristwatch. In contrast to this, the whole advertisement image 242a includes the appearance and product name of the analog wristwatch in the central portion, and includes the product release date at the upper portion, and the website information at the lower portion.

Processing

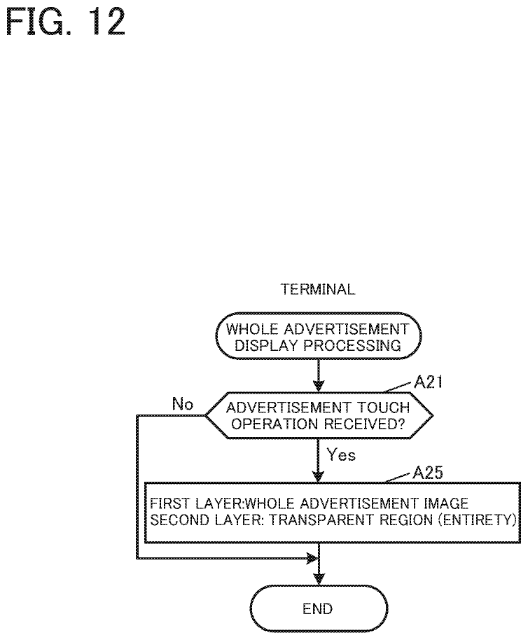

FIG. 12 is a flowchart showing an example of a flow of whole advertisement display processing, which is an example of processing executed by the display processor 211 of the terminal 20 in this embodiment.

The whole advertisement display processing can be executed after the fixed flag is set (after A11 in FIG. 10), for example, without limitation thereto.

It is to be understood that the whole advertisement display processing can be executed as processing that is based on a subroutine program of the display processing program 2801, for example, without limitation thereto.

The terminal 20 determines whether or not a touch operation (second input) has been performed in a state where the transparent region 241a and the region of interest of the whole advertisement image 242a are superimposed on each other (A21).

It is to be understood that the user performing the touch operation (second input) also corresponds to performing an operation of touching the transparent region 241a superimposed on the region of interest.

If the user has not performed a touch operation (A21: No), the terminal 20 ends the whole advertisement display processing.

On the other hand, if a touch operation has been performed by the user (A21: Yes), the terminal 20 returns the whole advertisement image 242a to the position at the beginning of distribution (non-limiting examples of which include the position of A3 in FIGS. 7 and 10). That is, in the first layer, the bottom side of the whole advertisement image 242a is rearranged along the bottom side of the page display region. Alternatively or additionally, the terminal 20 sets the entire web page 241 arranged in the second layer in the transparent region 241a (A25). Then, the terminal 20 ends the whole advertisement display processing.

As a result, the whole advertisement image 242a arranged in the first layer can be viewed by the user.

### Effects of Third Embodiment

The third embodiment shows a configuration in which the display region of the display 24 is a vertically elongated region with a vertical direction that is longer than its horizontal direction, and the whole advertisement image 242a (a non-limiting example of the first content information) that is based on the whole advertisement data has a first side in the vertical direction and a second side in the horizontal direction that is shorter than the first side, and the whole advertisement image 242a is displayed in the page display region with the first side arranged along the longitudinal direction of the page display region and the second side arranged along the lateral direction of the page display region.

As an example of the effect obtained by such a configuration, the user can view the vertically elongated first content information.

The third embodiment shows a configuration in which control for making the whole advertisement image 242a visible to the user of the terminal 20 is executed by the controller 21 based on the touch operation (a non-limiting example of second input) performed on the region of interest (a non-limiting example of first information).

As an example of the effect obtained by such a configuration, the user can be allowed to view the entirety of the first content information based on the second input. Alternatively or additionally, a user who is interested in the first information can be guided to the first content information, which has a higher display effect, for example, without limitation thereto.

The third embodiment shows a configuration in which processing for setting the region of interest in the second layer in which the main content information is arranged as the transparent region (a non-limiting example of processing for making the second content information transparent) is executed by the controller 21 based on the touch operation (second input) performed on the region of interest.

As an example of the effect obtained by such a configuration, it is possible to allow the user to view the entirety of the first content information according to simple processing. Alternatively or additionally, the first content information can be made visible without performing processing for changing the layer in which the first content information is arranged to the second layer, which is higher than the first layer, or the like, for example, without limitation thereto.

The third embodiment shows a configuration in which the second input is input performed through an operation of touching the region of interest that is visible via the transparent region 241a.

As an example of the effect obtained by such a configuration, the first content information, which has a higher display effect, can be displayed due to the user touching the display region.

Third Variation (1)

In the third embodiment, the entirety of the whole advertisement image 242a was made visible due to the entire region of the web page 241 arranged in the second layer being set as the transparent region 241a in the state where the whole advertisement image 242a is arranged in the first layer, but there is no limitation to such a configuration. Based on a touch operation (second input) performed by the user, the whole advertisement image 242a may be arranged in the second layer, and a web page including the transparent region 241a may be arranged in the first layer.

That is, the entirety of the advertisement information can be made visible due to layer change processing for swapping between the advertisement information arranged in the first layer and the main content information arranged in the second layer (a non-limiting example of processing for changing from the second content information displayed in the display region to the first content information) being performed based on the second input, and the advertisement information being arranged in a layer higher than that of the main content information as a result.

As an example of the effect obtained by such a configuration, the first content information can be made visible without changing the transparent region.

As another example, the whole advertisement image 242a arranged in the first layer may optionally be made visible by entering a state in which the main content information arranged in the second layer is erased and the main content information is not arranged in the second layer, based on the second input.

Third Variation (2)

In the third embodiment, the web page 241 arranged in the second layer may be made visible again based on the elapse of a predetermined period (predetermined amount of time) after the processing of A25 was executed and the whole advertisement image 242a became visible, or the fact that the user has executed an operation for making the main content information visible again.

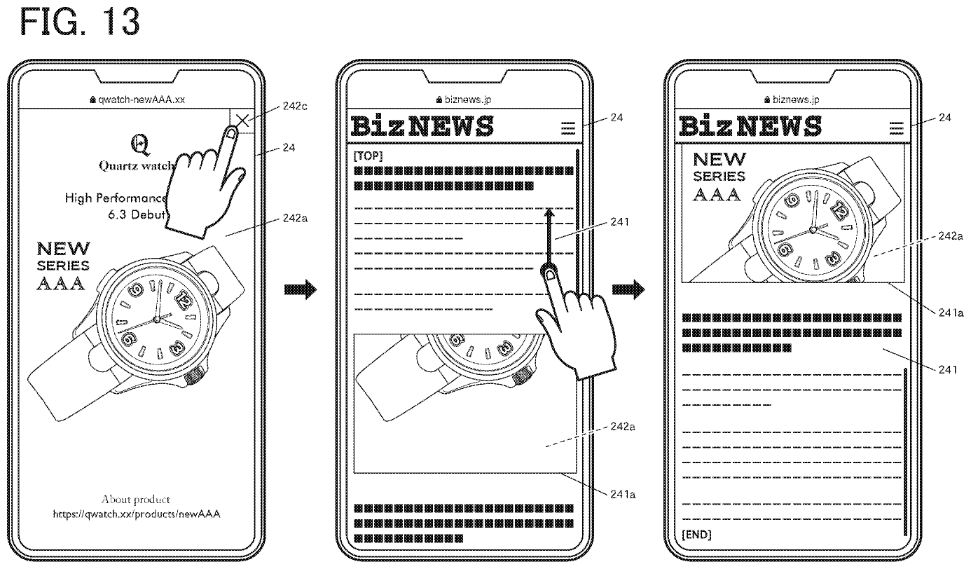

The transparent region setting in the second layer can be erased and the web page 241 in the second layer can be made visible again by the user touching an erase icon 242c shown as “x”, which is displayed in the upper right portion of the whole advertisement image 242a shown in FIG. 13, for example, without limitation thereto. At this time, the web page 241 in the second layer is in a state of being superimposed on the whole advertisement image 242a in the first layer, and a portion of the whole advertisement image 242a can be viewed via the transparent region 241a.

That is, regarding the third variation (1) as well, the web page 241 arranged in the first layer may be made visible by being temporarily arranged in the second layer again based on the elapse of a predetermined period (predetermined amount of time) after the whole advertisement image 242a became visible, or the user performing an operation for making the main content visible again.

If the user touches the erase icon 242c shown as “x” displayed in the upper right portion of the whole advertisement image 242a shown in FIG. 13, the main content information may be made visible due to a layer change of swapping the main content information displayed in the first layer and the advertisement information displayed in the second layer being executed and the main content information being arranged in the layer above that of the advertisement information again as a result, for example, without limitation thereto. At this time, the web page 241 in the second layer is in a state of being superimposed on the whole advertisement image 242a in the first layer, and a portion of the whole advertisement image 242a can be viewed via the transparent region 241a.

Each of the above-described variations shows a configuration in which the whole advertisement image 242a (a non-limiting example of the first content information) is displayed in the page display region, and main content information (web page 241) (a non-limiting example of the second content information) that is superimposed on at least a portion of the whole advertisement image 242a and at least partially includes the transparent region 241a is displayed in the page display region.

As an example of the effect obtained by such a configuration, the user can browse the second content information again even after the first content information is displayed in the entire display region. Alternatively or additionally, a portion of the first content information can be viewed by the user via the transparent region.

Third Variation (3)

The following configuration may be added to the configuration shown in the third variation (2), in which the whole advertisement image 242a is displayed in the page display region, and the main content information (web page 241) that is superimposed on at least a portion of the whole advertisement image 242a and at least partially includes the transparent region 241a is displayed in the page display region.

As shown in FIG. 13, due to the user moving the transparent region 241a through a scroll operation, the relative positions of the transparent region 241a and the whole advertisement image 242a may be fixed again based on the transparent region 241a and the region of interest of the whole advertisement image 242a being superimposed, and the transparent region 241a and the whole advertisement image 242a may move based on the scroll operation thereafter, for example, without limitation thereto.

Third Variation (4)

In the third embodiment, the entirety of the second layer becomes the transparent region 241a (A25) and the entirety of the whole advertisement image 242a becomes visible based on the second input (A21) being performed after the relative positions of the transparent region 241a and the whole advertisement image 242a are fixed (after A11), but even if the second input is performed at a stage before the transparent region 241a and the region of interest are superimposed, that is, at a stage before the relative positions of the transparent region 241a and the whole advertisement image 242a are fixed (before A11), the processing of A25 is not executed and the entirety of the whole advertisement image 242a does not become visible.

There is no limitation to such a mode, and even in the stage before the relative positions of the transparent region 241a and the whole advertisement image 242a are fixed (before All), the processing of A25 may be executed and the entirety of the whole advertisement image 242a may be made visible based on the second input being performed.

In the third variation (1), the entirety of the whole advertisement image 242a becomes visible due to the layer change of the first layer and the second layer being performed and the whole advertisement image 242a moving to the second layer based on the second input (A21) being performed after the relative positions of the transparent region 241a and the whole advertisement image 242a are fixed (after A11), but even if the second input is performed at a stage before the transparent region 241a and the region of interest are superimposed, that is, a stage before the relative positions of the transparent region 241a and the whole advertisement image 242a are fixed (before All), the above-described layer change is not executed and the entirety of the whole advertisement image 242a does not become visible.

There is no limitation to such a mode, and even in the stage before the relative positions of the transparent region 241a and the whole advertisement image 242a are fixed (before A11), the above-described layer change may be performed and the entirety of the whole advertisement image 242a may be made visible based on the second input being performed.

In these examples, the whole advertisement image 242a may be displayed based on the second input performed on the region that is visible via the transparent region 241a and that is different from the region of interest, in the state where the web page 241 is in the initial position, for example, without limitation thereto.

As an example of the effect obtained by such a configuration, if the user is interested in the advertisement before seeing the region of interest, the whole advertisement image 242a can be displayed at that stage.

Third Variation (5)

In the example shown in FIG. 11, the whole advertisement image 242a is a still image, but there is no limitation to this, and the whole advertisement image 242a may be a moving image.

The whole advertisement image 242a before the second input (non-limiting examples of which include the touch operation of A21) is performed is the first image of an animated GIF (animated Graphic Interchange Format), and the entirety of the whole advertisement image 242a may be displayed and moving image playback of the animated GIF may be executed based on the second input being performed, for example, without limitation thereto.

Alternatively or additionally, the whole advertisement image 242a before the second input (non-limiting examples of which include the touch operation of A21) is performed is an independent frame (I frame) of an MPEG (Moving Picture Experts Group), and the entirety of the whole advertisement image 242a may be displayed and moving image playback of the MPEG may be executed based on the second input being performed.

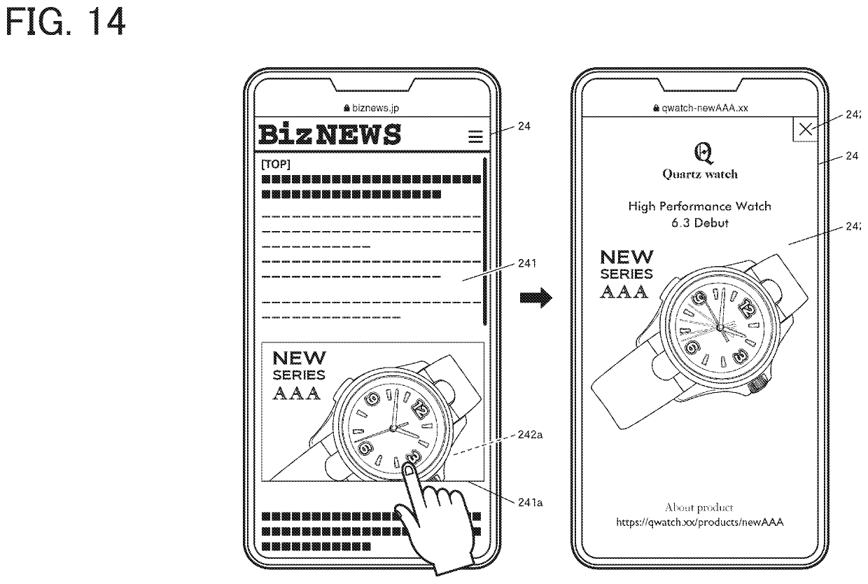

In the example shown in FIG. 14, playback of the whole advertisement image 242a, which is a moving image, is started based on the region of interest viewed via the transparent area 241a being touched by the user (second input). In this example, the second hand of the analog wristwatch, which was stopped before the second input, starts operating based on the entirety of the whole advertisement image 242a being displayed.

This variation shows a configuration in which the whole advertisement image 242a (a non-limiting example of advertisement information) is a moving-image advertisement image (a non-limiting example of moving-image advertisement information), and playback of the moving-image advertisement image (a non-limiting example of playback of the moving-image advertisement image) is executed by the controller 21 based on the second input performed on the region of interest.

As an example of the effect obtained by such a configuration, unexpectedness resulting from the stationary advertisement information starting to move based on the second input performed by the user is generated, and thus it is possible to draw the attention of the user to the first content information.

### Fourth Embodiment

A fourth embodiment is an embodiment in which the terminal 20 receives main content data (a non-limiting example of second content data) and advertisement content data (a non-limiting example of first content data; including data of a partial advertisement image that is a portion of a whole advertisement image), and displays, on the display 24, a web page of the main content (a non-limiting example of the second content information based on the second content data) and the partial advertisement image (a non-limiting example of first information, which is a portion of the first content information), which is a portion of a whole advertisement image (a non-limiting example of first content information based on the first content data) in a state of being superimposed on each other, for example, without limitation thereto.

The fourth embodiment corresponds to the second embodiment, but differs in that instead of the data of the whole advertisement image, the data of the partial advertisement image is transmitted from the server 10 to the terminal 20, and instead of the whole advertisement image, the partial advertisement image is displayed on the terminal 20.

The features described in the fourth embodiment can also be applied to and/or combined with other embodiments and variations.

Constituent elements that are the same as those already described are denoted by the same reference numerals, and redundant description thereof is omitted.

In the fourth embodiment, the advertisement content data includes the whole advertisement data and the later-described partial advertisement data.

Functional Configuration

(1) Functional Configuration of Server

The distribution processor 111 distributes the main content data stored in the storage 15 to the terminal 20, and distributes the advertisement content data including the partial advertisement data stored in the storage 15 to the terminal 20, for example, without limitation thereto.

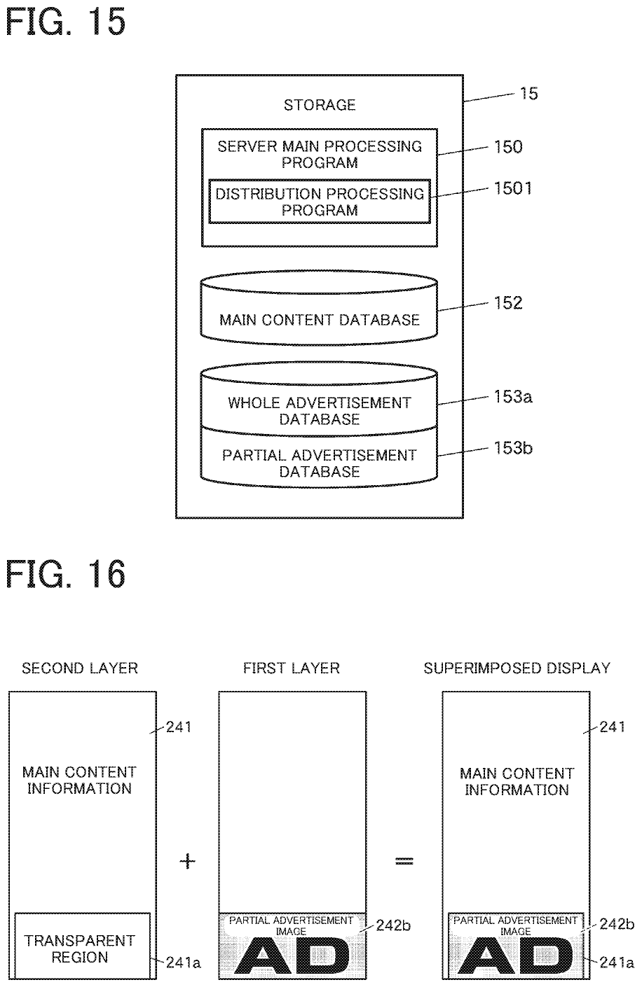

A partial advertisement database 153b shown in FIG. 15 is a database in which partial advertisement data including data of a partial advertisement image corresponding to a portion of the whole advertisement image is cumulatively stored.

When the partial advertisement data is distributed to the terminal 20, the partial advertisement image is displayed in a portion of the page display region, for example, without limitation thereto.

The partial advertisement image is an image including a portion of the whole advertisement image corresponding to the partial advertisement image. Alternatively or additionally, in this embodiment, the partial advertisement image is an image including a region of interest.

As described above, the region of interest is a region set for the purpose of drawing the attention of the user, and is a region set with respect to the whole advertisement image.

On the other hand, non-limiting examples of the partial advertisement image include an image that is generated by trimming a portion of the whole advertisement image or the like and is distributed by the server 10.

As described above, the region of interest can be set in advance by the advertiser, for example, without limitation thereto. In this case, as described above, any region in the whole advertisement image can be set as the region of interest. That is, it is possible to set a region within the outline of the feature portion of the image as a region of interest, or to set a minute region in the whole advertisement image (also includes a region composed of only one pixel, such as a pixel located at the center coordinates of the whole advertisement image) as the region of interest, for example, without limitation thereto.

Since the partial advertisement image generated and distributed by the server 10 does not necessarily need to be the same as the image of the region of interest, in this embodiment, the partial advertisement image and the region of interest are distinguished from each other.

It is to be understood that unlike this embodiment, it is not necessary to distinguish between the partial advertisement image and the region of interest. That is, the partial advertisement image may be used as the image of the region of interest.

In this case, the server 10 may generate a partial advertisement image by trimming the image of the region of interest in the whole advertisement image from the whole advertisement image, for example, without limitation thereto.

For example, in this embodiment, the partial advertisement image will be described as a horizontally elongated advertisement image with a vertical width that is smaller than its horizontal width.

Non-limiting examples of the partial advertisement image can include an advertisement image having a horizontal width that is the same as or smaller than the horizontal width of the whole advertisement image, and a vertical width smaller than the vertical width of the whole advertisement image.

Alternatively or additionally, as described in further detail below, the partial advertisement image is not limited to a still image, and can also be a moving image.

The main content database 152 stores an advertisement number according to which it is possible to identify the advertisement content data (whole advertisement data, partial advertisement data), in association with the main content data, for example, without limitation thereto. As a result, the main content information to be displayed on the terminal 20 that is the distribution target and the advertisement content information (whole advertisement image or partial advertisement image) to be displayed in association with the main content information are associated with each other.

Alternatively or additionally, a whole advertisement image and a partial advertisement image corresponding to a portion of the whole advertisement image are denoted by the same advertisement number. The controller 11 can identify the whole advertisement image corresponding to the partial advertisement image based on the advertisement number.

Regarding the processing of the terminal 20, performing control for displaying of the advertisement content information (whole advertisement image or partial advertisement image) associated with the web page of the main content information on the web browser corresponding to an example of processing for displaying the advertisement content information on the display 24.

Display Screen Example

FIG. 16 is an illustrative diagram showing a relationship between information arranged in a first layer and information arranged in a second layer in this example.

Based on the terminal 20 receiving the main content data, the main content information (web page 241) that is based on the main content data is arranged in the second layer, and the partial advertisement image 242b that is based on the partial advertisement data distributed in association with the main content data is arranged in the first layer below the second layer.

In this example, the partial advertisement image 242b is a horizontally elongated image with a vertical width that is smaller than its horizontal width as described above, and the bottom side of the partial advertisement image 242b is arranged along the bottom side of the page display region, for example, without limitation thereto.

As a result of displaying the information of the second layer superimposed on the information of the first layer, in principle, the information of the first layer is hidden by the information of the second layer and cannot be seen by the user. However, at least a portion of the partial advertisement image 242b (in this example, most of the partial advertisement image 242b excluding the left and right end portions) is superimposed on the transparent region 241a of the second layer. As a result, the user can see a portion of the partial advertisement image 242b via the transparent region 241a, together with the main content information.

In the second embodiment, an example was shown in which the transparent region 241a of the web page 241 is located in the page display region while the web page 241 is in the initial position, and the user can confirm this (see FIG. 8). There is no limitation to such a configuration, and the transparent region 241a of the web page 241 may be prevented from being located in the page display region in the state where the web page 241 is in the initial position.

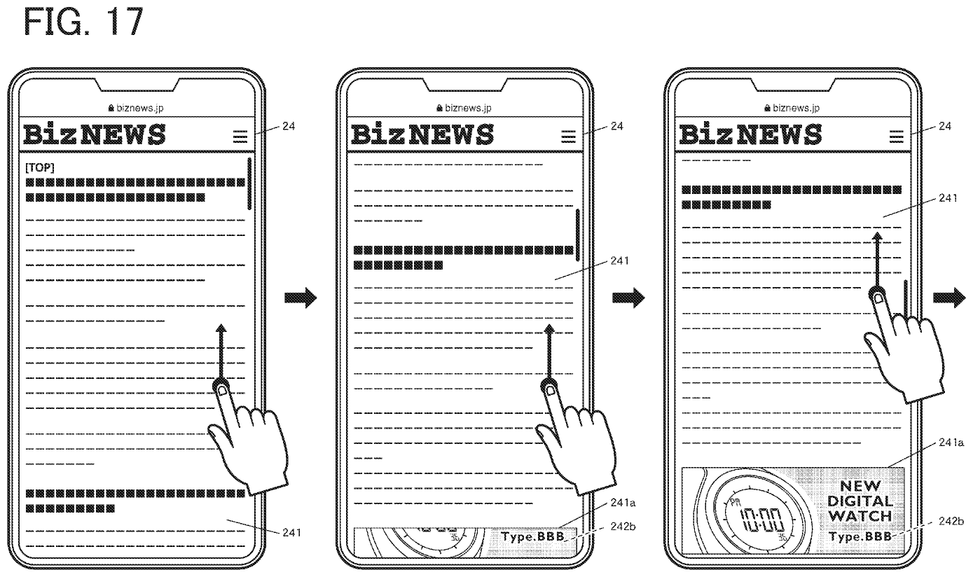

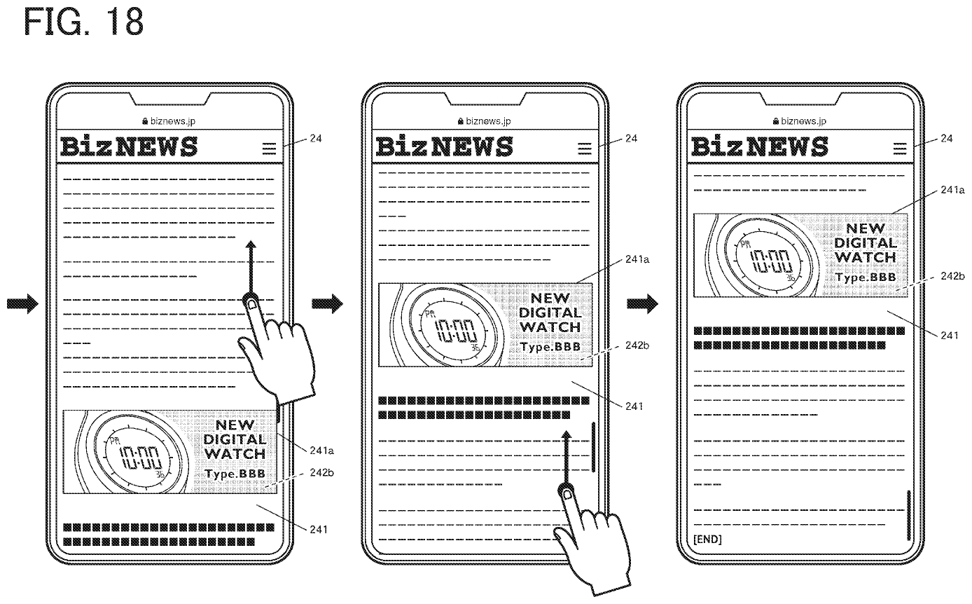

In the examples shown in FIGS. 17 and 18, the partial advertisement image 242b is arranged as the advertisement content information in the first layer, and the web page 241 of the business news site is arranged as the main content information in the second layer.

In this example, the partial advertisement image 242b is an image of a digital wristwatch. This partial advertisement image 242b includes the appearance and product name of the digital wristwatch as information, but does not include the release date or website information included in the corresponding whole advertisement image 242a.

In the examples shown in FIGS. 17 and 18, the partial advertisement image 242b is a horizontally elongated image with a width that is larger than its height, and is arranged at the lower end of the first layer. Alternatively or additionally, the partial advertisement image 242b includes a region of the watch face, which is a region of interest.

In a state where the partial advertisement image 242b is arranged at the lower end of the first layer, there is no region for arranging other information below the partial advertisement image 242b. At this time, it can also be said that the bottom side of the partial advertisement image 242b is arranged along the bottom side of the page display region.

In the example shown in FIG. 17, the vertical width of the web page 241 is about twice as large as the vertical width of the page display region, and therefore the entirety of the web page 241 cannot fit in the page display region. As a result, a portion of the web page 241 including the top portion [TOP] of the web page 241 is initially displayed in the page display region, and the remaining portion including the final portion [END] of the web page 241 is not displayed. Then, in this example, since the transparent region 241a is arranged in the latter half of the web page 241, the transparent region 241a is not located in the page display region when the web page 241 is in the initial position.

For this reason, in the state where the web page 241 is in the initial position, the user cannot view the partial advertisement image 242b of the first layer at all, and cannot know whether or not the web page 241 includes a transparent region.

If the web page 241 is in the initial position, the web page 241 scrolls in the screen upward direction due to the user touching the page display region (i.e., a region different from the transparent region 241a) and performing a scroll operation of moving his or her finger in the screen upward direction. Accompanying this, the transparent region 241a also scrolls in the screen upward direction, and the upper portion of the transparent region 241a appears from the lower portion of the screen.

Due to the upper portion of the transparent region 241a being located in the page display region, the upper portion of the transparent region 241a and the lower portion of the partial advertisement image 242b are superimposed on each other, and the lower portion of the partial advertisement image 242b can be viewed via the transparent region 241a. Furthermore, due to the user continuing the scrolling operation in the screen upward direction, the entirety of the transparent region 241a appears in the page display region. As a result, almost the entirety of the partial advertisement image 242b can be viewed via the transparent region 241a. In such an example, the transparent region 241a is a horizontally elongated region with a horizontal width that is larger than its vertical width.

Then, the position of the partial advertisement image 242b with respect to the transparent region 241a is fixed based on the superimposition of the center position of the transparent region 241a and the center position of the partial advertisement image 242b. When the user further continues the scroll operation in the screen upward direction, as shown in FIG. 18, the transparent region 241a and the partial advertisement image 242b scroll in the screen upward direction in a fixed state accompanying the web page 241 scrolling in the screen upward direction.

Furthermore, when the user continues the scroll operation and moves the final portion [END] of the web page 241 to the page display region, the transparent region 241a and the partial advertisement image 242b scroll in the screen upward direction in a fixed state accompanying the web page 241 scrolling in the screen upward direction.

Accordingly, the user can continuously view the partial advertisement image 242b via the transparent region 241a.

Processing

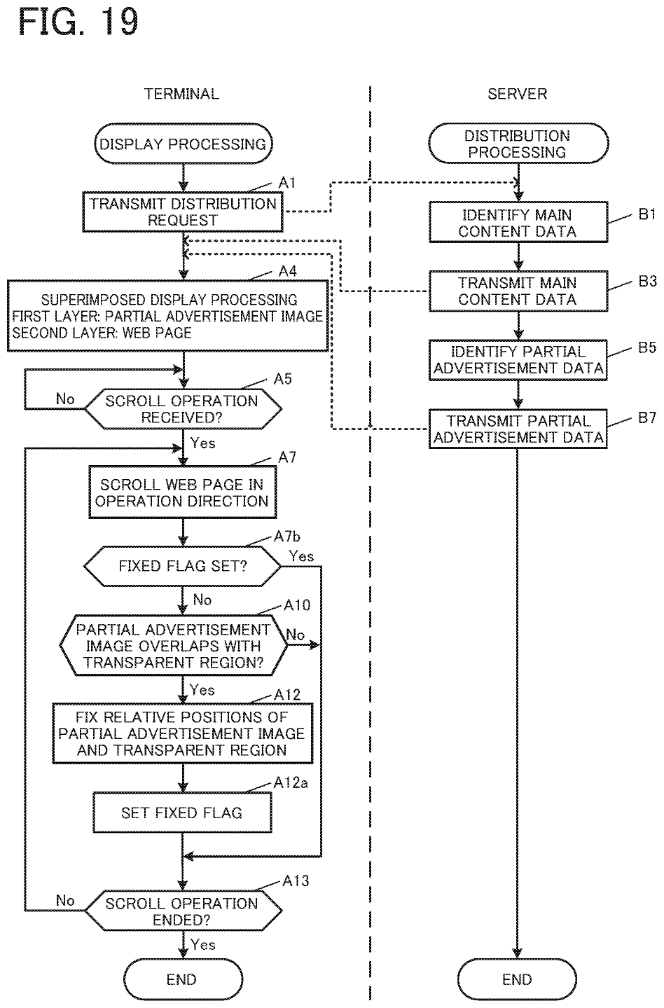

FIG. 19 is a flowchart showing an example of a flow of processing executed by each device in this embodiment.

In this diagram, distribution processing executed by the distribution processor 111 of the server 10 and display processing executed by the display processor 211 of the terminal 20 are shown.

The processing shown in FIG. 19 differs from the processing shown in FIG. 10 in that the processing of A4, A10, A12, and A12a is executed instead of the processing of A3, A9, A11, and A11a executed by the terminal 20, and differs in that the processing of B5 and B7 is executed instead of the processing of B3a and B3b executed by the server 10.

When the server 10 receives the distribution request from the terminal through the communication I/F 14, the server 10 identifies the main content data to be distributed from the main content database 152 based on the distribution request (B1). Then, the main content data to be distributed is transmitted to the terminal 20 through the communication I/F 14 (B3).

Alternatively or additionally, the server 10 identifies the partial advertisement data associated with the main content data to be distributed from the partial advertisement database 153b (B5). Then, the identified partial advertisement data (non-limiting examples of which include the data of the partial advertisement image 242b) is transmitted to the terminal 20 through the communication I/F 14 (B7), and the processing is ended.

When the terminal 20 receives the main content data and the partial advertisement data from the server 10, the terminal 20 arranges the partial advertisement image 242b based on the partial advertisement data in the first layer and the web page 241 based on the main content data in the second layer and displays the web page 241 in a superimposed manner on the partial advertisement image 242b (A4).

Since the web page 241 has the transparent region 241a, the user can view the partial advertisement image 242b via the transparent region 241a.

The terminal 20 determines whether or not the partial advertisement image 242b is superimposed on the transparent region 241a as a result of the web page 241 being scrolled (A10). In A10, it is determined whether or not the center position of the partial advertisement image 242b and the center position of the transparent region 241a overlap each other, for example, without limitation thereto.

It may be determined whether or not a predetermined percentage (non-limiting examples of which include 70%) of the vertical width of the partial advertisement image 242b overlaps with the transparent region 241a, for example, without limitation thereto.

If the partial advertisement image 242b overlaps with the transparent region 241a (A10: Yes), the terminal 20 fixes the relative position of the transparent region 241a with respect to the partial advertisement image 242b (A12). Then, a fixed flag is set based on the partial advertisement image 242b and the transparent region 241a being fixed (A12a). Then, the processing is advanced to A13.

The “fixed flag” in this processing is a flag that is set when the relative positions of the partial advertisement image 242b and the transparent region 241a are fixed.

If the processing of A12 has been executed, thereafter, even if the scroll operation is performed and the web page 241 scrolls, the region of the partial advertisement image 242b viewed via the transparent region 241a does not change.

If the partial advertisement image 242b is not superimposed on the transparent region 241a (A10: No), the terminal 20 advances the processing to A13.

In this processing, it was assumed that the relative position of the transparent region with respect to the partial advertisement image is fixed under the condition that the partial advertisement image is superimposed on the transparent region, but there is no limitation to this.

Specifically, the condition may optionally be that the region of interest is superimposed on the transparent region, for example, without limitation thereto.

Alternatively or additionally, the condition may optionally be that the distance between the region of interest and the transparent region is a set distance or less (or less than the set distance), for example, without limitation thereto.

### Effects of Fourth Embodiment

The effect based on the relationship between the transparent region 241a and the partial advertisement image 242b in the fourth embodiment is almost the same as the effect based on the relationship between the transparent region 241a and the region of interest of the whole advertisement image 242a shown in the second embodiment.

As another effect, the fourth embodiment shows an example of a configuration in which the partial advertisement image 242b has a vertical side (a non-limiting example of a third side) and a horizontal side longer than the vertical side (a non-limiting example of a fourth side), the vertical side is arranged along the longitudinal direction of the screen (and the page display region), and the horizontal side arranged along the lateral direction of the screen (and the page display region).

As an example of the effect obtained by such a configuration, by setting the first information having a smaller size than the first content information as the display control target, it is possible to reduce the load related to the display control of the terminal.

The fourth embodiment shows a configuration in which the partial advertisement image 242b is displayed at the lower end of the page display region, and the page display region is moved based on the scroll operation.

As an example of the effect obtained by such a configuration, the distance by which the first information moves based on the first input can be increased.

The fourth embodiment shows a configuration in which the transparent region 241a is displayed from the lower end of the page display region based on the scroll operation.

As an example of the effect obtained by such a configuration, the transparent region can be recognized by the user at an early stage.

Fourth Variation

A variation relating to the relationship between the transparent region 241a and the region of interest of the whole advertisement image 242a shown as a variation of the second embodiment can be similarly applied also to the relationship between the transparent region 241a and the partial advertisement image 242b in the fourth embodiment.

Alternatively or additionally, a variation related to the method of setting the region of interest for the whole advertisement image 242a shown as the variation of the second embodiment can be similarly applied also to the method of setting the partial advertisement image 242b for the whole advertisement image 242a in the fourth embodiment.

### Fifth Embodiment

A fifth embodiment is an embodiment in which control for making the whole advertisement image 242a corresponding to the partial advertisement image 242b visible based on second input performed by the user on the partial advertisement image 242b has been added to the control performed by the terminal 20 in the fourth embodiment. The control of the fifth embodiment is executed after the execution of the superimposed display processing (A4) shown in FIG. 19, for example, without limitation thereto.

Although the fifth embodiment corresponds to the third embodiment, it differs in that in the terminal 20, based on the second input performed on the partial advertisement image, the data of the whole advertisement image corresponding to the partial advertisement image is acquired from the server 10, and the control for making the whole advertisement image visible is executed. The fifth embodiment differs from the third embodiment in that, at the time when the data of the partial advertisement image is acquired from the server 10 and displayed, the terminal 20 does not have the data of the whole advertisement image, and in order to make the whole advertisement image visible, the data of the whole advertisement image is separately acquired from the server 10.

The features described in the fifth embodiment can also be applied to and/or combined with other embodiments and variations.

Constituent elements that are the same as those already described are denoted by the same reference numerals, and redundant description thereof is omitted.

Display Screen Example

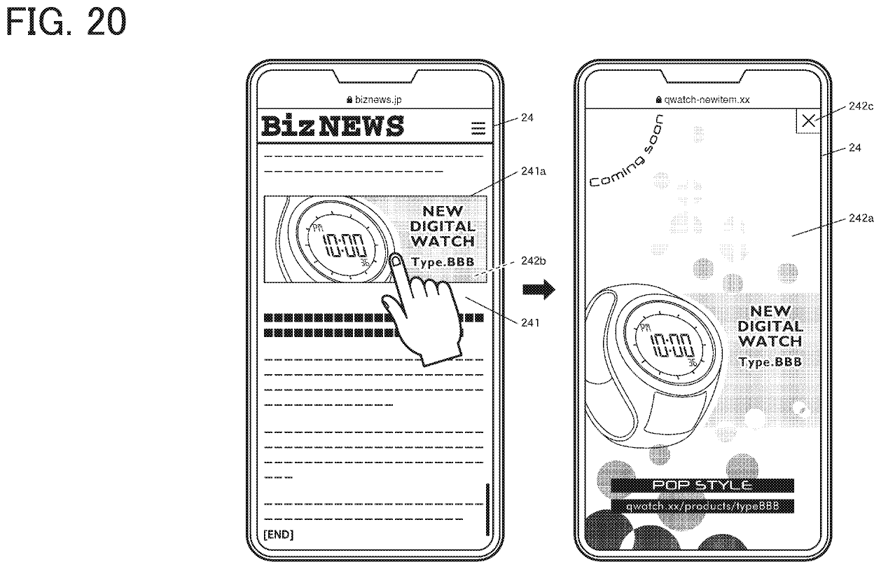

In the display screen shown in FIG. 20, the transparent region 241a and the partial advertisement image 242b are fixed due to a scroll operation (A5 to A13) being performed after the superimposed display processing (A4) is executed (A12). For this reason, the partial advertisement image 242b can be viewed via the transparent region 241a.

In this state, the user performs a touch operation (a non-limiting example of the second input) of touching the visible partial advertisement image 242b (a non-limiting example of the first information) on the touch panel, and thereby the whole advertisement image 242a corresponding to the partial advertisement image 242b becomes visible.

In this example, the only information included in the partial advertisement image 242b is the appearance and product name of the digital wristwatch. In contrast to this, the whole advertisement image 242a includes the appearance and product name of the digital wristwatch in the central portion, includes information indicating that the product is about to be released in the upper portion, and includes website information in the lower portion.

That is, in this example, the partial advertisement image 242b is set as an advertisement image obtained by trimming the central portion in the vertical direction of the whole advertisement image 242a.

Processing

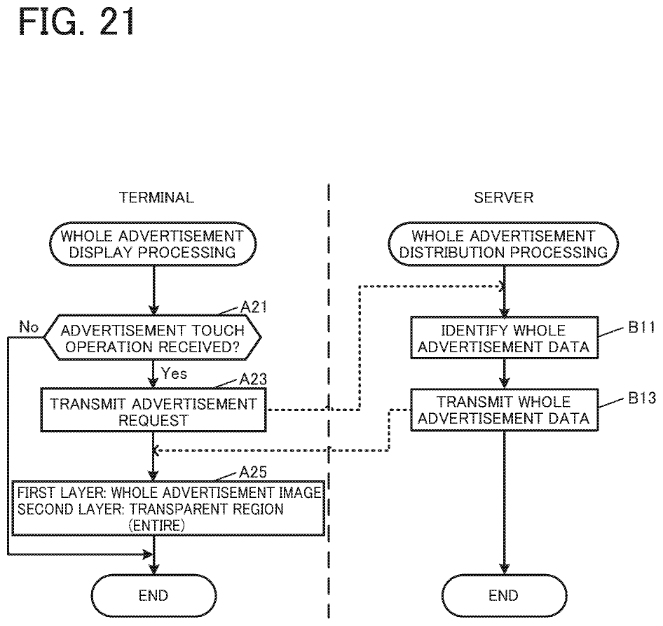

FIG. 21 is a flowchart showing an example of a flow of processing executed by each device in this embodiment.

In this diagram, whole advertisement distribution processing executed by the distribution processor 111 of the server 10 and whole advertisement display processing executed by the display processor 211 of the terminal 20 are shown.

Compared to the processing shown in FIG. 12, the processing shown in FIG. 21 differs in that A23 is added as processing executed by the terminal 20, and in that B11 and B13 are added as processing executed by the server 10. The whole advertisement distribution processing can be executed as processing that is based on a subroutine program of the distribution processing program 1501, for example, without limitation thereto.

The terminal 20 determines whether or not the touch operation of the partial advertisement image 242b (a non-limiting example of second input on the first information) has been performed in the state where the transparent region 241a of the web page and the partial advertisement image 242b are superimposed (A21).

If the user has performed a touch operation on the partial advertisement image 242b (A21: Yes), the terminal 20 transmits an advertisement request including the advertisement number of the partial advertisement image 242b to the server 10 through the communication I/F 22 (A23).

It is to be understood that the user performing a touch operation on the partial advertisement image 242b also corresponds to performing a touch operation on the transparent region 241a superimposed on the partial advertisement image 242b.

When the server 10 receives the advertisement request from the terminal through the communication I/F 14, the server 10 identifies the whole advertisement data to be distributed from the whole advertisement database 153a based on the advertisement number included in the advertisement request (B11). Then, the identified whole advertisement data (non-limiting examples of which include including the data of the whole advertisement image 242a) is transmitted to the terminal 20 through the communication I/F 14 (B13), and the whole advertisement distribution processing is ended.

When the terminal 20 receives the whole advertisement data from the server 10, the terminal 20 arranges the whole advertisement image 242a based on the whole advertisement data in the first layer, sets the entirety of the web page 241 arranged in the second layer in the transparent region 241a (A25), and ends the whole advertisement display processing.

As a result, the whole advertisement image 242a arranged in the first layer can be viewed by the user.

### Effect of Fifth Embodiment

The effect based on the relationship between the partial advertisement image 242b and the whole advertisement image 242a in the fifth embodiment is the same as the effect based on the relationship between the region of interest and the whole advertisement image 242a shown in the third embodiment.

Fifth Variation (1)

A variation relating to the relationship between the region of interest and the whole advertisement image 242a shown as a variation of the third embodiment can be similarly applied also to the relationship between the partial advertisement image 242b and the whole advertisement image 242a in the fifth embodiment. The partial advertisement image 242b may be a still image, whereas the whole advertisement image 242a corresponding to the partial advertisement image 242b may be a moving image, and playback of the moving image may be started accompanying the whole advertisement image 242a being displayed (the entirety becoming visible) based on the second input performed on the partial advertisement image 242b, for example, without limitation thereto.

Furthermore, a variation relating to the display processing after the whole advertisement image 242a is displayed (after the entirety becomes visible), which is shown as a variation of the third embodiment, can be similarly applied also to the fifth embodiment.

Fifth Variation (2)

In the fifth embodiment, the main content data distributed from the server 10 can also be made to include information such as a URI in which the data of the whole advertisement image associated with the main content data is stored, for example, without limitation thereto.

Alternatively or additionally, the partial advertisement data distributed from the server 10 can also be made to include information such as a URI in which the data of the whole advertisement image associated with the partial advertisement image corresponding to the partial advertisement data is stored, for example, without limitation thereto.

In this case, in the whole advertisement display processing shown in FIG. 21, if a touch operation (second input) on the partial advertisement image 242b has been performed (A21: Yes), the terminal 20 acquires the data of the whole advertisement image 242a associated with the partial advertisement image 242b on which the touch operation was performed, based on information such as the URI included in the above-described main content data (or partial advertisement data), for example, without limitation thereto. Then, the whole advertisement image 242a based on the acquired data can be arranged in the first layer (A25).

This method can be similarly applied also to the following embodiments.

### Sixth Embodiment

The sixth embodiment is an embodiment in which setting of the partial advertisement image 242b and the transparent region 241a and billing processing based on the partial advertisement image 242b have been added to the above-described embodiment.

The features described in the sixth embodiment can also be applied to and/or combined with other embodiments and variations.

The same constituent elements as those already mentioned are denoted by the same reference numerals, and redundant description thereof is omitted.

Functional Configuration

(1) Functional Configuration of Server

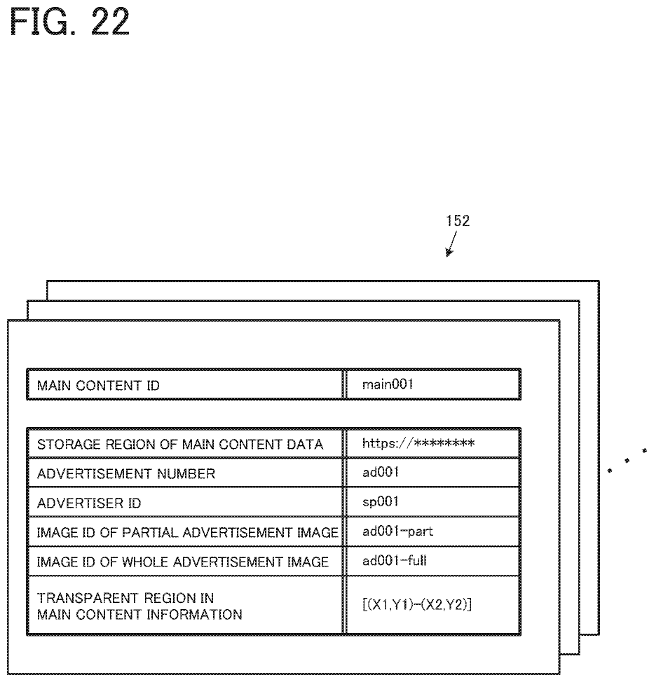

The main content database 152 shown in FIG. 22 stores a main content ID for identifying the main content information that is based on the main content data, the storage region in which the main content data of the main content ID is stored, the advertisement number for identifying the advertisement associated with the main content data of the main content ID (the advertisement information to be displayed on the terminal 20 together with the main content information), an advertiser ID for identifying the advertiser providing the advertisement with that advertisement number, an image ID for identifying a partial advertisement image related to the advertisement with that advertisement number, an image ID for identifying the whole advertisement image related to the advertisement with that advertisement number, and a setting range of the transparent region in the main content information (web page) of the main content ID, in association with each other, for example, without limitation thereto.

In this example, the image ID of the partial advertisement image and the image ID of the whole advertisement image corresponding to the partial advertisement image include the same advertisement number. For this reason, based on the advertisement number, the server 10 can identify the partial advertisement image and the whole advertisement image constituting the advertisement with the advertisement number.

A storage region in which the whole advertisement image is stored in association with the image ID of the whole advertisement image, and a billing amount, which is an amount of money billed to the advertiser each time the whole advertisement image is displayed on the terminal 20, are stored in association with each other in the whole advertisement database 153a shown in FIG. 24, for example, without limitation thereto. In this example, 1.0 yen will be billed to the advertiser every time the whole advertisement image is displayed based on a touch operation performed on the partial advertisement image.

The storage region in which the partial advertisement image is stored, the region of the partial advertisement image with respect to the whole advertisement image (a trimming region indicating which region of the corresponding whole advertisement image the partial advertisement image corresponds to), and the initial position of the partial advertisement image are stored in association with the image ID of the partial advertisement image in the partial advertisement database 153b shown in FIG. 24, for example, without limitation thereto.

In this embodiment, the region where the corresponding whole advertisement image is trimmed in the vertical direction is defined as the region of the partial advertisement image. In the diagram, the coordinate value in the horizontal direction is represented as “x”, the coordinate value in the vertical direction is represented as “y”, and the coordinate values are represented as “(x, y)”, for example, without limitation thereto.

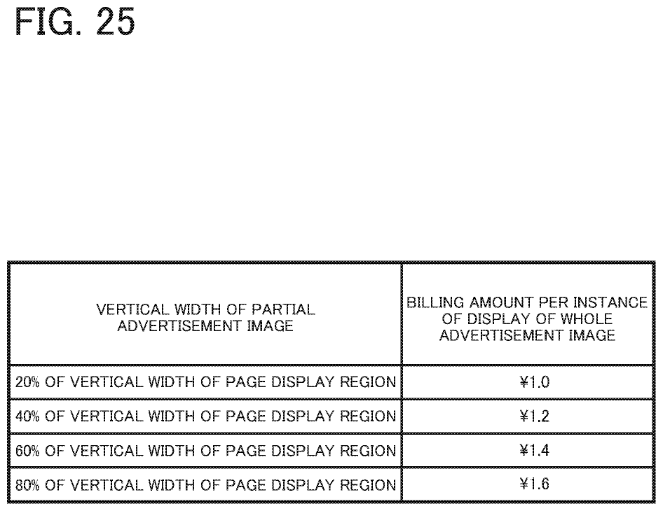

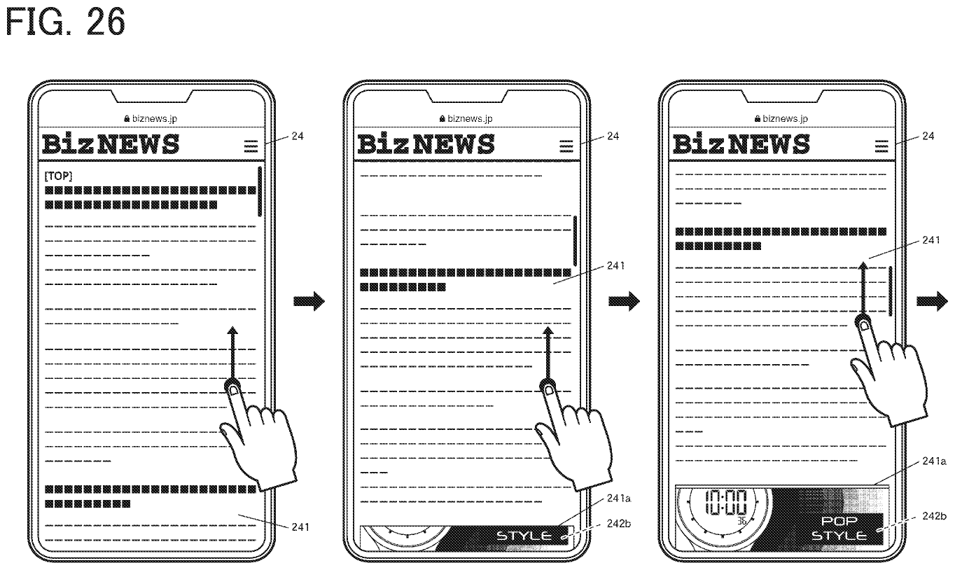

FIG. 25 shows an example of a table showing the relationship between the size (vertical width) of the partial advertisement image and the billing amount. This table can be stored in the storage 15 of the server 10, for example, without limitation thereto.

In this table, the vertical width of the partial advertisement image and the billing amount per instance of display of the whole advertisement image (hereinafter referred to as “billing amount” as appropriate) are defined in association with each other. That is, this table is a table for setting the billing amount based on the vertical width of the partial advertisement image.

The example shown in FIG. 25 shows a case where the vertical width of the partial advertisement image is divided according to the percentage with respect to the vertical width of the page display region and the billing amount is changed. This is intended to change the billing amount depending on the percentage occupied by the vertical width of the partial advertisement image within the display range that is the standard for the user to view (non-limiting examples of which include within the range of the page display region).

Specifically, the vertical width of the partial advertisement image is divided into “20% of the vertical width of the page display region”, “40% of the vertical width of the page display region”, “60% of the vertical width of the page display region”, and “80% of the vertical width of the page display region”, for example, without limitation thereto.

For example, “1.0 yen” is set as the billing amount for “20% of the vertical width of the page display region”, “1.2 yen” is set as the billing amount for “40% of the vertical width of the page display region”, “1.4 yen” is set as the billing amount for “60% of the vertical width of the page display region”, and “1.6 yen” is set as the billing amount for “80% of the vertical width of the page display region”.

That is, the higher the percentage of the page display region with respect to the vertical width, the higher the billing amount.

In such an example, the vertical width of the partial advertisement image is divided according to the percentage with respect to the vertical width of the page display region, but there is no limitation to this.

The billing amount may optionally be changed by dividing the vertical width of the partial advertisement image according to the percentage with respect to the vertical width of the main content information (web page), for example, without limitation thereto.

If the vertical width of the whole advertisement image is the same as the vertical width of the page display region, or if the size of the whole advertisement image is the same as the size of the page display region, the above-described percentage with respect to the vertical width of the page display region is the same as the percentage with respect to the vertical width of the whole advertisement image. That is, the billing amount is set by dividing the vertical width of the partial advertisement image according to the percentage with respect to the vertical width of the whole advertisement image.

It is to be understood that the whole advertisement image does not necessarily need to be an image of the same size as the page display region, and the whole advertisement image can also be an image of a size smaller than the page display region, for example, without limitation thereto.

In view of this, the billing amount may optionally be changed by dividing vertical width of the partial advertisement image according to the percentage with respect to the vertical width of the whole advertisement image, for example, without limitation thereto.

In this case, as the size of the whole advertisement image increases, the billing amount may be relatively higher for the same percentage (percentage with respect to the vertical width of the whole advertisement image).

In this embodiment, the controller 11 of the server 10 determines the billing amount for when the whole advertisement image corresponding to the partial advertisement image is displayed based on the set vertical width of the partial advertisement image, and associates the determined billing amount with the whole advertisement image.

Based on the server 10 transmitting the whole advertisement data to the terminal 20 in B11 of FIG. 21, the server 10 updates the billing amount relating to the advertisement with the advertisement number (or image ID) stored in association with the advertisement number corresponding to the whole advertisement data (or image ID of the whole advertisement image), for example, without limitation thereto. Alternatively or additionally, the server 10 updates the billing amount to the advertiser based on the advertisement number (or image ID) and the advertiser ID being associated with each other.

Note that in A25 of FIG. 21, the advertisement display information including the image ID of the whole advertisement image 242a may be transmitted to the server 10 based on the terminal 20 displaying the whole advertisement image 242a on the display 24 (based on the whole advertisement image 242a becoming visible). The server 10 that has received the advertisement display information may update the billing amount relating to the advertisement with the advertisement number associated with the image ID included in the advertisement display information and the billing amount to the advertiser of the advertiser ID associated with the advertisement number.

It is to be understood that the billing amount to the advertiser can also be defined as the billing amount in the case where the partial advertisement image is displayed. Alternatively or additionally, the server 10 may optionally set the billing amount in the case where the partial advertisement image is displayed. This also applies to other embodiments.

(2) Setting of Partial Advertisement Image by Advertiser

As described above, the advertiser can set the region of the whole advertisement image that is to be the partial advertisement image as appropriate.

The advertiser can set the partial advertisement image by operating a setting device (e.g., a device having the same function as the terminal 20) for setting a partial advertisement image stored in the server 10 in a state in which the setting device is connected to the server 10 via the network 30, for example, without limitation thereto.

Specifically, the advertiser performs an operation of specifying the region of the partial advertisement image (e.g., an operation of changing the position and size of a shape displayed on the whole advertisement image) in the state where the whole advertisement image is displayed on the display of the setting device, and thereby the specified region is trimmed from the whole advertisement image, is set as the partial advertisement image, and is stored in the partial advertisement database 153b. The data of the set partial advertisement image is distributed to the terminal 20 as partial advertisement data.

In some embodiments, as described above, the partial advertisement image can also be automatically set by the terminal 20 or the server 10, and the partial advertisement image can also be set through operation of the terminal 20 by the user.

(3) Setting of Transparent Region by Server

When the partial advertisement image is set, the controller 11 of the server 10 sets the transparent region of the main content information (web page) associated with the partial advertisement image based on the horizontal width and the vertical width of the partial advertisement image, for example, without limitation thereto.

Specifically, the server 10 sets the size of the transparent region using a horizontal width that is the same as or smaller than the horizontal width of the partial advertisement image (non-limiting examples of which include 80% to 100% of the horizontal width of the partial advertisement image) as the horizontal width of the transparent region, and a vertical width that is the same as or smaller than the vertical width of the partial advertisement image (non-limiting examples of which include 80% to 100% of the vertical width of the partial advertisement image) as the vertical width of the transparent region, for example, without limitation thereto.

Alternatively or additionally, the server 10 may optionally set the size of the transparent region based on either the horizontal width or the vertical width of the partial advertisement image.

Alternatively or additionally, the server 10 determines the position of the transparent region in the main content information (web page). Specifically, if a web page having a vertical width that is about twice the vertical width of the page display region is displayed on the terminal 20, and a portion of the partial advertisement image is made visible in a state where the web page is in the initial position (if the basic setting therefor has been performed by the advertiser, etc.), the server 10 determines the position of the transparent region to be a position at the upper portion of the web page, the position being superimposed on the partial advertisement image.

On the other hand, if the partial advertisement image is to be made invisible in the state where the web page is in the initial position (non-limiting examples of which include if the basic setting therefor has been performed by the advertiser, etc.), the position of the transparent region is set to the lower portion of the web page, the transparent region is made to appear in the page display region from the lower portion of the screen and overlap with the partial advertisement image through a scroll operation.

In some embodiments, the server 10 may determine the size or position of the transparent region based on the configuration of the main content information, for example, without limitation thereto.

If more important regions (main content regions to be given attention by the user) in the main content information, such as news images on the web page of the news site, are arranged in the first half than in the second half, the vertical width of the transparent region is set such that the transparent region is set in the second half of the web page while avoiding the important regions and a predetermined interval is provided between the transparent region and the important region, for example, without limitation thereto.

Conversely, if more important regions are arranged in the second half than the first half, the vertical width of the transparent region is set such that the transparent region is set in the first half of the web page while avoiding the important regions and a predetermined interval is provided between the transparent region and the demand region.

In some embodiments, the server 10 may optionally set the transparent region based on the size of the partial advertisement image, for example, without limitation thereto. Specifically, a size that is the same as or smaller than the size of the partial advertisement image (non-limiting examples of which include 80% to 100% of the size of the partial advertisement image) may optionally be set as the size of the transparent region, for example, without limitation thereto.

### Effect of Sixth Embodiment

The sixth embodiment shows a configuration in which the advertiser requests transmission of the advertisement content data (non-limiting examples of which include whole advertisement data including the whole advertisement image; an example of first content data) to the terminal 20 of the user, and the partial advertisement image of the advertisement content information (the first information of the first content information) is set by the advertiser.

As an example of the effect obtained by such a configuration, a business operator (non-limiting examples of which include the advertiser) can set, as the first information, the region to which the attention of the user is to be drawn in the first content information that is based on the first content data that was requested to be transmitted to the terminal.

The sixth embodiment shows a configuration in which the billing amount based on transmission of the whole advertisement image to the terminal 20 is set based on the length of a side of the partial advertisement image (first information) or the size of the partial advertisement image.

As an example of the effect obtained by such a configuration, an appropriate billing amount is set for the first information, which has a high display effect (non-limiting examples of which include an advertisement effect) and is likely to lead to display in the first content information.

The sixth embodiment shows a configuration in which the data of the whole advertisement image (first content information) is included in the whole advertisement data (first content data), and the whole advertisement image is associated with a partial advertisement image (first information) according to an advertisement number.

As an example of the effect obtained by such a configuration, it is possible to display the first information first, and then display the first content information corresponding to the first information, for example, without limitation thereto.

The sixth embodiment shows a configuration in which the transparent region is set based on the length of a side of the partial advertisement image (first information) or the size of the partial advertisement image.

As an example of the effect obtained by such a configuration, a transparent region suitable for the first information can be set.

The sixth embodiment shows a configuration in which the whole advertisement data (first content data) includes the data of the whole advertisement image (first content information), and the whole advertisement image associated with information relating to billing based on the length of the partial advertisement image (first information) or the size of the partial advertisement image.

As an example of the effect obtained by such a configuration, a billing amount corresponding to the likelihood of drawing attention can be associated with the first information having a length or size that is likely to draw attention from the user, for example, without limitation thereto.

The sixth embodiment shows a configuration in which the whole advertisement data (first content data) includes the data of the whole advertisement image (first content information), and the whole advertisement image (first information) is associated with information relating to billing in the server 10 that transmits the whole advertisement data to the terminal 20.

As an example of the effect obtained by such a configuration, information relating to billing based on the first content information being displayed can be managed on the server side.

Sixth Variation (1)

In the sixth embodiment, an example was shown in which the partial advertisement image is set by the advertiser, but the present disclosure is not limited to such a mode. As described above, the partial advertisement image may be set based on the whole advertisement image by the server 10 that stores the whole advertisement image.

The server 10 may set a horizontally elongated rectangular region in which a pixel at the center coordinates of the whole advertisement image 242a is included at the center position, as the partial advertisement image 242b, for example, without limitation thereto. Alternatively or additionally, the server 10 executes image processing for the whole advertisement image 242a, and may estimate the contour of the feature portion through edge detection or the like using filtering, and thereby set the horizontally elongated region including the contour as the partial advertisement image 242b, for example, without limitation thereto.

Alternatively or additionally, if the whole advertisement image 242a is a moving image, the server 10 may estimate a region in which a difference (variation) in pixel values between prior and subsequent images based on the display order or between prior and subsequent frames based on the display order is large as a feature portion, and thereby set the partial advertisement image 242b so as to include the estimated feature portion, for example, without limitation thereto.

This variation shows a configuration in which the partial advertisement image (first information) is set by the server 10 that transmits the whole advertisement data (first content data) to the terminal 20.

As an example of the effect obtained by such a configuration, it is possible to eliminate the need for a business operator (non-limiting examples of which include the advertiser) to perform a setting operation on the first information.

Sixth Variation (2)

In the sixth embodiment, an example was shown in which one piece of advertisement information is displayed in association with one piece of main content information on the terminal 20, but the present disclosure is not limited to such a configuration, and a plurality of pieces of advertisement information may be displayed in association with one piece of main content information.

In the main content database 152, two different advertisement numbers (hereinafter referred to as a first advertisement number and a second advertisement number) are associated with one main content ID, for example, without limitation thereto. Then, if the main content data of the main content ID has been distributed to the terminal 20, the first advertisement content data associated with the first advertisement number (data of the first whole advertisement image or data of a first partial advertisement image, which is a portion of the first whole advertisement image) and second advertisement content data associated with the second advertisement number (data of a second whole advertisement image or data of a second partial advertisement image, which is a portion of the second whole advertisement image) may be distributed to the terminal 20.

The first partial advertisement image and the second partial advertisement image may be arranged in the first layer, and the main content information having a transparent region may be arranged in the second layer, and thereby at least one of the first partial advertisement image and the second partial advertisement image may be made visible via the transparent region of the main content information, for example, without limitation thereto.

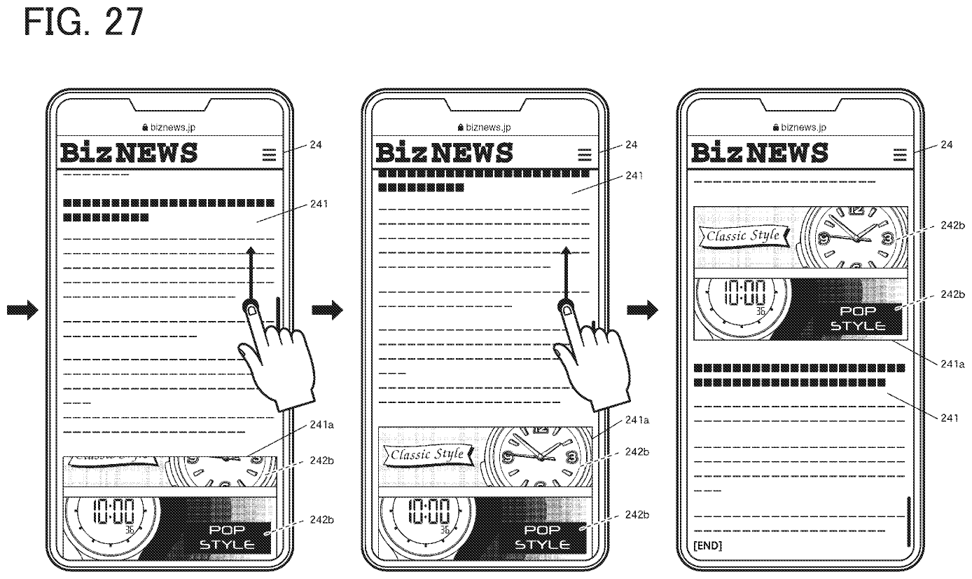

In the examples shown in FIGS. 26 and 27, the first partial advertisement image 242b, which is an advertisement image of a digital wristwatch, and the second partial advertisement image 242b, which is an advertisement image of an analog wristwatch, are arranged in the first layer, and the web page 241 is arranged in the second layer. The first partial advertisement image 242b and the second partial advertisement image 242b are both horizontally elongated images, and are arranged aligned in the vertical direction in the first layer.

As shown in FIG. 26, since the transparent region 241a is not in the page display region in the state where the web page 241 is in the initial position, neither the first partial advertisement image 242b nor the second partial advertisement image 242b can be viewed.

Due to the user performing a scroll operation and scrolling the web page 241 to the upper portion of the screen, the transparent region 241a appears in the page display region from the lower portion of the screen. At this time, only the lower portion of the first partial advertisement image 242b arranged at the lower end of the first layer can be viewed via the transparent region24 1 a. Due to the user further performing a scrolling operation and scrolling the web page 241 to the upper portion of the screen, the entirety of the first partial advertisement image 242b can be viewed via the transparent region 241a.

As shown in FIG. 27, due to the user further performing a scroll operation and scrolling the web page 241 to the upper portion of the screen, the entirety of the first partial advertisement image 242b and a portion of the second partial advertisement image 242b arranged thereabove become visible via the transparent region 241a. Due to the user further performing the scroll operation and scrolling the web page 241 to the upper portion of the screen, the entirety of the first partial advertisement image 242b and the entirety of the second partial advertisement image 242b become visible via the transparent region 241a.

At this time, the relative positions of the transparent region 241a and the first partial advertisement image 242b are fixed and the relative positions of the transparent region 241a and the second partial advertisement image 242b are also fixed based on both the first partial advertisement image 242b and the second partial advertisement image 242b overlapping with the transparent region 241a (non-limiting examples of which include the boundary line between the first partial advertisement image 242b and the second partial advertisement image 242b being located in the center in the vertical direction of the transparent region 241a).

Thereafter, when the user performs a scroll operation, the first partial advertisement image 242b and the second partial advertisement image 242b move together with the transparent region 241a. As a result, the state in which the entirety of the first partial advertisement image 242b and the entirety of the second partial advertisement image 242b can be viewed via the transparent region 241a continues.

In this manner, the transparent region 241a is also set such that a plurality of partial advertisement images 242b are visible, based on the plurality of partial advertisement images 242b being arranged in the first layer. That is, in this variation, the server 10 sets the transparent region based on the number of partial advertisement images.

Specifically, the server 10 sets the vertical width of the transparent region 241a to a width that satisfies the vertical width of the first partial advertisement image 242b and the vertical width of the second partial advertisement image 242b based on a plurality of partial advertisement images 242b being aligned in the vertical direction of the first layer in association with the same main content information in the terminal 20, for example, without limitation thereto.

The horizontal width of the transparent region 241a is set to a horizontal width that is the same as or smaller than the horizontal width of the partial advertisement image 242b with the shorter horizontal width out of the first partial advertisement image 242b and the second partial advertisement image 242b, for example, without limitation thereto.

This variation shows a configuration in which both the first partial advertisement image 242b (first information), which is a portion of the first whole advertisement image 242a (first content information), and the second partial advertisement image 242b (second information), which is a portion of the second whole advertisement image 242a (third content information) are displayed in the page display region, and the vertical width and horizontal width of the transparent region are set based on the vertical width and horizontal width of the first partial advertisement image 242b and the vertical width and horizontal width of the second partial advertisement image 242b.

As an example of the effect obtained by such a configuration, if a plurality of pieces of information are arranged in the first layer, a transparent region in which the plurality of pieces of information are made visible can be set, for example, without limitation thereto.

Sixth Variation (3)

In the sixth embodiment, before setting the size of the transparent region 241a, the server 10 may transmit the data of the web page 241 including the transparent region 241a based on the initial setting to the terminal 20, and temporarily display the web page 241 including the transparent region 241a based on the initial setting on the terminal 20, for example, without limitation thereto.

Thereafter, the server 10 sets the transparent region 241a based on at least one of the vertical width and the horizontal width of the partial advertisement image 242b that are to be or were arranged in the first layer, the size of the partial advertisement image 242b, the number of the partial advertisement images 242b, or a combination thereof. Then, the main content information (web page 241) having the transparent region 241a may be transmitted to the terminal 20, and the main content information (web page 241) having the updated transparent region 241a may be arranged again in the second layer in the terminal 20.

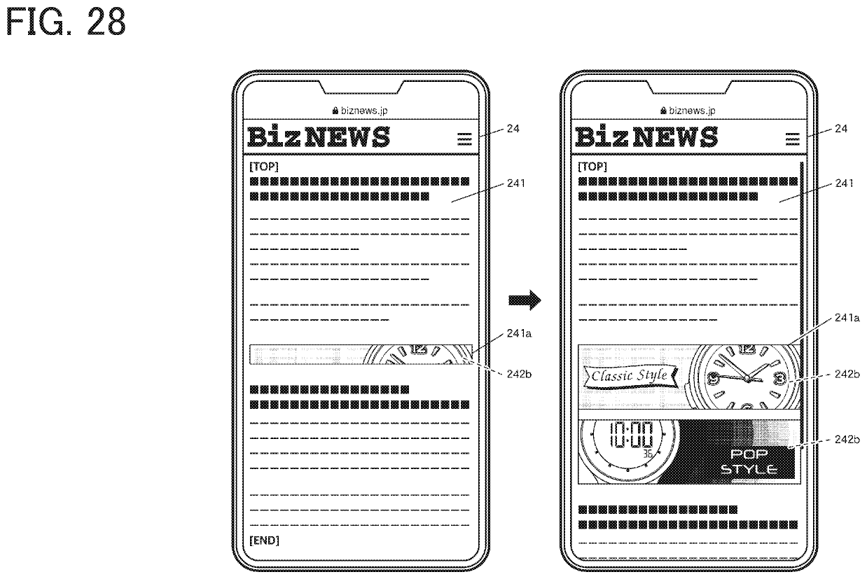

In the example shown in FIG. 28, in the terminal 20, two horizontally elongated partial advertisement images 242b are arranged aligned in the vertical direction in the first layer, and the web page 241 including the horizontally elongated transparent region 241a based on the initial setting is arranged in the second layer. The transparent region 241a based on the initial setting is a rectangle having a predetermined vertical width and horizontal width.

In this example, since the vertical width of the transparent region 241a based on the initial setting is only about 30% of the vertical width of one partial advertisement image 242b, only a portion of the one partial advertisement image 242b can be viewed and the other partial advertisement image 242b cannot be viewed at all.

Thereafter, the server 10 sets a transparent region 241a of a size according to which both of the partial advertisement images 242b become visible based on the vertical width and the horizontal width of each partial advertisement image 242b arranged in the first layer of the terminal 20, and transmits the main content data including the data of the web page 241 including the transparent region 241a to the terminal 20. As a result, the web page 241 including the transparent region 241a (the transparent region 241a changed from the initial setting) based on the main content data is arranged in the second layer of the terminal 20.

As a result, the user will be able to view both of the partial advertisement images 242b via the changed transparent region 241a.

As an example of the effect of this modification, the user can view the main content information before the transparent region 241a based on the advertisement information associated with the main content information is set.

If the advertisement information associated with the main content information is changed based on the attribute information or website access history of the user, the partial advertisement image 242b differs depending on the user, and the load of setting a different transparent region 241a for each user is generated in the server 10. As a result, it takes a predetermined amount of time to set the transparent region 241a based on the partial advertisement image 242b on the server 10 side and transmit the main content data of the main content information (web page 241) having the transparent region 241a to the terminal 20, and a user who cannot immediately see the main content information will feel uncomfortable.

In this variation, due to the web page 241 including the transparent region 241a in the initial setting being temporarily displayed on the terminal 20 at a stage before the transparent region 241a is based on the partial advertisement image 242b, it is possible to prevent the display of the main content information from being delayed.

Sixth Variation (4)

The method of setting the billing amount described in the above-described embodiment is merely an example, and there is no limitation thereto.

The billing amount may optionally be set in consideration of not only the vertical width of the partial advertisement image but also the horizontal width of the partial advertisement image, for example, without limitation thereto.

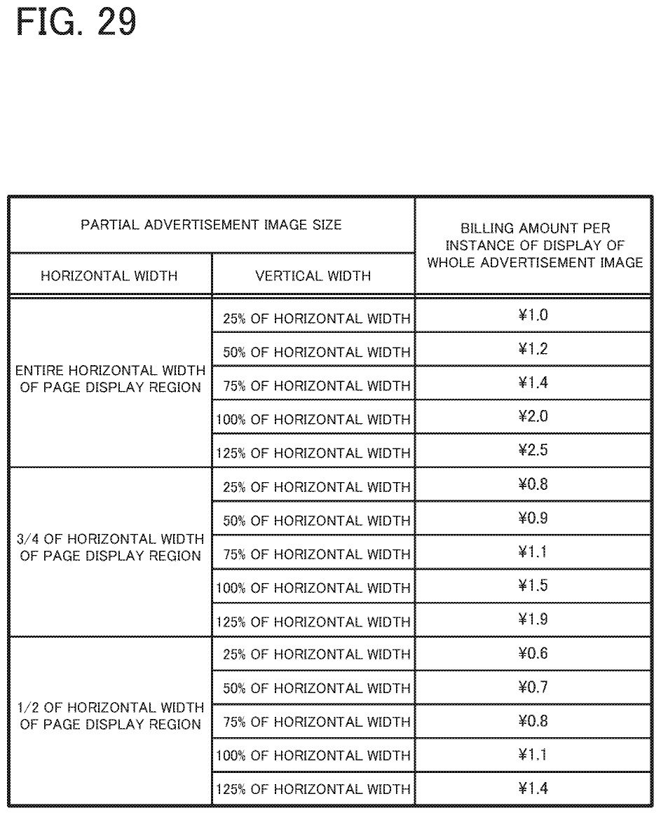

FIG. 29 is a diagram showing another example of a table showing the relationship between the size of the partial advertisement image and the billing amount. This table can be stored in the storage 15 of the server 10, for example, without limitation thereto.

The configuration of this table is almost the same as that of FIG. 25, but the column of the partial advertisement image size is different. Specifically, in this table, the partial advertisement image size includes the horizontal width of the partial advertisement image and the vertical width of the partial advertisement image.

The horizontal width is classified into three categories: “the entire horizontal width of the page display region”, “¾ of the horizontal width of the page display region”, and “½ of the horizontal width of the page display region”, for example, without limitation thereto.

In each column for the horizontal width, for the vertical width, “25% of horizontal width”, “50% of horizontal width”, “75% of horizontal width”, “100% of horizontal width” and “125% of horizontal width” are defined as the vertical width according to the percentage with respect to the horizontal width, for example, without limitation thereto.

Regarding the horizontal width of the partial advertisement image “the entire width of the page display region”, the billing amount “1.0 yen” is set for “25% of the horizontal width”, the billing amount “1.2 yen” is set for “50% of the horizontal width”, the billing amount “1.4 yen” is set for “75% of the horizontal width”, the billing amount “2.0 yen” is set for “100% of the horizontal width”, and the billing amount “2.5 yen” is set for “125% of the horizontal width”. That is, the higher the percentage with respect to the horizontal width, the higher an amount of money is set as the billing amount.

Alternatively or additionally, regarding the horizontal width of the partial advertisement image “¾ of the horizontal width of the page display region”, the billing amount “0.8 yen” is set for “25% of the horizontal width”, the billing amount “0.9 yen” is set for “50% of the horizontal width”, the billing amount “1.1 yen” is set for “75% of the horizontal width”, the billing amount “1.5 yen” is set for “100% of the horizontal width, and the billing amount “1.9 yen” is set for “125% of the horizontal width”. That is, the higher the percentage with respect to the horizontal width, the higher an amount of money is set as the billing amount.

Alternatively or additionally, regarding the horizontal width of the partial advertisement image “½ of the horizontal width of the page display region”, the billing amount “0.6 yen” is set for “25% of the horizontal width”, the billing amount “0.7 yen” is set for “50% of the horizontal width”, the billing amount “0.8 yen” is set for “75% of the horizontal width”, the billing amount “1.1 yen” is set for “100% of the horizontal width, and the billing amount “1.4 yen” is set for “125% of the horizontal width”. That is, the higher the percentage with respect to the horizontal width, the higher an amount of money is set as the billing amount.

Alternatively or additionally, as the percentage of the horizontal width with respect to the page display region increases, a higher amount of money is set as the billing amount for the same vertical width. That is, the higher the percentage of the horizontal width with respect to the page display region, the higher an amount of money is set as the billing amount.

Alternatively or additionally, in the case of a vertically elongated image in which the vertical width of the partial advertisement image is larger than the horizontal width, a higher billing amount is set than in the case of a horizontally elongated image.

Alternatively or additionally, in the above-described embodiment, the billing amount was classified based on the vertical width set according to the percentage with respect to the horizontal width of the page display region, but the billing amount may optionally be categorized based on the actual length of the vertical width of the partial advertisement image.

Similarly, the billing amount may optionally be classified based on the actual length of the horizontal width of the partial advertisement image.

Sixth Variation (5)

If the sixth embodiment is applied to the second embodiment or the third embodiment, a configuration may be used in which the storage 15 of the server 10 does not store the partial advertisement database 153b. The server 10 may optionally be configured to store the region-of-interest information for identifying the region of interest in the whole advertisement image 242a in association with the image ID of the whole advertisement image 242a, for example, without limitation thereto.

Alternatively or additionally, the relationship between the size of the partial advertisement image 242b shown in FIGS. 25 and 29 and the billing amount generated by displaying the whole advertisement image 242a can be applied to the relationship between the size of the region of interest and the billing amount generated by displaying the entirety of the whole advertisement image 242a including the region of interest.

In the configuration according to this variation, in A25 of FIG. 12, the terminal 20 may transmit advertisement display information including the image ID of the whole advertisement image 242a to the server 10 based on the entirety of the whole advertisement image 242a being displayed on the display 24 (based on the entirety of the whole advertisement image 242a becoming visible). The server 10 that has received the advertisement display information may update the billing amount relating to the advertisement with the advertisement number associated with the image ID included in the advertisement display information and the billing amount to the advertiser of the advertiser ID associated with the advertisement number.

In such a variation, if a plurality of advertisements are associated with one piece of main content information, in the main content database 152, two different advertisement numbers (hereinafter referred to as the first advertisement number and the second advertisement number) are associated with one main content ID, for example, without limitation thereto. Then, if the main content data of the main content ID is distributed to the terminal 20, first advertisement content data (including the data of the first whole advertisement image, and the region-of-interest information for identifying the first region of interest, which is a portion of the first whole advertisement image), which is associated with the first advertisement number, and second advertisement content data (including data of the second whole advertisement image and region-of-interest information for identifying a second region of interest, which is a portion of the second whole advertisement image), which is associated with the second advertisement number, may be distributed to the terminal 20.

Then, the first region of interest and the second region of interest are arranged aligned in the vertical direction in the first layer, and the main content information is arranged in the second layer. Furthermore, based on the second input (touch operation) performed on the first region of interest, the entirety of the first whole advertisement image may be displayed (become visible), and based on the second input (touch operation) performed on the second region of interest, the entirety of the second whole advertisement image may be displayed (become visible).

### Seventh Embodiment

The seventh embodiment is an embodiment in which a plurality of partial advertisement images are arranged in the first layer.

The seventh embodiment differs from the fourth to sixth embodiments in that not one partial advertisement image, but a plurality of partial advertisement images are arranged in the first layer.

The features described in the seventh embodiment can also be applied to and/or combined with other embodiments and variations.

The same constituent elements as those already mentioned are denoted by the same reference numerals, and redundant description thereof is omitted.

In this embodiment, if different partial advertisement images are arranged adjacent to each other, they are illustrated and described as being arranged with a gap provided therebetween so that the user can recognize that they are different partial advertisement images.

However, unlike with the present embodiment, the different partial advertisement images may optionally be arranged without a gap provided therebetween (in contact with each other).

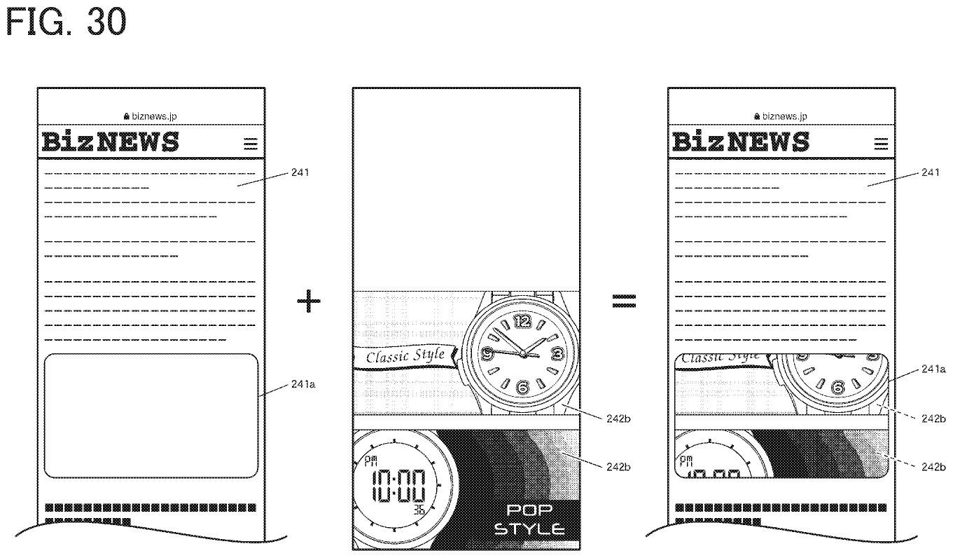

In the example shown in FIG. 30, two partial advertisement images 242b are arranged as advertisement content information in the first layer, and a web page 241 is arranged in the second layer.

Specifically, as shown in FIG. 30, the first partial advertisement image 242b of the digital wristwatch is arranged in the lower portion of the first layer, and the second partial advertisement image 242b of the analog wristwatch is arranged in the central portion, for example, without limitation thereto. Alternatively or additionally, the web page 241 of the business news site is arranged as the main content information in the second layer.

The web page 241 includes a document (a non-limiting example of text information included in the third content information) and an image (a non-limiting example of image information included in the third content information) constituting a news article, but these are both arranged in the second layer.

The first partial advertisement image 242b and the second partial advertisement image 242b are both horizontally elongated images and are arranged aligned in the vertical direction in the first layer. The first partial advertisement image 242b is an image obtained by trimming a portion of the first whole advertisement image 242a, and is arranged at the lower end of the page display region of the terminal 20, for example, without limitation thereto.

The second partial advertisement image 242b is an image obtained by trimming a portion of the second whole advertisement image 242a to substantially the same size as the size of the first partial advertisement image 242b, and is arranged adjacent to the upper side of the first partial advertisement image 242b, for example, without limitation thereto. That is, the first partial advertisement image 242b and the second partial advertisement image 242b are located at the lower portion of the screen and the central portion of the screen, respectively.

In this embodiment, the relative position of the first partial advertisement image 242b with respect to the page display region and the relative position of the second partial advertisement image 242b with respect to the page display region are fixed, for example, without limitation thereto. That is, the first partial advertisement image 242b and the second partial advertisement image 242b do not change their positions even if the user scrolls the web page 241.

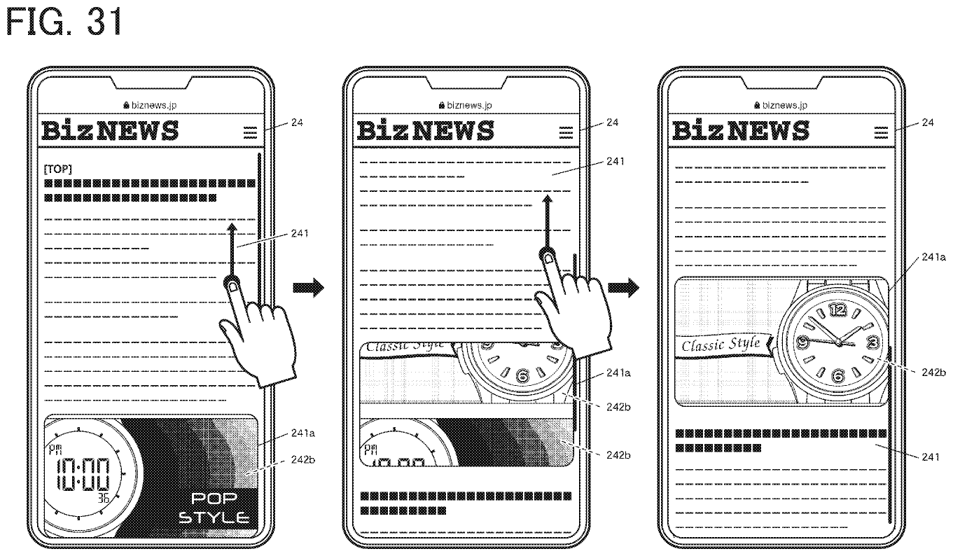

As shown in FIG. 31, due to the user accessing the business news site using the web browser of the terminal 20, the web page 241 is displayed in the page display region.

In this example, since the vertical width of the web page 241 is larger than the vertical width of the page display region, the entirety of the web page 241 cannot fit in the page display region. As a result, a portion of the web page 241 including the top portion [TOP] of the web page 241 is initially displayed in the page display region, and the remaining portion including the final portion [END] of the web page 241 is not displayed. In this state, the web page 241 is in the initial position.

In this example, in the state where the web page 241 is in the initial position, the transparent region 241a is arranged at the lower end of the page display region. The transparent region 241a is a horizontally elongated region with a horizontal width that is larger than its vertical width, and has substantially the same size as the first partial advertisement image 242b. For this reason, the entirety of the first partial advertisement image 242b at the lower portion of the screen is viewed via the transparent region 241a.

If the web page 241 is in the initial position, the user touches the page display region (i.e., the region different from the transparent region 241a) and performs a scroll operation of moving his or her finger in the screen upward direction, and thereby the web page 241 scrolls in the screen upward direction. Accompanying this, the transparent region 241a moves upward, and a portion of the upper side of the first partial advertisement image 242b and a state is entered in which a portion of the lower side of the second partial advertisement image 242b are viewed via the transparent region 241a.

Thereafter, when the user continues the scroll operation and moves the final portion [END] of the web page 241 to the page display region, the transparent region 241a also scrolls in the screen upward direction accompanying the web page 241 scrolling in the screen upward direction, and the transparent region 241a and the second partial advertisement image 242b are superimposed on each other. This state is a state in which the web page 241 is in a terminal end position.

Processing

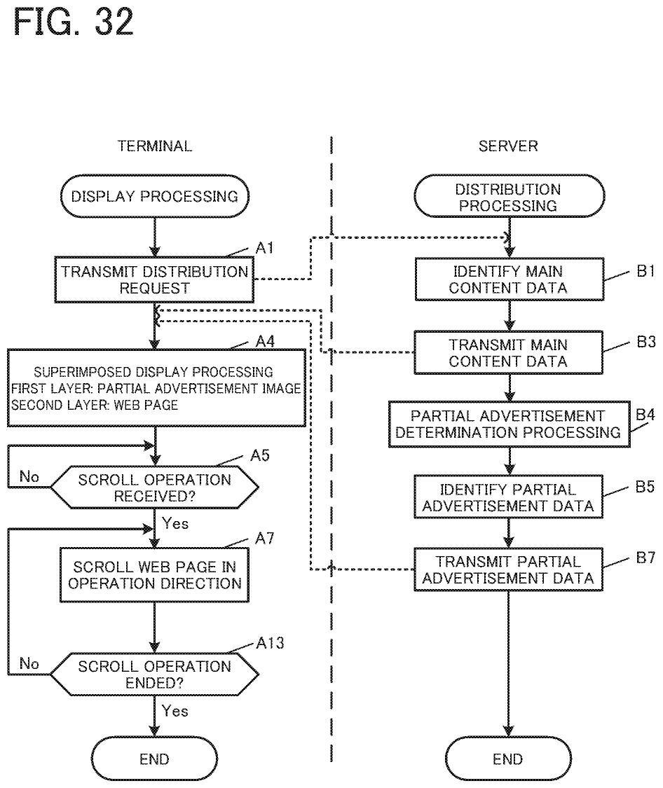

FIG. 32 is a flowchart showing an example of a flow of processing executed by each device in this embodiment.

In this diagram, distribution processing executed by the distribution processor 111 of the server 10 and display processing executed by the display processor 211 of the terminal 20 are shown.

The same steps as those in the flowchart described above are denoted by the same reference numerals, redundant description thereof is omitted, and the description will be given with a focus on steps that are different.

The flowchart described hereinafter merely illustrates processing in this embodiment, and in the flowchart described hereinafter, some steps need not be executed, and additional steps may be inserted.

FIG. 32 is a flowchart obtained by adding, to the flowchart of FIG. 19, a step (non-limiting examples of which include step B4) of partial advertisement determination processing for determining the partial advertisement image 242b after the processing (B3) in which the main content data to be distributed (non-limiting examples of which include including data relating to the web page 241 of the news site), and erasing the steps (non-limiting examples of which include steps A1b to A12a) of processing for fixing the relative position of the transparent region 241a with respect to the partial advertisement image 242b if the region of interest and the transparent region 241a are superimposed on each other.

After B3, the server 10 analyzes the content of the main content data to be distributed as the partial advertisement determination processing, and extracts three or more pieces of partial advertisement data having content relating to that content from the partial advertisement database 153b. Then, two pieces of partial advertisement data to be distributed to the terminal 20 are randomly selected from the extracted three or more pieces of partial advertisement data (B4).

Thereafter, the server 10 identifies the selected partial advertisement data from the partial advertisement database 153b (B5), transmits the identified partial advertisement data (non-limiting examples of which include data relating to the partial advertisement image 242b) to the terminal 20 through the communication I/F 14 (B7), and ends the distribution processing.

It is to be understood that the method for selecting the two pieces of partial advertisement data to be distributed to the terminal 20 from the three or more pieces of partial advertisement data is not limited to such a method. Two pieces of partial advertisement data to be distributed to the terminal 20 may be selected based on the time zone, the preference of the user, or the like, for example, without limitation thereto.

### Effects of Seventh Embodiment

The seventh embodiment shows a configuration in which the first partial advertisement image 242b (a non-limiting example of first information), which is a portion of the first whole advertisement image 242a (a non-limiting example of first content information) and the second partial advertisement image 242b (a non-limiting example of second information), which is a portion of the second whole advertisement image 242a (a non-limiting example of second content information) are displayed in at least the page display region (a non-limiting example of a display region of a terminal), and the main content information (web page 241) (a non-limiting example of third content information), which is superimposed on at least portions of the first partial advertisement image 242b and the second partial advertisement image 242b and at least partially includes the transparent region 241a, is displayed in the page display region. Then, control for moving in the page display region is executed on at least the transparent region 241a of the web page 241 based on a scroll operation (a non-limiting example of the first input) performed on the page display region by the user.

As an example of the effect obtained by such a configuration, the first information and the second information are fixed in the display region, whereas the transparent region moves in the display region based on the first input. For this reason, the user can view the first information and the second information via the transparent region.

The seventh embodiment shows a configuration in which the first input is a scroll operation performed by the user, and the transparent region 241a is moved in a direction based on the scroll operation.

As an example of the effect obtained by such a configuration, due to the transparent region moving in the direction intended by the user, it is possible to increase the likelihood that the user will pay attention to at least one of the first information and the second information.

The seventh embodiment shows a configuration in which the first content information is advertisement information (non-limiting examples of which include the first whole advertisement image 242a), and the first information (non-limiting examples of which include a first partial advertisement image 242b) is a portion thereof.

As an example of the effect obtained by such a configuration, since the user can be made to recognize the content of the advertisement information via the transparent region moving in the display region, the advertisement effect can be improved.

The seventh embodiment shows a configuration that includes the terminal 20 receiving the third content data (non-limiting examples of which include main content data) through the communication I/F 22, and the third content information (non-limiting examples of which include a web page for business news, etc.) is based on the third content data.

As an example of the effect obtained by such a configuration, the third content information can be displayed based on the data received from outside the terminal.

The seventh embodiment shows a configuration in which the third content information (non-limiting examples of which include a web page of business news) includes text information or image information, and the transparent region 241a does not include text information or image information.

As an example of the effect obtained by such a configuration, it is easier to distinguish between the third content information and the first information and second information that are visible via the transparent region.

Other Effects

The seventh embodiment has a configuration in which the transparent region of the main content information arranged in the second layer moves based on the input performed by the user, but the plurality of partial advertisement images arranged in the first layer do not move together with the transparent region of the main content information.

More specifically, the seventh embodiment shows a configuration in which the controller 21 executes control for moving in the page display region in the transparent region 241a based on the direction of the first input performed by the user.

As an example of the effect obtained by such a configuration, the user can change the movement direction of the transparent region by changing the direction of the first input, and thus it is possible to increase the likelihood that the user will pay attention to at least one of the first information and the second information.

Alternatively or additionally, in the display example shown in FIG. 31, in a state where the final portion [END] of the web page 241 has moved to the page display region, the user can view the entire second partial advertisement image 242b via the transparent region 241a.

That is, if the web page 241 is in the initial position, the entire first partial advertisement image 242b becomes visible via the transparent region 241a, and if the web page 241 is in the terminal end position, the entire second partial advertisement image 242b becomes visible via the transparent region 241a.

When the user finishes reading the content of the web page 241, the web page 241 is in the terminal end position, and the entire second partial advertisement image 242b is visible via the transparent region 241a. Alternatively or additionally, after the user finishes reading the content of the web page 241, the web page 241 often continues to not be scrolled.

That is, after the user finishes reading the content of the web page 241, the state in which the second partial advertisement image 242b can be viewed via the transparent region 241a often continues for a long time, but the second partial advertisement image 242b will not be visible unless the user scrolls the web page 241.

On the other hand, before the user reads the content of the web page 241, the web page 241 is in the initial position, and the entire first partial advertisement image 242b is visible via the transparent region 241a. Due to the above, the likelihood that the first partial advertisement image 242b will be viewed is higher than the likelihood that the second partial advertisement image 242b will be viewed.

Accordingly, it can be said that the first partial advertisement image 242b has a higher value as an advertisement than the second partial advertisement image 242b, for example, without limitation thereto.

Seventh Variation (1)

In the seventh embodiment, an example was shown in which the main content information (web page 241) that partially includes the transparent region 241a is superimposed on the entire region of the first partial advertisement image 242b and the second partial advertisement image 242b arranged in the first layer, but there is no limitation to such a configuration, and the main content information (web page 241) that partially includes the transparent region 241a may be superimposed on a partial region of the first partial advertisement image 242b and the second partial advertisement image 242b arranged in the first layer.

In the seventh embodiment, an example was shown in which the entire region of the rectangular transparent region 241a moves due to the scroll operation, but there is no limitation to such a configuration, and a portion of the rectangular transparent region 241a may move due to the scroll operation.

In the seventh embodiment, an example was shown in which the transparent region 241a in the web page 241 and another region (text region of a news article, etc.) move together due to a scroll operation, but there is no limitation to such a configuration, and the transparent region 241a may be movable independently of the other regions.

Seventh Variation (2)

In the seventh embodiment, the first content information and the second content information were advertisement information, but at least one of the first content information and the second content information is not limited to the advertisement information and may be other content information. At least one of the first content information and the second content information may be content information related to the third content information, for example, without limitation thereto, and if the third content information is a document of a news article, at least one of the first content information and the second content information may be a news image related to the news article, and at least one of the first information and the second information may be a portion of that news image, for example, without limitation thereto.

As an example of the effect obtained by such a configuration, it is possible to diversify the display mode of the information related to the third content information.

Seventh Variation (3)

In the seventh embodiment, an example was shown in which the size of the transparent region 241a is substantially the same as the size of the partial advertisement image 242b. There is no limitation to such a configuration, and the size of the transparent region 241a may be smaller than or larger than the size of the partial advertisement image 242b.

Seventh Variation (4)

In the seventh embodiment, an example was shown in which the first partial advertisement image 242b and the second partial advertisement image 242b are horizontally elongated images, but at least one of the first partial advertisement image 242b and the second partial advertisement image 242b may be a vertically elongated image.

In the seventh embodiment, an example was shown in which the transparent region 241a of the web page 241 is in the page display region in the state where the web page 241 is in the initial position, and the user can confirm this (see FIGS. 30 and 31). There is no limitation to such a configuration, and the transparent region 241a of the web page 241 may be prevented from being located in the page display region in the state where the web page 241 is in the initial position.

Seventh Variation (5)

In the seventh embodiment, an example was shown in which two partial advertisement images 242b, namely the first partial advertisement image 242b and the second partial advertisement image 242b, are arranged in the page display region, but three or more partial advertisement images 242b may be arranged in the page display region.

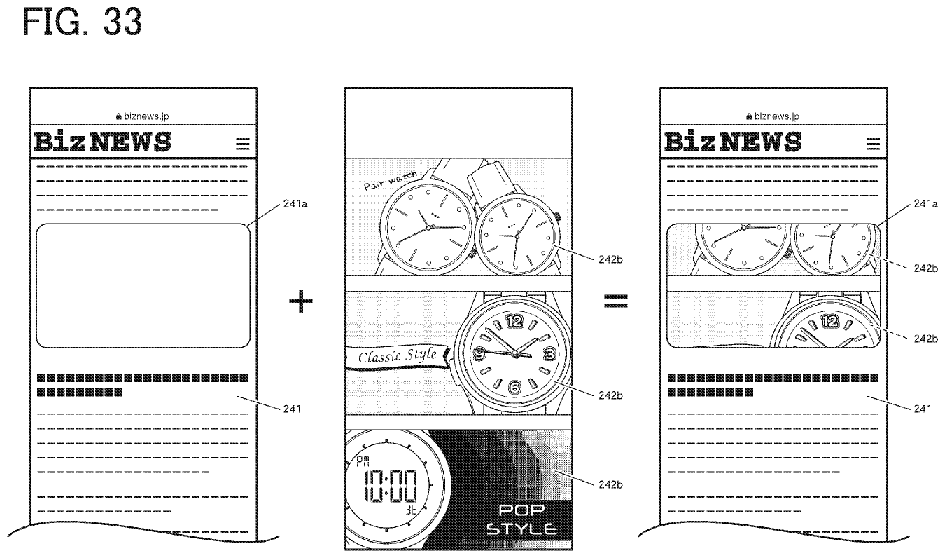

In the examples shown in FIGS. 33 to 35, three partial advertisement images 242b are arranged as the advertisement content information in the first layer, and the web page 241 of a business news site is arranged as the main content information in the second layer.

Specifically, as shown in FIG. 33, the first partial advertisement image 242b of the digital wristwatch is arranged at the lower portion in the first layer, and the second partial advertisement image 242b of the analog wristwatch is arranged at the central portion, for example, without limitation thereto. In addition to these, the third partial advertisement image 242b, which is an advertisement image of pair watches, is arranged at the upper portion in the first layer. Alternatively or additionally, the web page 241 is arranged in the second layer.

The third partial advertisement image 242b is a horizontally elongated image obtained by trimming a portion of the third whole advertisement image 242a to substantially the same size as the first partial advertisement image 242b, and is arranged adjacent to the upper side of the second partial advertisement image 242b. That is, the first partial advertisement image 242b, the second partial advertisement image 242b, and the third partial advertisement image 242b are located at the lower portion of the screen, the central portion of the screen, and the upper portion of the screen, respectively.

The relative position of the third partial advertisement image 242b with respect to the page display region is fixed. That is, the first partial advertisement image 242b, the second partial advertisement image 242b, and the third partial advertisement image 242b do not change their positions even when the user scrolls the web page 241.

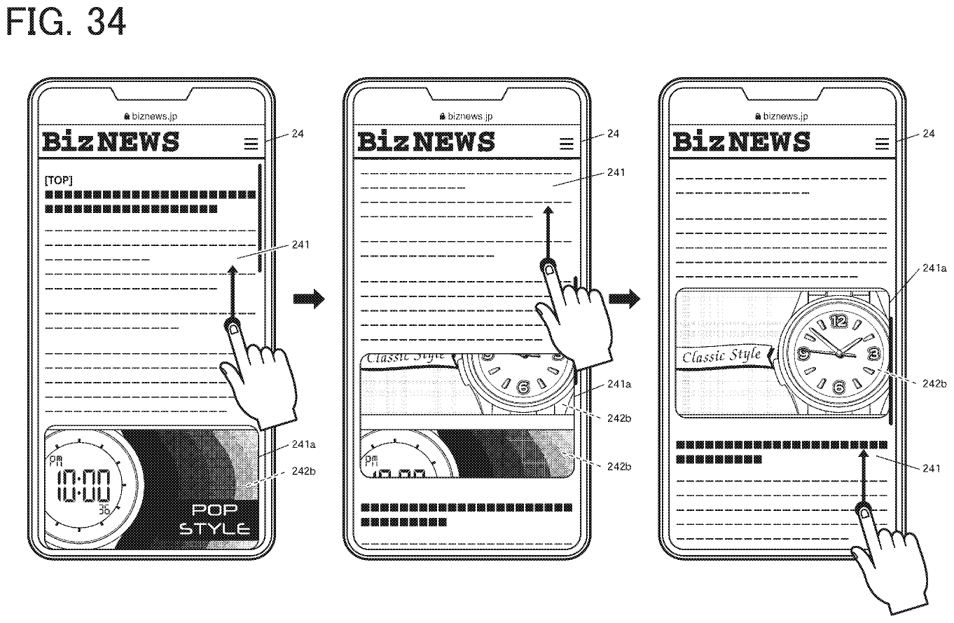

As shown in FIG. 34, in this example, the vertical width of the web page 241 is larger than the vertical width of the page display area, and therefore the entirety of the web page 241 cannot fit in the page display region. As a result, in the state where the web page 241 is in the initial position, a portion of the web page 241 including the top portion [TOP] of the web page 241 is displayed in the page display region, and the remaining portion including the final portion [END] of the web page 241 is not displayed. Alternatively or additionally, since the length of the web page 241 is long, the moving distance of the transparent region 241a is also large.

The transparent region 241a has substantially the same size as the first partial advertisement image 242b, and is arranged at the lower end of the page display region. For this reason, the entire first partial advertisement image 242b at the lower portion of the screen is viewed via the transparent region 241a.

If the web page 241 is in the initial position, the user touches the page display region (i.e., the region different from the transparent region 241a) and performs a scroll operation of moving his or her finger in the screen upward direction, and thereby the web page 241 scrolls in the screen upward direction. Accompanying this, the transparent region 241a moves upward, and a portion of the upper side of the first partial advertisement image 242b and a portion of the lower side of the second partial advertisement image 242b are viewed via the transparent region 241a. When the transparent region 241a moves further upward, the transparent region 241a and the second partial advertisement image 242b are superimposed, and the user can view the entire second partial advertisement image 242b via the transparent region 241a.

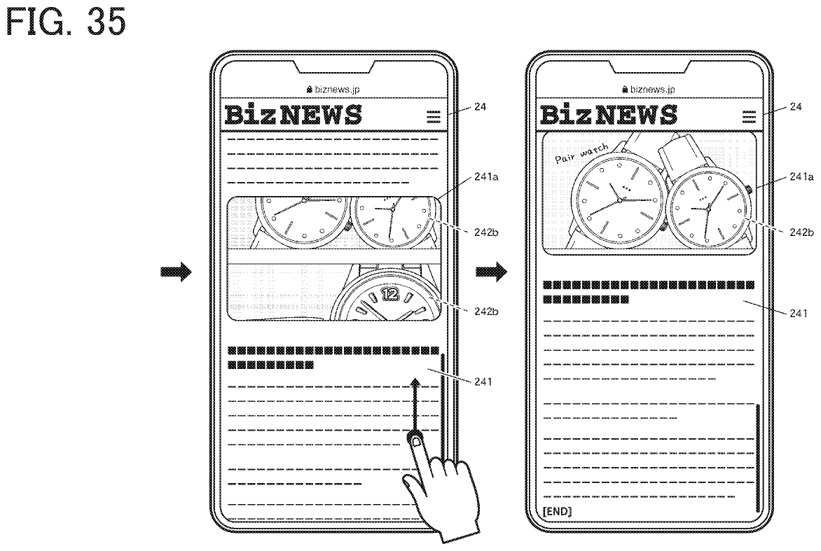

As shown in FIG. 35, when the user continues the scroll operation and scrolls the web page 241 in the screen upward direction, the transparent region 241a moves further upward, and a portion of the upper side of the second partial advertisement image 242b and a portion of the lower side of the third partial advertisement image 242b enter a state of being viewed via the transparent region 241a. Then, when the user continues the scroll operation and moves the final portion [END] of the web page 241 to the page display region, the transparent region 241a also scrolls in the screen upward direction accompanying the web page 241 scrolling in the screen upward direction, and the transparent region 241a and the third partial advertisement image 242b are superimposed on each other.

Accordingly, in a state where the final portion [END] of the web page 241 has moved to the page display region, the entire third partial advertisement image 242b becomes visible via the transparent region 241a.

Before the user reads the content of the web page 241, the web page 241 is in the initial position (TOP) and the entirety of the first partial advertisement image 242b at the lower portion of the first layer is visible via the transparent region 241a of the web page.

On the other hand, after the user has finished reading the content of the web page 241, the web page 241 is in the final position (END), and the entire third partial advertisement image 242b at the upper portion of the first layer is visible via the transparent region 241a of the web page.

After the user finishes reading the content of the web page 241, the web page is often not moved from that position, and therefore the third partial advertisement image 242b can be viewed via the transparent region 241a for a long time in many cases. However, on the other hand, the third partial advertisement image 242b will not become visible unless the user scrolls the web page 241.

On the other hand, the second partial advertisement image 242b becomes visible via the transparent region 241a while the user is reading the content of the web page 241. That is, the time during which the second partial advertisement image 242b can be viewed via the transparent region 241a is often short.

Due to the above, it can also be said that the value of the first partial advertisement image 242b as an advertisement is the highest, the value of the third partial advertisement image 242b as an advertisement is the second highest, and the value of the second partial advertisement image 242b as an advertisement is the lowest, for example, without limitation thereto.

Effects of Seventh Variation (5)

In this variation, a third partial advertisement image 242b (a non-limiting example of third information), which is a portion of a third whole advertisement image 242a (a non-limiting example of fourth content information) that is different from the first whole advertisement image 242a (a non-limiting example of first content information) is displayed in the page display region (a non-limiting example of a display region of a terminal).

The transparent region 241a shows a configuration in which setting is performed based on the length of a side of the third partial advertisement image 242b (a non-limiting example of third information), or the size of the third partial advertisement image 242b.

As an example of the effect obtained by such a configuration, it is possible to set a transparent region that makes third information visible in addition to the first information and the second information.

Effects of Seventh Variation (6)

In the seventh embodiment, an example was shown in which two partial advertisement images 242b for different types of clocks are arranged in the page display region, and in the seventh modification (5), an example was shown in which three partial advertisement images 242b for different types of clocks are arranged in the page display region. There is no limitation to such a configuration, and two or more partial advertisement images 242b for products having different qualities and the like may be arranged in the page display region.

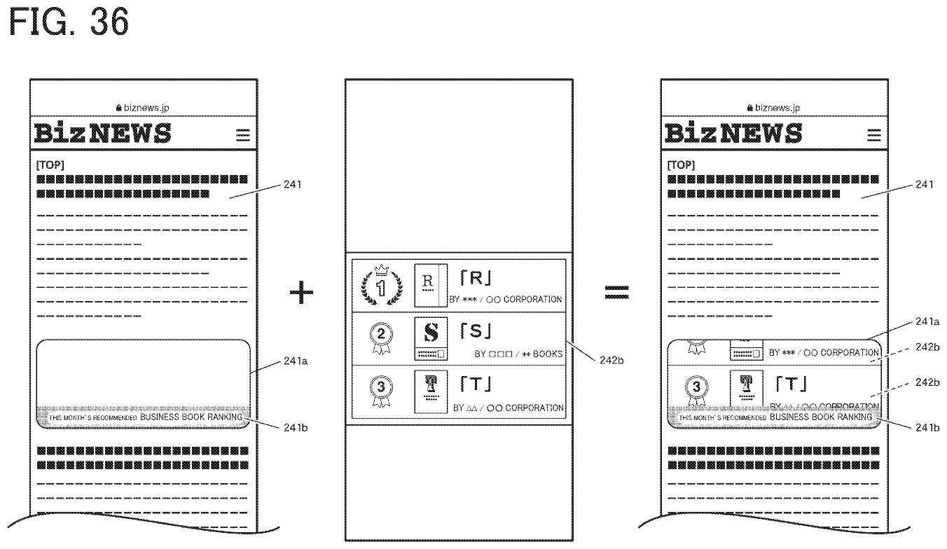

In the examples shown in FIGS. 36 to 38, three partial advertisement images 242b are arranged as advertisement content information in the first layer, and the web page 241 of the business news site is arranged as main content information in the second layer.

Specifically, as shown in FIG. 36, the partial advertisement image 242b, the second partial advertisement image 242b, and the third partial advertisement image 242b, which respectively correspond to the third, second, and first place in the current month's recommended business book ranking are arranged in the center in the stated order starting from the bottom in the first layer, for example, without limitation thereto. Alternatively or additionally, a web page 241 is arranged in the second layer.

The first partial advertisement image 242b, the second partial advertisement image 242b, and the third partial advertisement image 242b are all horizontally elongated images and have substantially the same size. The second partial advertisement image 242b is arranged adjacent to the upper side of the first partial advertisement image 242b, and the third partial advertisement image 242b is arranged adjacent to the upper side of the second partial advertisement image 242b. That is, in the first layer, the partial advertisement images 242b of the business books whose rankings are third, second, and first place are arranged from the lower side to the upper side.

The relative positions of the first partial advertisement image 242b, the second partial advertisement image 242b, and the third partial advertisement image 242b with respect to the page display region are fixed.

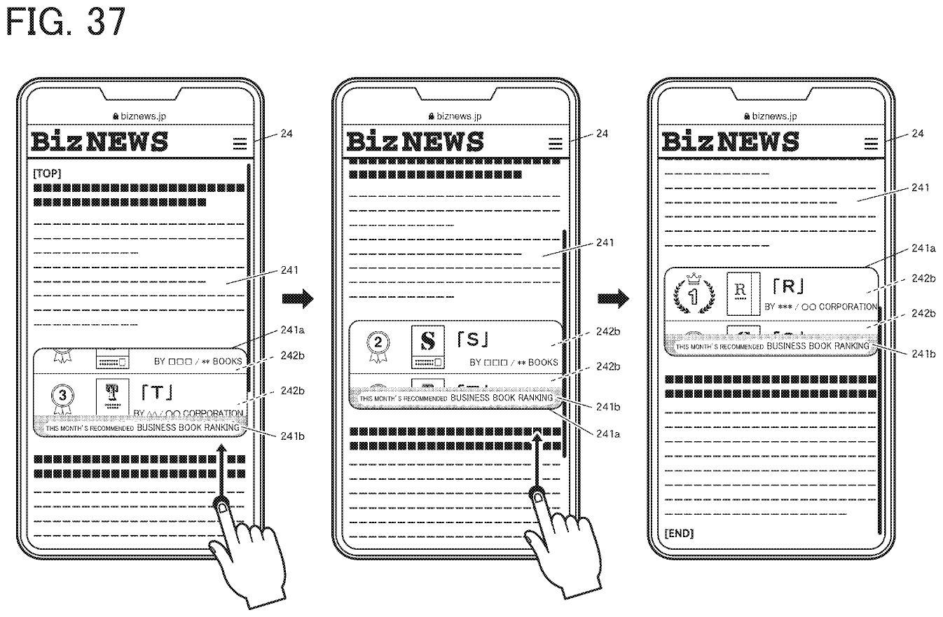

As shown in FIG. 37, the vertical width of the web page 241 is larger than the vertical width of the page display region, and therefore the entirety of the web page 241 cannot fit in the page display region. As a result, in the state where the web page 241 is in the initial position, a portion of the web page 241 including the top portion [TOP] of the web page 241 is displayed in the page display region, and the remaining portion including the final portion [END] of the web page 241 is not displayed.

The transparent region 241a is a horizontally elongated region with a horizontal width that is larger than its vertical width, and has substantially the same horizontal width as the first partial advertisement image 242b, but the transparent region 241a has a vertical width that is about 1.7 times the vertical width of the second partial advertisement image 242b, for example, without limitation thereto. Alternatively or additionally, an opaque label 241b denoted by the character string “This month's recommended business book ranking” is arranged at the lower end of the transparent region 241a.

The transparent region 241a is arranged so as to be superimposed on the first partial advertisement image 242b when the web page 241 is in the initial position. For this reason, the first partial advertisement image 242b and a portion of the lower side of the second partial advertisement image 242b are viewed via the transparent region 241a.

If the web page 241 is in the initial position, the user touches the page display region (i.e., a region different from the transparent region 241a) and performs a scroll operation of moving his or her finger in the screen upward direction, and thereby the web page 241 scrolls in the screen upward direction. Accompanying this, the transparent region 241a moves upward, and a portion on the upper side of the first partial advertisement image 242b and the second partial advertisement image 242b are viewed via the transparent region 241a.

Thereafter, when the user continues the scroll operation and moves the final portion [END] of the web page 241 to the page display region, the transparent region 241a also scrolls in the screen upward direction accompanying the web page 241 scrolling in the screen upward direction, and the transparent region 241a overlaps with the portion on the upper side of the second partial advertisement image 242b and the third partial advertisement image 242b. That is, in the state where the web page 241 is in the terminal position, the user can view the portion on the upper side of the second partial advertisement image 242b and the third partial advertisement image 242b via the transparent region 241a.

Although an example was shown here in which three partial advertisement images 242b are aligned such that the rankings of the business books rise from the lower side to the upper side, there is no limitation to such a configuration, and the three partial advertisement images 242b may be aligned such that the partial advertisement image 242b of a business book with a higher ranking is arranged at a position with a higher advertisement value.

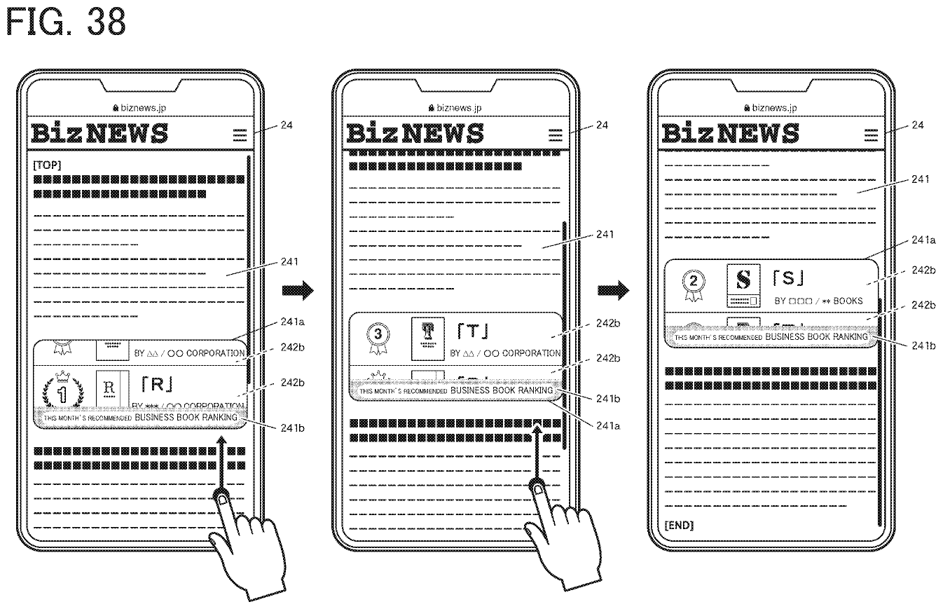

In the example shown in FIG. 38, the third partial advertisement image 242b corresponding to the business book whose ranking is first place is arranged on the lower side, at which the advertisement value is the highest, for example, without limitation thereto. Alternatively or additionally, the second partial advertisement image 242b corresponding to the business book whose ranking is second place is arranged on the upper side, at which the advertisement value is the second highest. Then, the first partial advertisement image 242b corresponding to the business book whose ranking is third place is arranged in the center, at which the advertisement value is the lowest. That is, in the first layer, from the bottom to the top, the third partial advertisement image 242b, the second partial advertisement image 242b, and the first partial advertisement image 242b respectively corresponding to the business books whose rankings are first, third, and second place arranged from the lower side to the upper side in the first layer.

Effects of Seventh Variation (3)

This variation shows a configuration in which the first partial advertisement image 242b (a non-limiting example of the first information) and the second partial advertisement image 242b (a non-limiting example of the second information) are displayed at the display position of the page display region (a non-limiting example of a display region of a terminal) based on the content.

As an example of the effect obtained by such a configuration, by displaying the first information and the second information in the display region so as to be aligned in the order of the content, the content can be made easy for the user to understand. Alternatively or additionally, by displaying the first information and the second information in the display region such that the order of the content and the order of the advertisement value of the arrangement position of the information match, information can be displayed at a position having the advertisement value corresponding to the content.

Furthermore, this variation shows a configuration in which the first partial advertisement image 242b (a non-limiting example of the first information), the second partial advertisement image 242b (a non-limiting example of the second information), and the third partial advertisement image 242b (a non-limiting example of the third information) are displayed at display positions of the page display region (a non-limiting example of the display region of the terminal) based on the content.

As an example of the effect obtained by such a configuration, by displaying the first information, the second information, and the third information in the display region so as to be aligned in the order of the content, it is possible to make the content easy for the user to understand. Alternatively or additionally, by displaying the first information, the second information, and the third information in the page display region such that the order of the content and the order of the advertisement value of the arrangement position of the information match, information can be displayed at a position that has advertisement value corresponding to its content.

In such a variation, an example was shown in which three partial advertisement images 242b are arranged in the page display region, but there is no limitation to such a configuration, and two partial advertisement images 242b or four or more partial advertisement images 242b may be arranged in the page display region.

### Eighth Embodiment

The eighth embodiment is an embodiment in which the whole advertisement image 242a corresponding to the first partial advertisement image 242b is made visible based on the second input performed by the user on the first partial advertisement image 242b, for example, without limitation thereto. Alternatively or additionally, it is an embodiment in which the whole advertisement image 242a corresponding to the second partial advertisement image 242b is made visible based on the third input performed by the user the second partial advertisement image 242b. The eighth embodiment is executed after the execution of the superimposed display processing (A4) shown in FIG. 32, for example, without limitation thereto.

Although the eighth embodiment corresponds to the fifth embodiment, it differs in that in the terminal 20, the execution target of the control for making the whole advertisement image visible is extended to a plurality of partial advertisement images instead of one partial advertisement image.

The features described in the eighth embodiment can also be applied to and/or combined with other embodiments and variations.

The same constituent elements as those already mentioned are denoted by the same reference numerals, and redundant description thereof is omitted.

Display Screen Example

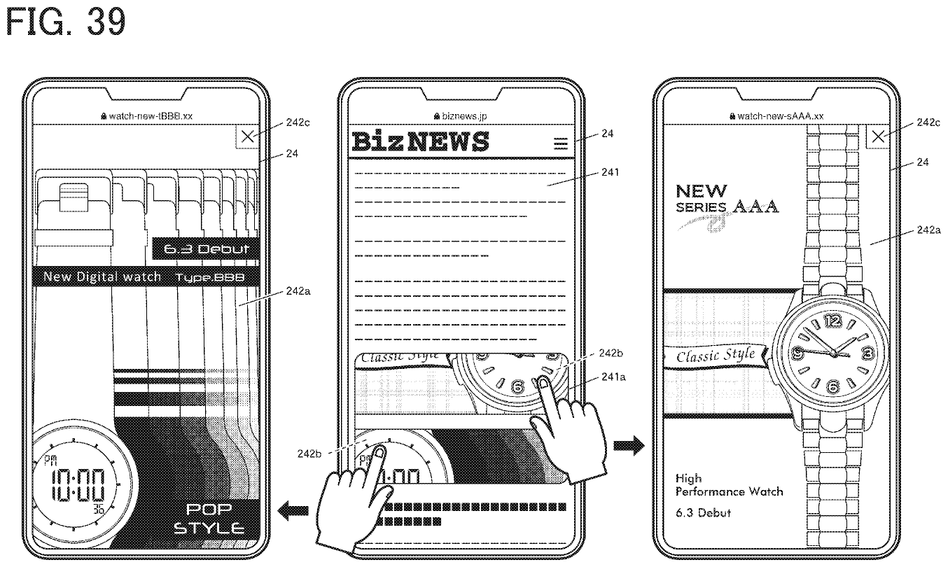

In the display screen shown in FIG. 39, the web page 241 scrolls from the initial position in the screen upward direction due to the scroll operation (A5 to A13) being performed after executing the superimposed display processing (A4) in FIG. 32 (A7), for example, without limitation thereto. Accompanying this, the transparent region 241a moves upward, and a portion of the upper side of the first partial advertisement image 242b and a portion of the lower side of the second partial advertisement image 242b are viewed via the transparent region 241a.

In this state, due to the user performing a touch operation (a non-limiting example of second input) of briefly touching the visible first partial advertisement image 242b (a non-limiting example of first information) on the touch panel, the first whole advertisement image 242a corresponding to the first partial advertisement image 242b becomes visible. The first partial advertisement image 242b is a vertically elongated advertisement image displayed in the entire page display region.

The first whole advertisement image 242a is an image that includes the entire region of the first partial advertisement image 242b and includes the region not included in the first partial advertisement image 242b as well. In this example, the only information included in the first partial advertisement image 242b is the appearance of the dial and release date of the digital wristwatch. In contrast to this, the first whole advertisement image 242a includes the appearance of the dial and release date of the digital wristwatch at the lower portion, and includes the belt of the digital wristwatch and the product name and advertisement text of the product at the upper portion.

That is, in this example, the first partial advertisement image 242b is set as an advertisement image obtained by trimming the lower portion of the first whole advertisement image 242a.

The second whole advertisement image 242a is an image that includes the entire region of the second partial advertisement image 242b and includes the region not included in the second partial advertisement image 242b as well. In this example, the only information included in the second partial advertisement image 242b is the appearance of the dial of the analog wristwatch. In contrast to this, the second whole advertisement image 242a includes one belt of the analog wristwatch, the product name, and the advertisement text in the upper portion, and includes the other belt of the analog wristwatch and the release date of the product in the lower portion.

That is, in this example, the second partial advertisement image 242b is set as an advertisement image obtained by trimming the central portion in the vertical direction of the second whole advertisement image 242a.

Processing

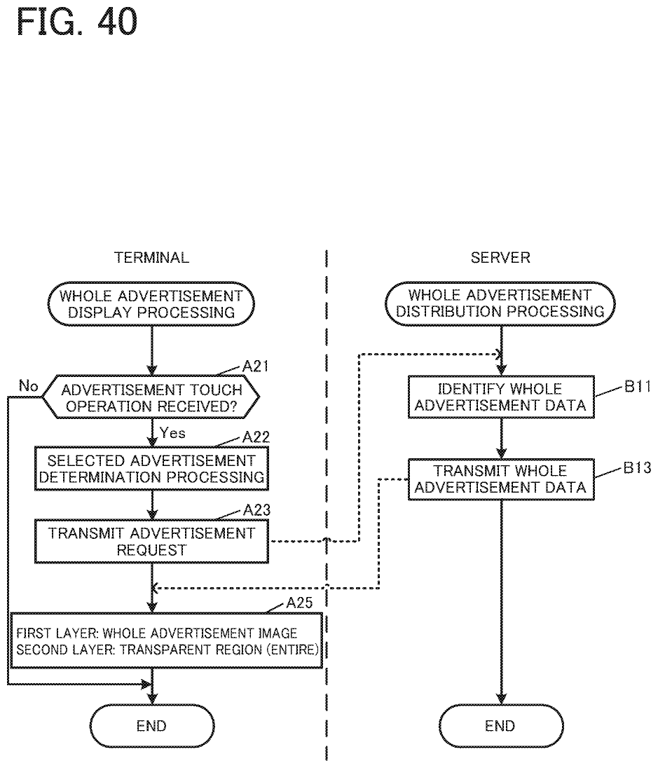

FIG. 40 is a flowchart showing an example of a flow of processing executed by each device in this embodiment.

In this diagram, the whole advertisement display processing executed by the display processor 211 of the terminal 20 is shown on the left side, and the whole advertisement distribution processing executed by the distribution processor 111 of the server 10 is shown on the right side.

The same steps as those in the flowchart described above are denoted by the same reference numerals, redundant description thereof is omitted, and description will be given with a focus on steps that are different.

The flowchart described below merely illustrates processing of this embodiment, and in the flowchart described below, some steps need not be executed and additional steps may be inserted.

FIG. 40 is a flowchart in which a step (non-limiting examples of which include step A21) of the operation for displaying the first whole advertisement image 242a or the second whole advertisement image 242a, a step (non-limiting examples of which include step A22) of determining the type of the whole advertisement image selected through the operation, and the like have been added to the flowchart shown in FIG. 21.

The terminal 20 determines whether or not an advertisement touch operation has been performed on the first partial advertisement image 242b or the second partial advertisement image 242b in a state where the transparent region 241a of the main content information is superimposed on the upper portion of the first partial advertisement image 242b and the lower portion of the second partial advertisement image 242b (A21).

If the user has performed an operation of touching the first partial advertisement image 242b or the second partial advertisement image 242b (A21: Yes), the terminal 20 performs selected advertisement determination processing for determining which of the first partial advertisement image 242b and the second partial advertisement image 242b the partial advertisement image 242b touched by the user is (A22).

If the terminal 20 has determined that the user has performed an operation (a non-limiting example of second input performed on the first information) of touching the first partial advertisement image 242b, the terminal 20 transmits an advertisement request including the advertisement number of the partial advertisement image 242b to the server 10 through the communication I/F 22. On the other hand, if the terminal 20 has determined that the user has performed an operation (a non-limiting example of third input performed on the second information) of touching the second partial advertisement image 242b, the terminal 20 transmits an advertisement request including the advertisement number of the partial advertisement image 242b to the server 10 through the communication I/F 22 (A23).

Note that the user performing the operation of touching the first partial advertisement image 242b or the second partial advertisement image 242b also corresponds to the operation of touching the transparent region 241a superimposed on the partial advertisement image 242b.

The terminal 20 receives the whole advertisement data identified by the server 10 based on the advertisement number (non-limiting examples of which include data regarding the first partial advertisement image 242b or the second partial advertisement image 242b). Then, the terminal 20 arranges the first partial advertisement image 242b or the second partial advertisement image 242b based on the whole advertisement data in the first layer, sets the entire web page 241 arranged in the second layer in the transparent region 241a (A25), and ends the whole advertisement display processing.

As a result, the user can view the entire first partial advertisement image 242b or second partial advertisement image 242b arranged in the first layer.

### Effects of Eighth Embodiment

The eighth embodiment shows a configuration in which the page display region of the display 24 is a vertically elongated region with a vertical direction that is longer than its horizontal direction, the first whole advertisement image 242a based on the whole advertisement data has a first side in the vertical direction and a second side in the horizontal direction that is shorter than the first side, the first partial advertisement image 242b has a third side in the vertical direction and a fourth side in the horizontal direction that is longer than the third side, and the first partial advertisement image 242b is arranged in the page display region with the third side arranged along the longitudinal direction of the page display region and the fourth side arranged along the lateral direction of the page display region.

As an example of the effect obtained by such a configuration, the visibility of the user can be improved by setting the first information as horizontally elongated information in which the third side is shorter than the fourth side.

The eighth embodiment shows a configuration in which the first whole advertisement image 242a is displayed in the page display region with the first side arranged along the longitudinal direction and the second side arranged along the lateral direction.

As an example of the effect obtained by such a configuration, by displaying the vertically elongated first content information in which the first side is longer than the second side, the attention of the user can be drawn to the first content information, and thus the information display effect can be improved.

The eighth embodiment shows a configuration in which, based on the second input performed by the user of the terminal 20 on the first partial advertisement image 242b, control for making the first whole advertisement image 242a visible to the user of the terminal 20 is executed by the controller 21, and based on the third input performed by the user of the terminal 20 on the second partial advertisement image 242b, control for making the second whole advertisement image 242a visible to the user of the terminal 20 is executed by the controller 21.

As an example of the effect obtained by such a configuration, a user who is interested in the first information can be guided to the first content information, and a user who is interested in the second information can be guided to the second content information.

The eighth embodiment shows a configuration in which the entirety of the second layer in which the main content information is arranged is set as the transparent region based on the second input performed by the user of the terminal 20 on the first partial advertisement image 242b or the third input performed by the user of the terminal 20 on the second partial advertisement image 242b.

As an example of the effect obtained by such a configuration, the first content information or the second content information can be made visible without changing the layer in which the first content information or the second content information is arranged to the second layer, which is higher than the first layer, for example, without limitation thereto.

In the eighth embodiment, the second input performed by the user of the terminal 20 on the first partial advertisement image 242b is an operation of touching the first partial advertisement image 242b, which is performed by the user of the terminal 20.

A configuration is shown in which the third input performed by the user of the terminal 20 on the second partial advertisement image 242b is an operation of touching the second partial advertisement image 242b, which is performed by the user of the terminal 20.

As an example of the effect obtained by such a configuration, if the user is interested in the first information or the second information, the first content information or second content information can be respectively displayed by performing an operation of touching the display region, for example, without limitation thereto.

Eighth Variation (1)

In the eighth embodiment, the entirety of the first whole advertisement image 242a or the second whole advertisement image 242a was made visible by setting the entire region of the web page 241 arranged in the second layer as the transparent region 241a in a state in which the first whole advertisement image 242a or the second whole advertisement image 242a is arranged in the first layer, but there is no limitation to such a configuration.

Specifically, the first whole advertisement image 242a may be arranged in the second layer based on the user touching the first partial advertisement image 242b, or the second whole advertisement image 242a may be arranged in the second layer based on the user touching the second partial advertisement image 242b, and the web page including the transparent region 241a may be arranged in the first layer, for example, without limitation thereto.

That is, the entirety of the advertisement information may be made visible due to a layer change in which the advertisement information arranged in the first layer and the main content information arranged are swapped being executed based on the input performed by the user, and as a result, the advertisement information being arranged in a layer above that of the main content information.

As an example of the effect obtained by such a configuration, the first content information or the second content information can be made visible without changing the transparent region.

Eighth Variation (2)

In the eighth embodiment, the web page 241 arranged in the second layer may be made visible again based on the elapse of a predetermined period (predetermined amount of time) after the processing of A25 is executed and the first whole advertisement image 242a or the second whole advertisement image 242a becomes visible, or based on execution of an operation for making it possible for the user to view the main content again.

The user touches the erase icon 242c indicated by “x” displayed in the upper right portion of the first whole advertisement image 242a shown in FIG. 39, whereby a portion of the first whole advertisement image 242a (upper side of the dial of the digital watch) is replaced with the second partial advertisement image 242b, and thereby the first partial advertisement image 242b and the second partial advertisement image 242b are arranged in the first layer, for example, without limitation thereto. Alternatively or additionally, the transparent region setting in the second layer is canceled, whereby the web page 241 of the second layer becomes visible again.

Similarly, due to the user touching the erase icon 242c indicated by “x” displayed in the upper right portion of the second whole advertisement image 242a shown in FIG. 39, a portion of the second whole advertisement image 242a (the lower side of the dial of the analog watch) is replaced with the first partial advertisement image 242b, and thereby the first partial advertisement image 242b and the second partial advertisement image 242b are arranged in the first layer. Alternatively or additionally, the transparent region setting in the second layer is canceled, whereby the web page 241 of the second layer becomes visible again. At this time, the web page 241 of the second layer is in a state of being superimposed on the first partial advertisement image 242b and the second partial advertisement image 242b in the first layer, and at least one of the first partial advertisement image 242b and the second partial advertisement image 242b is visible via the transparent region 241a.

It is to be understood that, regarding the eighth variation (1) as well, the web page 241 arranged in the first layer may be made visible by being arranged temporarily in the second layer again, based on the elapse of a predetermined period (predetermined amount of time) after the first whole advertisement image 242a or the second whole advertisement image 242a becomes visible, or based on the user executing an operation for making the main content information visible again.

If the user touches the erase icon 242c indicated by the “x” displayed in the upper right portion of the first whole advertisement image 242a shown in FIG. 39, a portion of the first whole advertisement image 242a (upper side of the dial of the digital watch) is replaced with the second partial advertisement image 242b, and thereby the first partial advertisement image 242b and the second partial advertisement image 242b are arranged in the second layer, for example, without limitation thereto. Similarly, if the user touches the erase icon 242c indicated by “x” displayed in the upper right portion of the second whole advertisement image 242a, a portion of the second whole advertisement image 242a (lower side of the dial of the analog watch) is replaced with the first partial advertisement image 242b, and thereby the first partial advertisement image 242b and the second partial advertisement image 242b are arranged in the second layer.

Then, the main content information may be made visible due to a layer change in which the main content information arranged in the first layer and the advertisement information arranged in the second layer are swapped being executed, and as a result, the main content information being arranged in a layer above that of the advertisement information again. At this time, the web page 241 in the second layer is in a state of being superimposed on the first partial advertisement image 242b and the second partial advertisement image 242b in the first layer, and at least one of the first partial advertisement image 242b and the first partial advertisement image 242b is visible via the transparent region 241a.

Eighth Variation (3)

In the example shown in FIG. 39, the first partial advertisement image 242b and the second partial advertisement image 242b are still images, and the first whole advertisement image 242a and the second whole advertisement image 242a respectively corresponding to the first partial advertisement image 242b and the second partial advertisement image 242b are also still images.

However, as described above, at least one of the first partial advertisement image 242b and the second partial advertisement image 242b may be either a still image or a moving image, and at least one of the first whole advertisement image 242a and the second whole advertisement image 242a may be either a still image or a moving image.

The first partial advertisement image 242b and the second partial advertisement image 242b are images obtained by trimming a portion of the first image of an animated GIF (animated Graphic Interchange Format), for example, without limitation thereto. Alternatively or additionally, the first whole advertisement image 242a and the second whole advertisement image 242a respectively corresponding to these may be moving images of an animated GIF (animated Graphic Interchange Format) including the first images thereof

The present disclosure is not limited in this regard, and the first partial advertisement image 242b and the second partial advertisement image 242b are images obtained by trimming a portion of the first frame of an MPEG (Moving Picture Experts Group). Alternatively or additionally, the first whole advertisement image 242a and the second whole advertisement image 242a respectively corresponding to these may be moving images in an MPEG standard (including, but not limited to one of MPEG-1, MPEG-2, and MPEG-4) including the first frames thereof.

Playback of the second whole advertisement image 242a, which is a moving image, is started based the fact that the second partial advertisement image 242b has been touched by the user, for example, without limitation thereto. In this example, similarly to the example shown in FIG. 14, the second hand of the analog wristwatch, which was stopped during the period when the second partial advertisement image 242b was displayed, starts operation based on the second whole advertisement image 242a being displayed.

Playback of the first whole advertisement image 242a, which is a moving image, is started based on the user touching the first partial advertisement image 242b, for example, without limitation thereto. In this example, a display portion of the number of seconds of the digital wristwatch, which was stopped during the period when the first partial advertisement image 242b was displayed, starts operation based on display of the first whole advertisement image 242a.

This variation shows a configuration in which the first whole advertisement image 242a is a moving-image advertisement image, and playback to the moving-image advertisement image is executed by the controller 21 based on the second input performed by the user of the terminal 20 on the first partial advertisement image 242b.

As an example of the effect obtained by such a configuration, it is possible to cause unexpectedness due to the stationary advertisement information starting to move based on the input performed by the user, and to draw the attention of the user to the first content information.

### Ninth Embodiment

The ninth embodiment is an embodiment in which setting of the first partial advertisement image 242b, the second partial advertisement image 242b, the third partial advertisement image 242b, and the transparent region 241a and billing processing performed based on the first partial advertisement image 242b, the second partial advertisement image 242b, and the third partial advertisement image 242b have been added to the above-described embodiments.

The ninth embodiment corresponds to the sixth embodiment, but differs in that there is not one, but a plurality of partial advertisement images.

The features described in the ninth embodiment can also be applied to and/or combined with other embodiments and variations.

The same constituent elements as those already mentioned are denoted by the same reference numerals, and redundant description thereof is omitted.

Functional Configuration

(1) Functional Configuration of Server

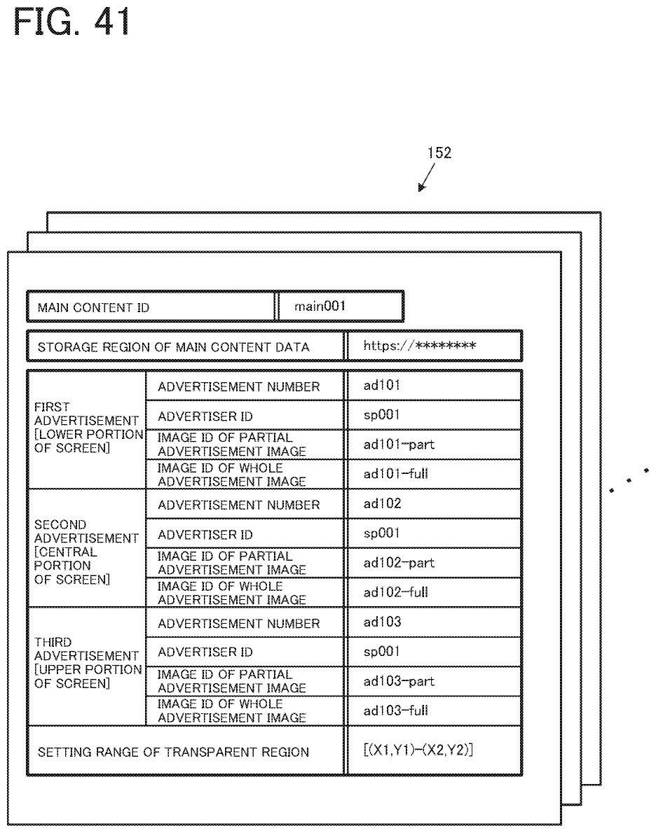

In the main content database 152 shown in FIG. 41, a main content ID for identifying the main content information based on the main content data, the storage region in which the main content data of the main content ID is stored, information to be used for display of each of a first advertisement, a second advertisement, and a third advertisement associated with the main content data of the main content ID, and the setting range of the transparent region in the main content information of the main content ID are stored in association with each other, for example, without limitation thereto.

The first advertisement, the second advertisement, and the third advertisement are advertisements that are displayed at the lower portion of the screen, the central portion of the screen, and the upper portion of the screen, respectively. The information used to display each of the first advertisement, the second advertisement, and the third advertisement includes an advertisement number for identifying the advertisement (advertisement information to be displayed on the terminal 20 together with the main content information), an advertiser ID for identifying the advertiser that provides the advertisement of the advertisement number, an image ID for identifying the partial advertisement image related to the advertisement of the advertisement number, and an image ID for identifying the whole advertisement image related to the advertisement of the advertisement number.

In this example, the image ID of the partial advertisement image and the image ID of the whole advertisement image corresponding to the partial advertisement image include the same advertisement number. For this reason, the server 10 can identify the partial advertisement image and the whole advertisement image constituting the advertisement of the advertisement number based on the advertisement number.

(2) Setting of Partial Advertisement Image by Advertiser

In this embodiment, the advertiser can set the display positions of the partial advertisement image, such as the first partial advertisement image, the second partial advertisement image, and the third partial advertisement image, and the partial advertisement image in the whole advertisement image, as appropriate.

The advertiser can set the partial advertisement image by operating the above-described setting device, for example, without limitation thereto.

In this example, the advertiser performs an operation of designating a region of a partial advertisement image in a state where the whole advertisement image is displayed on the display of the setting device. At this time, a rectangular trimming range of a predetermined size is displayed in the whole advertisement image. The vertical width of this trimming range is approximately ⅓ of the vertical width of the page display region of the terminal 20, and the horizontal width of the trimming range is a horizontal width that is slightly smaller than the horizontal width of the page display region of the terminal 20 (non-limiting examples of which include about 90% of the horizontal width of the page display region of the terminal 20). Due to the advertiser performing an operation of changing the position of the trimming range, the region designated by the trimming range is trimmed from the whole advertisement image and set as a partial advertisement image.

The advertiser performs an operation of setting a display position in the page display region of the terminal 20 for the trimmed partial advertisement image. The advertiser performs an operation of selecting one of the lower portion of the screen, the central portion of the screen, and the upper portion of the screen, for example, without limitation thereto. The setting device transmits a registration request including the display position of the partial advertisement image based on the selection result of the advertiser, the data of the whole advertisement image, and the data of the partial advertisement image to the server 10 based on the operation performed by the advertiser.

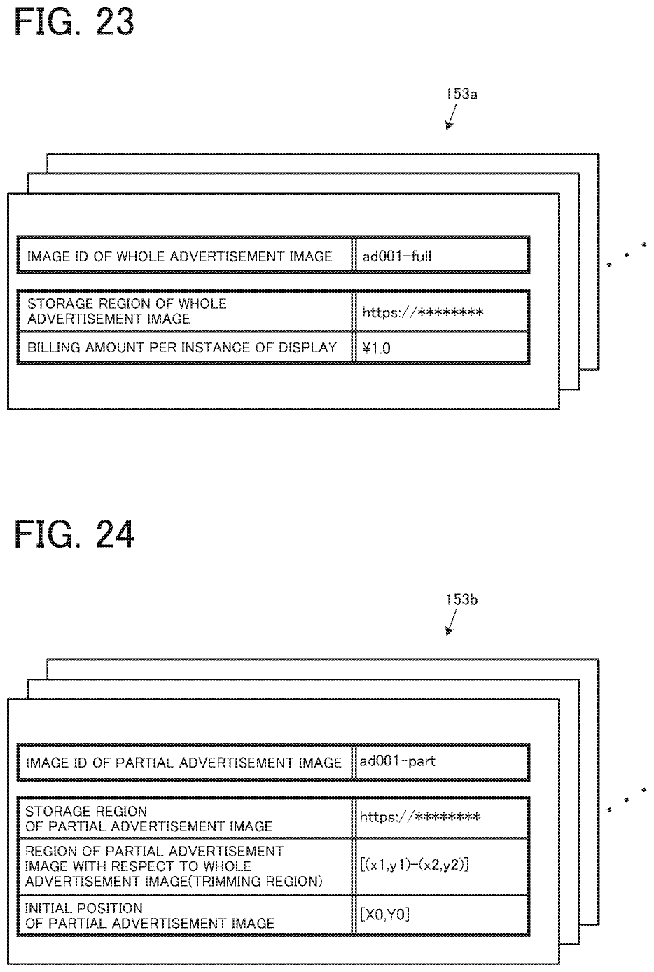

When the server 10 receives the registration request from the setting device through the communication I/F 14, the data of the whole advertisement image and the data of the partial advertisement image included in the received registration request are stored in the whole advertisement database 153a (see FIG. 23) and the partial advertisement database 153b (see FIG. 24), respectively.

Alternatively or additionally, the server 10 specifies the advertiser ID based on the unique address of the setting device of the sender, assigns a unique advertisement number, and stores the display position and the advertisement number of the partial advertisement image, the advertiser ID, the image ID of the partial advertisement image, and the image ID of the whole partial advertisement image included in the registration request in association with the main content ID in the main content database 152, for example, without limitation thereto.

(3) Setting of Transparent Region by Server

When the partial advertisement image is set, the controller 11 of the server 10 sets the transparent region of the main content information (web page) associated with the partial advertisement image based on the horizontal width and the vertical width of the partial advertisement image, for example, without limitation thereto.

The server 10 sets the size of the transparent region by setting a horizontal width that is approximately the same as the horizontal width of the partial advertisement image (non-limiting examples of which include 90% to 110% of the horizontal width of the partial advertisement image) as the horizontal width of the transparent region, and setting a vertical width that is approximately the same as the vertical width of the partial advertisement image (non-limiting examples of which include 90% to 110% of the vertical width of the partial advertisement image) as the vertical width of the transparent region, for example, without limitation thereto.

In some embodiments, the server 10 may optionally set the size of the transparent region based on one of the horizontal width and the vertical width of the partial advertisement image.

Alternatively or additionally, the server 10 determines the position of the transparent region in the main content information (web page). Specifically, the server 10 determines the position of the transparent region such that it is superimposed on the first partial advertisement image arranged on the lower side of the page display region of the terminal 20 in a state where the web page is in the initial position, for example, without limitation thereto.

### Effects of Ninth Embodiment

The ninth embodiment shows a configuration in which the display position where the first partial advertisement image 242b is displayed in the page display region is set by the advertiser.

As an example of the effect obtained by such a configuration, the first information can be displayed at the position desired by the business operator (non-limiting examples of which include the advertiser) in the display region of the terminal, and therefore the business operator can obtain an expected display effect.

The ninth embodiment shows a configuration in which transmission of the advertisement content data (non-limiting examples of which include the whole advertisement data including the whole advertisement image) to the terminal 20 is requested by the advertiser, and the partial advertisement image of the advertisement content information is set by the advertiser.

As an example of the effect obtained by such a configuration, the information that the business operator (non-limiting examples of which include the advertiser) wants to draw the attention of the user to in the first content information can be set as the first information.

The ninth embodiment shows a configuration in which the whole advertisement data includes the data of the whole advertisement image, and the whole advertisement image is associated with the partial advertisement image by the advertisement number.

As an example of the effect obtained by such a configuration, it is possible to display the first information first, and then display the first content information corresponding to the first information, for example, without limitation thereto.

The ninth embodiment shows a configuration in which the transparent region is set based on the length of a side of the partial advertisement image or the size of the partial advertisement image.

As an example of the effect obtained by such a configuration, a transparent region suitable for the first information can be set.

Ninth Variation (1)

In the ninth embodiment, an example was shown in which partial advertisement images to be displayed at the lower portion of the screen, the central portion of the screen, and the upper portion of the screen are set by the advertiser, but the present disclosure is not limited to such a mode.

The server 10 may optionally select and set partial advertisement images to be displayed at the lower portion of the screen, the central portion of the screen, and the upper portion of the screen, for example, without limitation thereto.

In this variation, an advertisement billing table 154d is further stored in the storage 15 of the server 10.

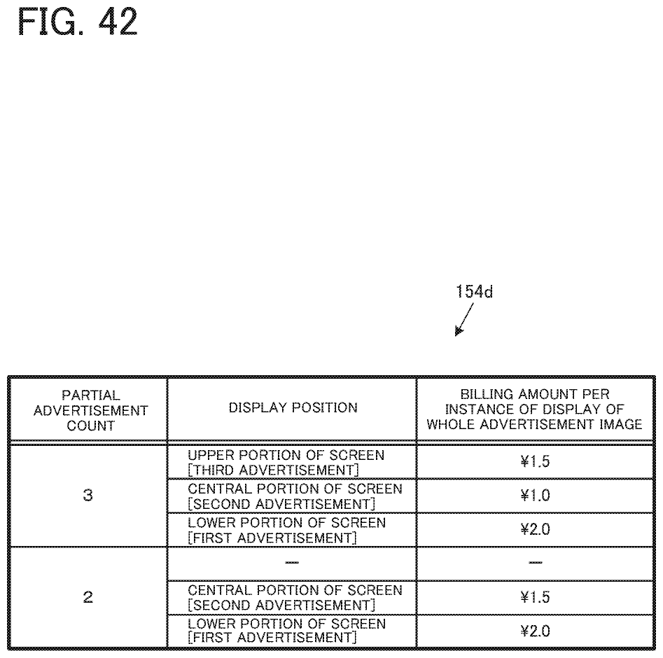

In the advertisement billing table 154d shown in FIG. 42, the relationship between the number of partial advertisements (hereinafter referred to as “the partial advertisement count”) arranged in the page display region, their display positions, and the billing amount, which is the amount charged to the advertiser each time the whole advertisement image corresponding to the partial advertisement image of the partial advertisement is displayed once on the terminal 20, is included, for example, without limitation thereto.

In this example, if three partial advertisements are arranged in the page display region, the “billing amount per instance of display of the whole advertisement image” increases in the order of “central portion of screen”, “upper portion of screen” and “lower portion of screen”. As shown in the seventh variation (5), this is because the first partial advertisement image 242b at the lower portion of the screen has the highest value as an advertisement, the third partial advertisement image 242b at the upper portion of the screen has the next-highest value as an advertisement, and the second partial advertisement image 242b in the central portion of the screen has the lowest value as an advertisement, for example, without limitation thereto.

Alternatively or additionally, if two partial advertisements are arranged in the page display region, the “billing amount per instance of display of the whole advertisement image” increases in the order of “the upper portion of the screen” and “the lower portion of the screen”. This is because, as shown in the seventh embodiment, the first partial advertisement image 242b at the lower portion of the screen has a higher value as an advertisement than the second partial advertisement image 242b at the upper portion of the screen.

Processing

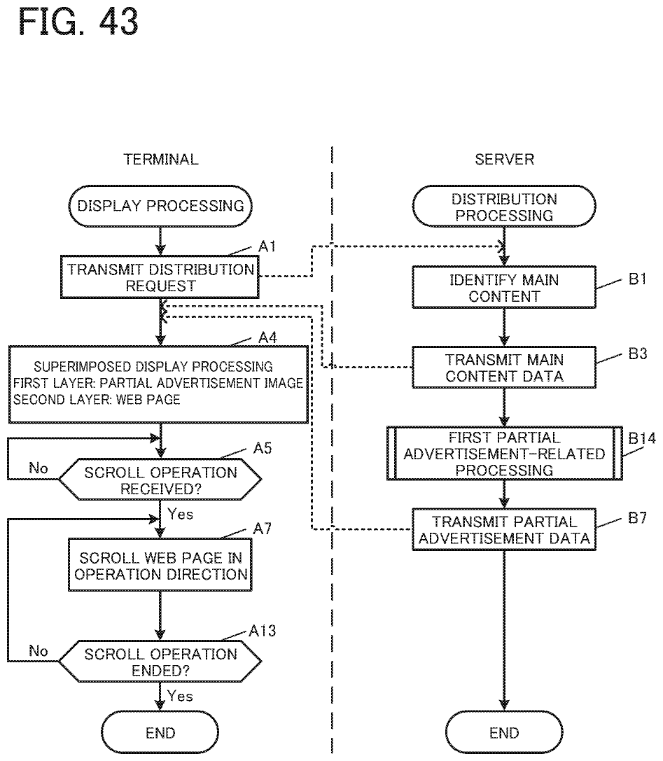

FIG. 43 is a flowchart showing an example of a flow of processing executed by each device in this variation.

In this diagram, the distribution processing executed by the distribution processor 111 of the server 10 and the display processing executed by the display processor 211 of the terminal 20 are shown.

The same steps as those in the flowchart described above are denoted by the same reference numerals, redundant description thereof is omitted, and description will be given with a focus on steps that are different.

The flowchart described below merely illustrates an example of the processing in this variation, and in the flowchart described below, some steps need not be executed, and additional steps may be inserted.

FIG. 43 is a flowchart in which first partial advertisement-related processing (non-limiting examples of which include step B14) has been added instead of a step of partial advertisement determination processing (non-limiting examples of which include step B4) and processing for identifying partial advertisement data (non-limiting examples of which include step B5) in the flowchart of FIG. 32.

After B1, the server 10 executes first partial advertisement-related processing (B14).

In the first partial advertisement-related processing, the content of the distributed main content data is analyzed, and based on the content, the number, content, arrangement position, billing amount, and the like of the partial advertisement image to be arranged in the page display region are determined.

If the number of partial advertisement images is determined to be “2”, the server 10 identifies the first partial advertisement data and the second partial advertisement data of the determined content from the partial advertisement database 153b, transmits these identified pieces of partial advertisement data to the terminal 20 through the communication I/F 14 (B7), and ends the processing.

Alternatively or additionally, if the number of partial advertisement images is determined to be “3”, the server 10 identifies the first partial advertisement data, the second partial advertisement data, and the third partial advertisement data of the determined content from the partial advertisement database 153b, and transmits these identified pieces of partial advertisement data to the terminal 20 through the communication I/F 14.

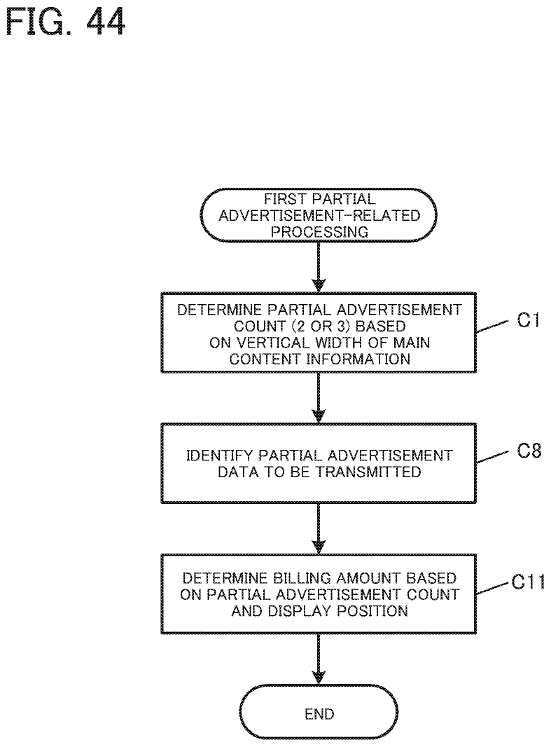

FIG. 44 is a flowchart showing an example of a flow of the first partial advertisement-related processing.

The server 10 determines the number of partial advertisement images 242b to be displayed in the page display region (partial advertisement count) based on the vertical width of the main content data to be distributed (non-limiting examples of which include including data relating to the web page 241 of the new site), for example, without limitation thereto.

If the vertical width of the main content data is small as shown in FIG. 30 for example, without limitation thereto, the scroll amount of the web page 241 will also be small, and therefore the server 10 determines the number of partial advertisement images 242b to be displayed in the page display region to be “2”, for example, without limitation thereto.

On the other hand, if the vertical width of the main content data is large as shown in FIGS. 32 and 33 for example, without limitation thereto, the scroll amount of the web page 241 will also be large, and therefore the server 10 determines the number of partial advertisement images 242b to be displayed in the page display region to be “3”, for example, without limitation thereto.

In this example, if the vertical width of the main content data is smaller than a predetermined threshold value for example, without limitation thereto, the server 10 determines that the number of partial advertisement images 242b to be displayed in the page display region is “2”, and if the vertical width of the main content data is the threshold value or more, the server 10 determines that the number of partial advertisement images 242b to be displayed in the page display region is “3” (C1).

Next, the server 10 identifies the partial advertisement data to be transmitted (C8).

Specifically, the server 10 generates the image ID of the partial advertisement image by adding “-part” to the end of a predetermined advertisement number, for example, without limitation thereto. Then, the server 10 refers to the partial advertisement database 153b shown in FIG. 24, and identifies the partial advertisement data to be transmitted based on the storage region of the partial advertisement image associated with the image ID of the generated partial advertisement image.

Next, the server 10 determines the billing amount based on the partial advertisement count and the display position (C11).

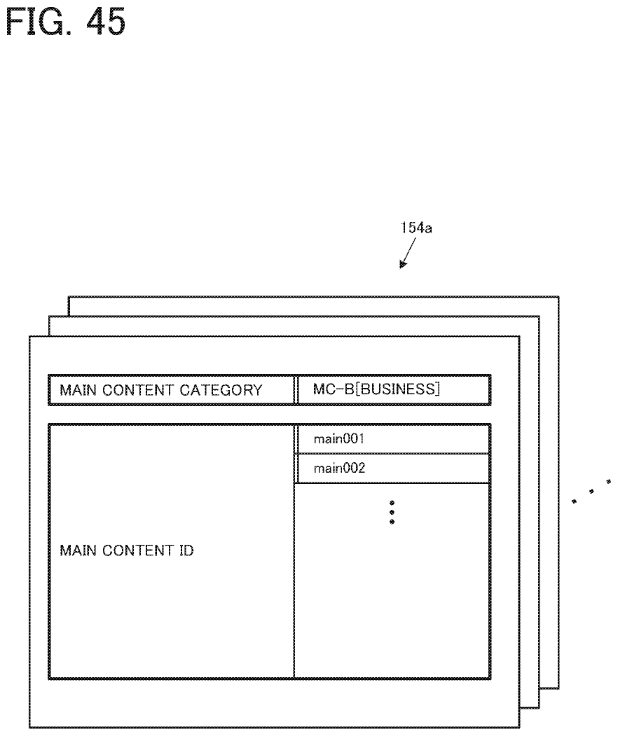

In this example, the server 10 refers to the advertisement billing table 154d shown in FIG. 45, and if the number of partial advertisement images 242b to be displayed in the page display region is determined to be “2”, the server 10 determines the billing amount for the case where the whole advertisement image corresponding to the first advertisement is displayed, and associates the determined billing amount is associated with that whole advertisement image. Similarly, the server 10 determines the billing amount for the case where the whole advertisement image corresponding to the second advertisement is displayed, and associates the determined billing amount with that whole advertisement image.

Alternatively or additionally, if the server 10 has determined that the number of partial advertisement images 242b to be displayed in the page display region is “3”, the server 10 determines the billing amounts for the case where the whole advertisement images corresponding to the first advertisement, the second advertisement, and the third advertisement are displayed, and associates the determined billing amounts with the respective whole advertisement images.

In some embodiments, as described above, the server 10 may optionally determine the billing amount for the case where the partial advertisement image is displayed, using the billing amount to the advertiser as the billing amount for the case where the partial advertisement image is displayed.

Effects of Ninth Variation (1)

This variation shows a configuration transmission of the advertisement content data (non-limiting examples of which include the whole advertisement data including the whole advertisement image) to the terminal 20 of the user is requested by the advertiser, and the billing amount to the advertiser for the advertisement content data is set based on the display position at which the partial advertisement image (a non-limiting example the first information) is displayed in the page display region (a non-limiting example of the display region).

As an example of the effect obtained by such a configuration, a high billing amount can be set when the first information is displayed at a position where the user has many opportunities to view the first information, and a low billing amount can be set when the first information is displayed at a position where the user has few opportunities to view the first information, for example, without limitation thereto. That is, it is possible to set an appropriate billing amount according to the likelihood that the user will view the first information.

This variation shows a configuration in which the billing amount to the advertiser is set lower in the case where the partial display image (a non-limiting example of the first information) is displayed in a second region (non-limiting examples of which include the central portion of the screen) that does not include the lower end or the upper end of the page display region of the terminal 20, compared to the case where the partial advertisement image is displayed in a first region (non-limiting examples of which include the lower portion of the screen or the upper portion of the screen).

As an example of the effect obtained by such a configuration, the billing amount to the business operator can be set higher in the case where the first information is displayed in the first region, which has a high likelihood of being viewed by the user, so as to make it possible for the user to view before or after reading the content, for example, without limitation thereto. Alternatively or additionally, the billing amount to the business operator can be set lower in the case where a partial advertisement image is displayed in a second region with a low likelihood of being viewed by the user, so as to be visible by the user while browsing the content, for example, without limitation thereto.

This variation shows a configuration in which the data of the whole advertisement image is included in the whole advertisement data, and the whole advertisement image is associated with the information relating to billing by the server 10 that transmits the whole advertisement data to the terminal 20.

As an example of the effect obtained by such a configuration, the information regarding the billing that is based on the first content information being displayed can be managed on the server side.

Ninth Variation (2)

In the ninth variation (1), if the content of the partial advertisement image to be arranged in the page display region in the partial advertisement-related processing is determined, a partial advertisement image that is preferably not displayed at the same time can also be selected and determined (selected), for example, without limitation thereto.

In this variation, in the storage 15 of the server 10, in addition to the advertisement billing table 154d, a main content management database 154a, an advertisement category selection table 154b, and an advertisement content management database 154c are stored.

In the main content management database 154a shown in FIG. 45, the main content category, which is an identifier for classifying the content of the main content information, and the main content ID of the main content information having the content are stored in association with each other, for example, without limitation thereto.

In this example, an identifier MC-B [business] is assigned to the main content information of content that is classified as “business”. Multiple main content IDs such as main001 and main002 are associated with the MC-B [business] identifier.

For example, the content of the main content information is classified into “sports”, “technology”, “food and drink”, and the like, in addition to “business”, for example, without limitation thereto.

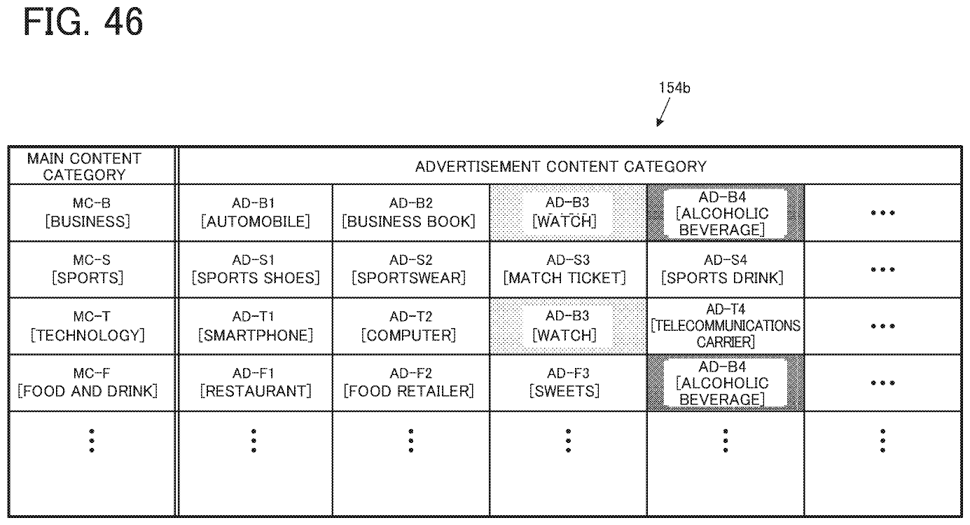

The advertisement category selection table 154b shown in FIG. 46 includes a relationship between the main content category and the advertisement content category, which is an identifier for classifying the content of the advertisement, for example, without limitation thereto.

In this example, multiple advertisement content categories are associated with one main content category. With these advertisement content categories, advertisements having content with main content information classified into the main content category, that is, content that appeals to the user browsing the web page, are classified, for example, without limitation thereto.

Specifically, advertisement content categories for advertisements that appeal to users who browse web pages for business, such as “automobile”, “business book”, “watch”, and “alcoholic beverage”, are associated with the main content category for “business”. Advertisement content categories for advertisements that appeal to users who browse web pages for sports, such as “sports shoes”, “sportswear”, “match ticket”, and “sports drink”, are associated with the main content category for “sports”. Advertisement content categories for advertisements that appeal to users who browse web pages for technology, such as “smartphone”, “computer”, “watch” and “telecommunications carrier”, are associated with the main content category of “technology”. Advertisement content categories for advertisements that appeal to users who browse a web page for food and drink, such as “restaurant”, “food retailer”, “sweets”, and “alcoholic beverage”, are associated with the main content category for “food and drink”.

For example, one advertisement content category may be associated with a plurality of main content categories, as with the advertisement content category of “alcoholic beverage”, which is associated with the main content categories of “business” and “food and drink”, and the advertisement content category of “watch”, which is associated with the main content categories of “business” and “technology”.

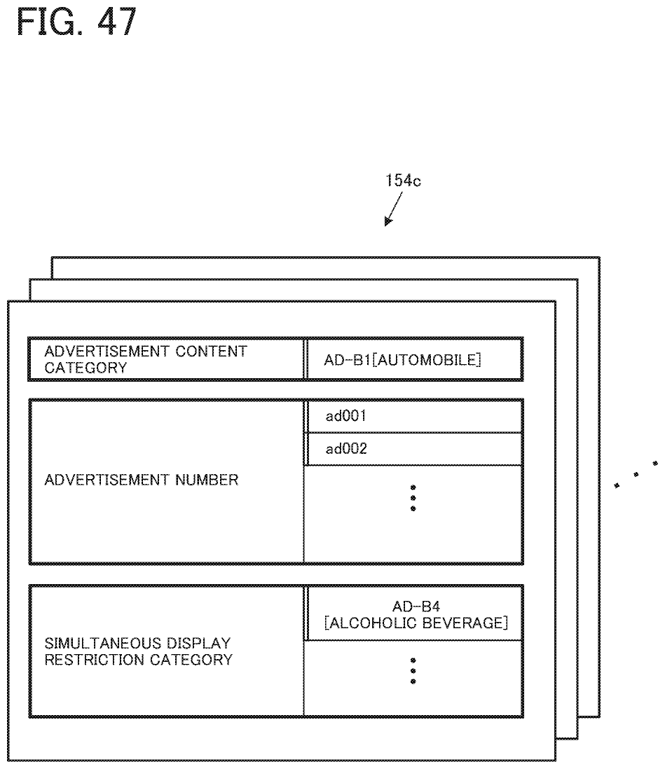

In the advertisement content management database 154c shown in FIG. 47, the advertisement content category, the advertisement number, and the simultaneous display restriction category are stored in association with each other, for example, without limitation thereto.

The simultaneous display restriction category is an identifier of an advertisement that is preferably not arranged simultaneously with an advertisement classified in that advertisement content category, or an advertisement that does not have good compatibility with (is not compatible with) an advertisement that is classified in that advertisement content category, for example, without limitation thereto.

In this example, the simultaneous display restriction category of “alcoholic beverage” is associated with the advertisement content category of “automobile”. This is because if an advertisement for an “automobile” and an advertisement for an “alcoholic beverage” are simultaneously displayed in one page display region, it may remind the user of drunk driving of an automobile, which is recognized as being socially unfavorable.

For example, the simultaneous display restriction category of “automobile” can be associated with the advertisement content category of “alcoholic beverage”.

Alternatively or additionally, in addition to the relationship between an advertisement for an “automobile” and an advertisement for an “alcoholic beverage”, the simultaneous display restriction category of “telecommunications carrier” is associated with the advertisement content category of “telecommunications carrier”, for example, without limitation thereto. This is because if an advertisement for a “telecommunications carrier” of a competing company A and an advertisement for a “telecommunications carrier” of a company B are simultaneously arranged in one page display region despite the fact that one user rarely contracts with a plurality of telecommunications carriers, the degree of attention of the user to the advertisement of the company may decrease for both companies A and B.

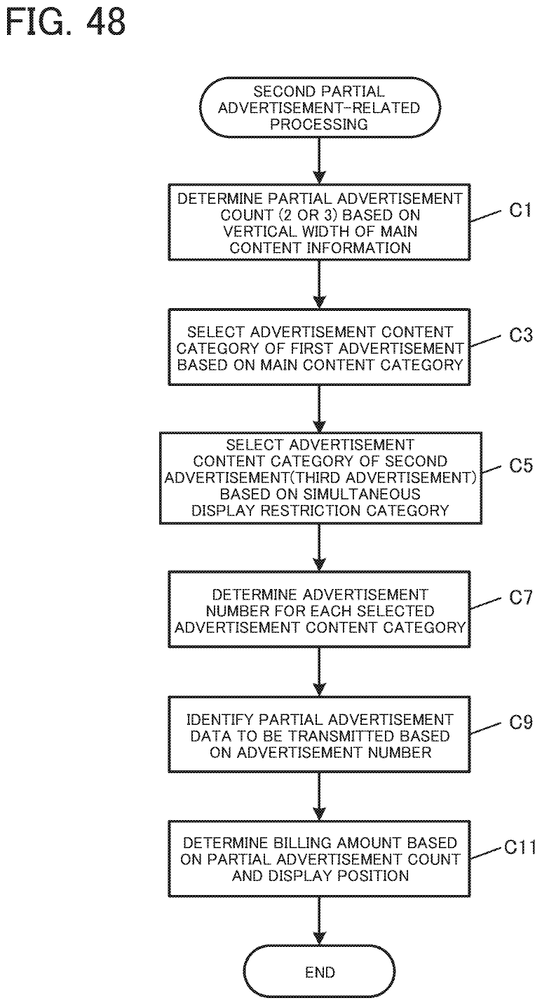

FIG. 48 is a flowchart showing an example of a flow of second partial advertisement-related processing, which is executed by the server 10 instead of the first partial advertisement-related processing (FIG. 44) in this variation.

This processing is obtained by replacing step C8 in the first partial advertisement-related processing with steps C3 to C9.

After C1, the server 10 selects the advertisement content category of the first advertisement based on the main content category (C3).

The server 10 refers to the main content management database 154a shown in FIG. 9-5 and acquires the identifier of the main content category corresponding to the main content ID of the main content data to be distributed, for example, without limitation thereto. In this example, the server 10 acquires the identifier MC-B [business], for example, without limitation thereto.

Then, the server 10 refers to the advertisement category selection table 154b shown in FIG. 46, acquires a plurality of advertisement content category identifiers corresponding to the acquired identifier of the main content category, and selects one identifier from among these identifiers for the advertisement content category. The server 10 acquires identifiers such as AD-B1 [automobile], AD-B2 [business book], AD-B3 [watch], and AD-B4 [alcoholic beverage], which correspond to the identifier MC-B [business], for example, without limitation thereto, and selects the identifier AD-B1 [automobile] from among these identifiers, for example, without limitation thereto.

For example, in the processing of C3, the identifier selection method may be a random selection method, or a selection method based on a specific condition such as the time zone or the preference of the user.

Thereafter, the server 10 selects the advertisement content category of the second advertisement based on the simultaneous display restriction category (C5).

The server 10 refers to the advertisement content management database 154c shown in FIG. 47, and recognizes that AD-B4 [alcoholic beverage] has been set as the identifier of the simultaneous display restriction category in the identifier AD-B1 [automobile] selected as the advertisement content category of the first advertisement, for example, without limitation thereto.

Then, the server 10 excludes AD-B4 [alcoholic beverage] from among the identifiers AD-B1 [automobile], AD-B2 [business book], AD-B3 [watch], AD-B4 [alcoholic beverage], and the like, and selects one identifier, as a non-limiting example, the identifier AD-B2 [business book], from among the identifiers AD-B1 [automobile], AD-B2 [business book], AD-B3 [watch], and the like.

For example, in the processing of C5, the server 10 selected AD-B1 [automobile] as the advertisement content category of the first advertisement, and therefore the server 10 may select one identifier of the advertisement content category from among the identifiers AD-B2 [business book], AD-B3 [watch], and the like such that AD-B1 [automobile] is not redundantly selected for the second advertisement as well.

Alternatively or additionally, if the server 10 has determined that the number of partial advertisement images 242b to be displayed in the page display region is “3” in step C1, the server 10 selects the advertisement content category of the third advertisement using the same method as that by which the advertisement content category of the second advertisement was selected in step C5.

Thereafter, the server 10 determines the advertisement number for each selected advertisement content category (C7).

The server 10 refers to the advertisement content management database 154c shown in FIG. 47, and recognizes that ad001 and ad002 have been set as the advertisement numbers for the identifier AD-B1 [automobile] selected as the advertisement content category of the first advertisement, for example, without limitation thereto. Then, the server 10 selects one advertisement number from among the advertisement numbers such as ad001 and ad002, and selects the advertisement number ad001, for example, without limitation thereto.

Similarly, the server 10 recognizes the advertisement number associated with the identifier AD-B2 [business book] selected as the advertisement content category of the second advertisement, and selects one advertisement number from among the recognized advertisement numbers.

For example, in the processing of C7, the method for selecting the advertisement number may be a method of randomly selecting the advertisement number or a method of selecting the advertisement number in order.

Alternatively or additionally, if the server 10 has determined that the number of partial advertisement images 242b to be displayed in the page display region is “3” in step C1, the server 10 determines the advertisement number of the third advertisement using the same method as that by which the advertisement number of the first advertisement was selected.

Next, the server 10 identifies the partial advertisement data to be transmitted based on the determined advertisement number (C9).

The server 10 generates the image ID of the partial advertisement image by adding “-part” to the end of the determined advertisement number, for example, without limitation thereto.

Then, the server 10 refers to the partial advertisement database 153b shown in FIG. 24, and identifies the partial advertisement data to be transmitted based on the storage region of the partial advertisement image associated with the image ID of the generated partial advertisement image.

After performing the processing of C3 to C9, the server 10 transitions the processing to C11.

Effects of Ninth Variation (2)

In this variation, in the advertisement category selection table 154b, the content of a whole advertisement image of an automobile (a non-limiting example of the first content information), the content of a whole advertisement image of a business book (a non-limiting example of the second content information), the content of a whole advertisement image of a watch, and the content of a whole advertisement image of an alcoholic beverage are classified into the advertisement content category associated with the main content category for business.

Based on the content of the whole advertisement image of the automobile and the content of the whole advertisement image of the business book not applying to the relationship between the advertisement content category and the simultaneous display restriction category in the advertisement content management database 154c, the whole advertisement image of the automobile and the whole advertisement image of the business book are selected from among the advertisement content categories associated with the main content category of business in the advertisement category selection table 154b.

A configuration is shown in which the first partial advertisement image 242b based on the whole advertisement image of the automobile and the second partial advertisement image 242b based on the whole advertisement image of the business book are displayed in the page display region of the terminal 20.

As an example of the effect obtained by such a configuration, it is possible to prevent first information and second information that are not preferably displayed at the same time, such as a combination of an advertisement for an automobile and an advertisement for an alcoholic beverage, from being displayed in the display region, for example, without limitation thereto.

Ninth Variation (3)

In the ninth embodiment, an example was shown in which the partial advertisement image is set by the advertiser, but there is no limitation to such a mode. The partial advertisement image may be set based on the whole advertisement image by the server 10 that stores the whole advertisement image.

If the whole advertisement image is a still image, based on a binarized image obtained by binarizing the whole advertisement image using a predetermined threshold value, the controller 11 of the server 10 may recognize a region with a high line segment density in the binarized image as a region of interest, and may set a rectangular region including the region of interest as a partial advertisement image, for example, without limitation thereto.

Alternatively or additionally, if the whole advertisement image is a moving image, the controller 11 of the server 10 may recognize a region with a large difference in pixel values between prior and subsequent images (or between frames) based on a display order as a region of interest, and may set a rectangular region including the region of interest as a partial image, for example, without limitation thereto.

Alternatively or additionally, the controller 11 of the server 10 may trim a portion of the whole advertisement image (non-limiting examples of which include the central portion) into a rectangular shape without performing the above image processing, and may set the trimmed region as a partial advertisement image, for example, without limitation thereto.

This variation shows a configuration in which the partial advertisement image is set by the server 10 that transmits the whole advertisement data to the terminal 20.

As an example of the effect obtained by such a configuration, it is possible to eliminate the need for the operation of setting the first information by the business operator (non-limiting examples of which include the advertiser), and to perform setting easily on the server side.

Ninth Variation (4)

In the ninth embodiment, an example was shown in which the size of the partial advertisement image is set to a predetermined size based on the initial setting. Alternatively or additionally, the configuration was described in which the billing amount per instance of display of the whole advertisement image is associated with the number of partial advertisements displayed in the page display region of the terminal 20 and the display position thereof, but there is no limitation to such a mode.

The size of the partial advertisement image may be set to any size, and the billing amount per instance of display of the whole advertisement image may be set by the server 10 according to the size, for example, without limitation thereto.

The controller 11 of the server 10 increases the billing amount the larger the vertical width of the partial advertisement image is, that is, the longer the sides in the longitudinal direction of the screen are, as with the relationship between the size of the above-described partial advertisement image and the billing amount, for example, without limitation thereto.

Specifically, the controller 11 of the server 10 sets a billing coefficient that increases the greater the vertical width of the partial advertisement image is, for example, without limitation thereto. Then, the controller 11 of the server 10 refers to the advertisement billing table 154d shown in FIG. 42, and sets an amount obtained by multiplying the billing amount per instance of display of the whole advertisement image according to the partial advertisement count and the display position by the billing coefficient as the billing amount to be billed to the advertiser, for example, without limitation thereto.

In some embodiments, the billing amount may optionally be set in consideration of not only the vertical width of the partial advertisement image but also the horizontal width of the partial advertisement image.

Specifically, a billing coefficient is set which increases the greater the horizontal width of the partial advertisement image is, and which increases the greater the vertical width of the partial advertisement image is, for example, without limitation thereto. Alternatively or additionally, in the case of a vertically elongated image in which the vertical width of the partial advertisement image is greater than the horizontal width, the controller 11 of the server 10 sets a billing coefficient larger than that in the case of a horizontally elongated image, for example, without limitation thereto. Then, the controller 11 of the server 10 refers to the advertisement billing table 154d shown in FIG. 42, and sets an amount obtained by multiplying the billing amount per instance of display of the whole advertisement image according to the partial advertisement count and the display position by the billing coefficient as the billing amount to be billed to the advertiser, for example, without limitation thereto.

This variation shows a configuration in which the whole advertisement data includes the data of the whole advertisement image, and the whole advertisement image is associated with information relating to billing based on the length of the partial advertisement image or the size of the partial advertisement image.

As an example of the effect obtained by such a configuration, an appropriate billing amount according to the likelihood of drawing attention can be associated with the first information having a length or size that is likely to draw attention from the user, for example, without limitation thereto.

Ninth Variation (5)

In the ninth embodiment, an example was shown in which the size of the partial advertisement image is set to a predetermined size based on the initial setting, but there is no limitation to such a mode. The size of the partial advertisement image may be any size.

The advertiser can set the partial advertisement image by operating the above-described setting device, for example, without limitation thereto.

In this example, the advertiser performs an operation of designating a region of a partial advertisement image in a state where the whole advertisement image is displayed on the display of the setting device. At this time, a rectangular trimming range of a predetermined size is displayed in the whole advertisement image. The size of this trimming range can be changed to any size through the operation performed by the advertiser. Due to the advertiser performing an operation of changing the position and size of the trimming range, the region designated by the trimming range is trimmed from the whole advertisement image, is set as a partial advertisement image, and is stored in the partial advertisement database 153b. The data of the set partial advertisement image is distributed to the terminal 20 as partial advertisement data.

Processing

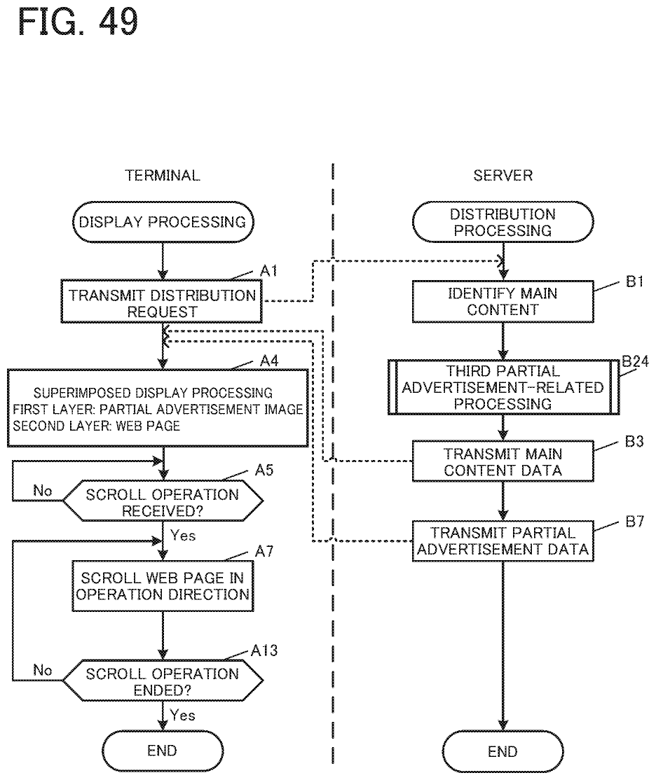

FIG. 49 is a flowchart showing an example of a flow of processing executed by each device in this variation.

In this diagram, the distribution processing executed by the distribution processor 111 of the server 10 and the display processing executed by the display processor 211 of the terminal 20 are shown.

The same steps as those in the flowchart described above are denoted by the same reference numerals, redundant description thereof is omitted, and description will be given with a focus on steps that are different.

The flowchart described below merely illustrates an example of the processing in this variation, and in the flowchart described below, some steps need not be executed, and additional steps may be inserted.

FIG. 49 is a flowchart obtained by erasing the step of partial advertisement determination processing (non-limiting examples of which include step B4) and the processing for identifying the partial advertisement data (non-limiting examples of which include step B5) from the flowchart of FIG. 32 and adding third partial advertisement-related processing (non-limiting examples of which include step B24) as the processing after the main content data is identified by the server 10 from the main content database 152 (B1).

After B1, the server 10 performs the third partial advertisement-related processing (B24).

In the third partial advertisement-related processing, the server 10 analyzes the content of the main content data to be distributed, and based on the content, the server 10 determines the number, content, arrangement position, billing amount, and the like of the partial advertisement images to be arranged in the page display region, for example, without limitation thereto.

Then, if the number of partial advertisement images is determined to be “2”, the server 10 identifies the first partial advertisement data and the second partial advertisement data of the determined content from the partial advertisement database 153b, and acquires the sizes of the first partial advertisement image and the second partial advertisement image based on these identified pieces of partial advertisement data. The server 10 determines the size of the transparent region 241a based on these acquired sizes.

Alternatively or additionally, if the number of partial advertisement images is determined to be “3”, the server 10 identifies the first partial advertisement data, the second partial advertisement data, and the third partial advertisement data of the determined content from the partial advertisement database 153b, and acquires the sizes of the first partial advertisement image, the second partial advertisement image, and the third partial advertisement image based on these identified pieces of partial advertisement data. The server 10 determines the size of the transparent region 241a based on these acquired sizes.

Then, the server 10 transmits the main content data including the data of the main content information including the determined transparent region 241a to the terminal 20 through the communication I/F 14 (B3).

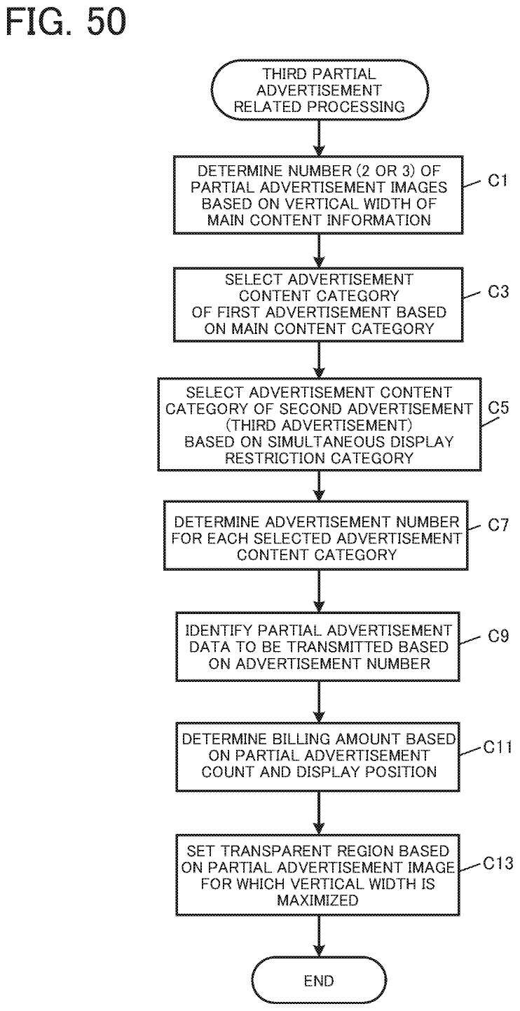

FIG. 50 is a flowchart showing an example of a flow of the third partial advertisement-related processing.

This processing is a flowchart obtained by adding the processing for setting the transparent region (non-limiting examples of which include step C13) after the processing for determining the billing amount in the second partial advertisement-related processing of FIG. 48 (non-limiting examples of which include step C11).

After C11, the server 10 sets the transparent region based on the partial advertisement image with the maximum vertical width, for example, without limitation thereto (C13).

In this example, the server 10 acquires the vertical width of the first partial advertisement image and the vertical width of the second partial advertisement image based on the partial advertisement data to be transmitted, and acquires the maximum vertical width out of these acquired vertical widths.

The server 10 sets a vertical width that is approximately the same as the maximum vertical width (non-limiting examples of which include 90% to 110% of the maximum vertical width) as the vertical width of the transparent region, and sets a horizontal width that is approximately the same as the horizontal width of the partial advertisement image having the maximum vertical width (non-limiting examples of which include 90% to 110% of the horizontal width of the partial advertisement image having the maximum vertical width) as the horizontal width of the transparent region, for example, without limitation thereto.

Then, the server 10 determines the position of the transparent region in the main content information (web page). The server 10 determines the position of the transparent region in the main content information such that it is superimposed on the first partial advertisement image arranged at the lower side of the page display region of the terminal 20 in the state where the web page is in the initial position, for example, without limitation thereto.

Although an example was shown in which, in the processing of C13, only the vertical width of the transparent region is set to the maximum vertical width out of the vertical width of the first partial advertisement image and the vertical width of the second partial advertisement image, and the horizontal width of the transparent region is set to approximately the same horizontal width as the partial advertisement image having the vertical width, there is no limitation to such a mode. The width of the transparent region may also be set to the maximum horizontal width out of the horizontal width of the first partial advertisement image and the horizontal width of the second partial advertisement image.

Alternatively or additionally, if the server 10 has determined in step C1 that the number of partial advertisement images 242b to be displayed in the page display region is “3”, the server 10 sets a vertical width that is approximately the same as the maximum vertical width out of the vertical width of the first partial advertisement image, the vertical width of the second partial advertisement image, and the vertical width of the third partial advertisement image (non-limiting examples of which include 90% to 110% of the maximum vertical width) as the vertical width of the transparent region.

This variation shows a configuration in which the transparent region is set based on the information of the partial advertisement image with the longer side or the larger size out of at least the first partial advertisement image and the second partial advertisement image.

As an example of the effect obtained by such a configuration, it is possible to prevent the visibility of the first information and the second information from being impaired due to the transparent region being too small, for example, without limitation thereto.

Ninth Variation (6)

In the ninth embodiment, the business operator who provides the main content may optionally sell the conditions such as the position, size, and number of the partial advertisement images to be arranged in the first layer in association with the main content provided by the business operator to an advertiser through auction or the like, for example, without limitation thereto.

In this case, the business operator who provides the main content can determine the conditions such as the position where the partial advertisement image of the advertiser is to be arranged, the size, and the number, according to the payment amount from the advertiser to the business operation (the billing amount from the business operator to the advertiser), for example, without limitation thereto.

Specifically, an advertiser with a higher billing amount can be given the right to arrange a partial advertisement image at a position that is likely to be noticed by the user when browsing the web page, for example, without limitation thereto.

Alternatively or additionally, an advertiser with a higher billing amount can be given the right to arrange a partial advertisement image with a larger size, for example, without limitation thereto.

Alternatively or additionally, an advertiser with a higher billing amount can be given the right to arrange a larger number of partial advertisement images, for example, without limitation thereto.

### Tenth Embodiment

The tenth embodiment is an embodiment in which a whole advertisement image that is a moving image is arranged in the first layer.

In the present embodiment, the transparent region of the main content information arranged in the second layer moves based on the input performed by the user, but the whole advertisement image is a moving image and control for playback of the whole advertisement image that is a moving image arranged in the first layer is executed based on the transparent region.

The tenth embodiment differs from the above-described embodiment in that the whole advertisement image is not a still image but a moving image.

The features described in the tenth embodiment can also be applied to and/or combined with other embodiments and variations.

The same constituent elements as those already mentioned are denoted by the same reference numerals, and redundant description thereof is omitted.

In this embodiment, the main content data and the whole advertisement data associated with the main content data are distributed from the server 10 to the terminal 20, for example, without limitation thereto. Then, the whole advertisement image that is a moving image is arranged in the first layer, and the main content information is arranged in the second layer.

Thereafter, the main content information is scrolled based on a scroll operation (first input) performed by the user. As a result, playback of the whole advertisement image that is the moving image is started based on a playback start condition being satisfied.

In this embodiment, as a non-limiting example, the playback start condition is: (A-1) That a portion of the transparent region is superimposed on the whole advertisement image.

In this case, it is possible to determine whether or not the transparent region is superimposed on the whole advertisement image based on the vertical side of the transparent region.

Here, at the timing when a portion of the transparent region is first superimposed on the whole advertisement image, the user cannot necessarily view a portion of the whole advertisement image via the transparent region. In actuality, it is conceivable that, at the timing when about 10% to 20% of the vertical width of the transparent region is superimposed on the whole advertisement image, a portion of the whole advertisement image becomes visible to the user via the transparent region, for example, without limitation thereto. In view of this, whether or not a certain percentage (non-limiting examples of which include about 10% to 20%) of the transparent region (the vertical width of the transparent region) is superimposed on the whole advertisement image may optionally be determined as the playback start condition, for example, without limitation thereto.

However, since the scroll operation is often performed at a high speed to some extent, it is conceivable that there will be many cases where even if the whole advertisement image (moving image) is played back at the timing when a portion of the transparent region is superimposed on the whole advertisement image, the whole advertisement image (moving image) will be recognized by the user as being played back at the timing when a portion of the whole advertisement image becomes visible.

Note that a case is envisioned in which the web page is scrolled in the horizontal direction, and it may optionally be determined whether or not the above-described playback start condition was satisfied based on the horizontal width of the transparent region, for example, without limitation thereto.

Alternatively or additionally, playback of the moving image may optionally be stopped if the playback start condition is no longer satisfied after playback of the moving image is started.

Processing

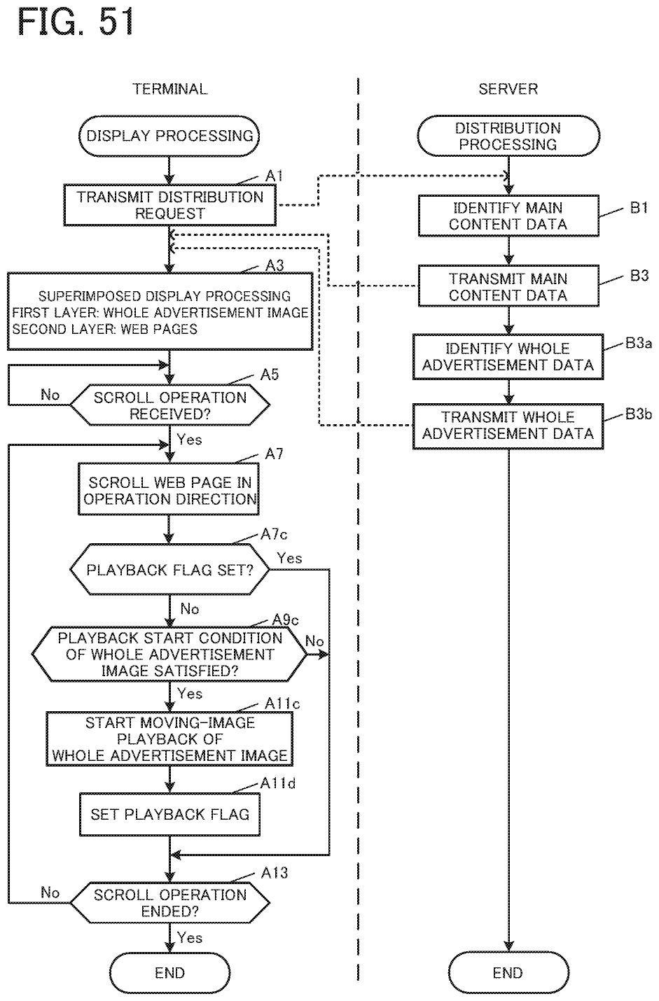

FIG. 51 is a flowchart showing an example of a flow of processing executed by each device in this embodiment.

In this diagram, the distribution processing executed by the distribution processor 111 of the server 10 is shown on the left side, and the display processing executed by the display processor 211 of the terminal 20 is shown on the right side.

FIG. 51 is obtained by, in the flowchart of FIG. 10, replacing steps A1b to A11a in FIG. 10 with steps A7c to A11d as the processing in the case where the whole advertisement image is a moving image, and replacing step A9 with step A9c.

After B3, the server 10 identifies the whole advertisement data that is a moving image associated with the main content data to be distributed from the whole advertisement database 153a (B3a). Then, the identified whole advertisement data that is a moving image is transmitted to the terminal 20 through the communication I/F 14 (B3b), and the distribution processing is ended.

When the terminal 20 receives the main content data and the whole advertisement data that is a moving image from the server 10, the terminal 20 arranges the whole advertisement image 242a that is a moving image based on the whole advertisement data in the first layer, and arranges the web page 241 based on the main content data in the second layer, for example, without limitation thereto (A3).

The web page 241 (main content information) has a transparent region 241a. For this reason, when the transparent region 241a appears in the page display region according to the scroll operation performed by the user, the user can view a portion of the whole advertisement image 242a that is a moving image via the transparent region 241a.

After A3, the terminal 20 determines whether or not a scroll operation has been performed (A5).

If no scroll operation has been performed (A5: No), the scroll operation is waited for.

If a scroll operation has been performed (A5: Yes), the web page 241 is moved in the direction of the scroll operation (A7).

Next, the terminal 20 determines whether or not the playback flag has been set (A7c).

The “playback flag” in this processing is a flag that is set when moving-image playback of whole advertisement image 242a is started. After the playback flag is set, moving-image playback of the whole advertisement image 242a is continued.

If the playback flag has been set (A7c: Yes), the processing is advanced to A13.

If the playback flag has not been set (A7c: No), the terminal 20 determines whether or not the playback start condition of the whole advertisement image 242a is satisfied (A9c). Specifically, it is determined whether or not a portion of the transparent region 241a is superimposed on the whole advertisement image 242a as a result of scrolling the web page 241, for example, without limitation thereto.

If the playback start condition is not satisfied (A9c: No), the terminal 20 advances the processing to A13.

On the other hand, if the playback start condition is satisfied (A9c: Yes), the terminal 20 starts moving-image playback of the whole advertisement image 242a (A11c). Then, after the playback flag is set (A11d), the terminal 20 advances the processing to A13.

### Effects of Tenth Embodiment

In the tenth embodiment, the terminal 20 displays the whole advertisement image that is a moving image in the page display region (a non-limiting example of the display region of the terminal) based on the moving image data received from the server 10. Alternatively or additionally, the terminal 20 displays the main content information (web page 241) (a non-limiting example of content) having the transparent region 241a in the page display region. Then, the terminal 20 executes control for moving in the page display region on at least the transparent region 241a of the web page 241 based on the scroll operation (a non-limiting example of first input) performed by the user on the page display region. Then, a configuration is shown in which the terminal 20 executes playback of the whole advertisement image that is a moving image based on the transparent region 241a.

As an example of the effect obtained by such a configuration, playback of the moving image can be linked with the first input via the movement of the transparent region. As a result, playback of a partial region of the moving image is also linked to the first input via the movement of the transparent region.

Tenth Variation

The playback start condition described in the tenth embodiment is merely an example. As the playback start condition, any of the following conditions can be set, for example, without limitation thereto.

(A-1) That a portion of the transparent region is superimposed on the whole advertisement image (same as in the tenth embodiment).

(A-2) That the entirety of the transparent region is superimposed on the whole advertisement image.

(A-3) That a predetermined percentage (non-limiting examples of which include a value that is about 30% to 70%) of the transparent region is displayed in the page display region.

In addition to the above, it is also possible to set the following as the playback start condition, for example, without limitation thereto.

(A-4) That a portion of the transparent region is superimposed on the region of interest.

(A-5) That the entirety of the transparent region is superimposed on the region of interest.

However, if the region of interest is smaller than the transparent region, the implication of these conditions is:

(A-4) That the transparent region includes a portion of the region of interest.

(A-5) That the transparent region includes the entirety of the region of interest.

Note that, in relation to the playback start conditions of (A-1) and (A-2), the playback start condition may optionally be that a predetermined percentage of the transparent region is superimposed on the whole advertisement image.

Alternatively or additionally, in relation to the playback start conditions of (A-4) and (A-5), the playback start condition may optionally be that a predetermined percentage of the transparent region is superimposed on the region of interest.

It is also possible to apply any of the above-mentioned playback start conditions, but here, as an example, an example of a display screen in the case where the above-mentioned playback start condition of (A-5) is applied will be described.

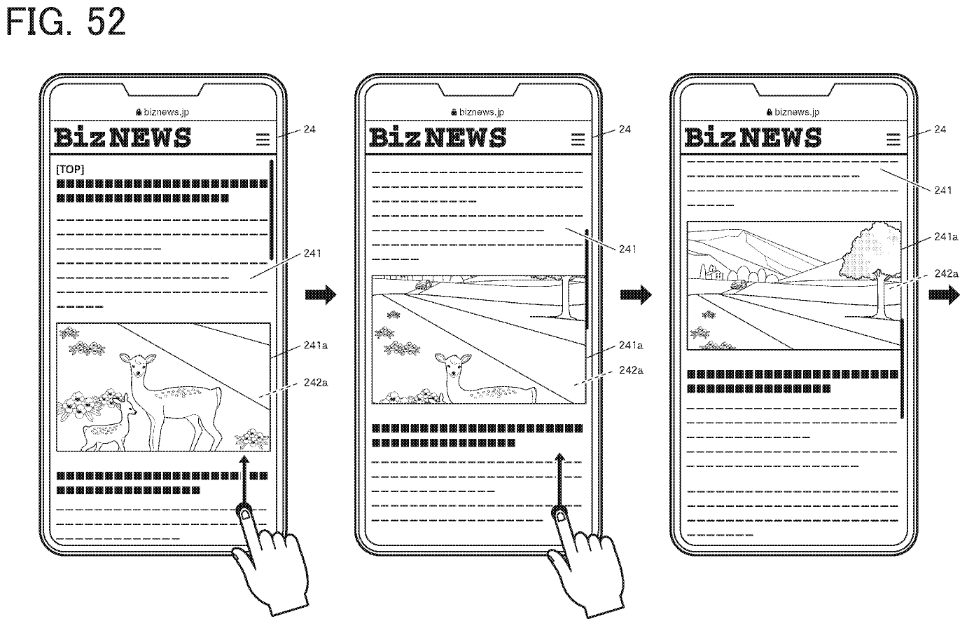

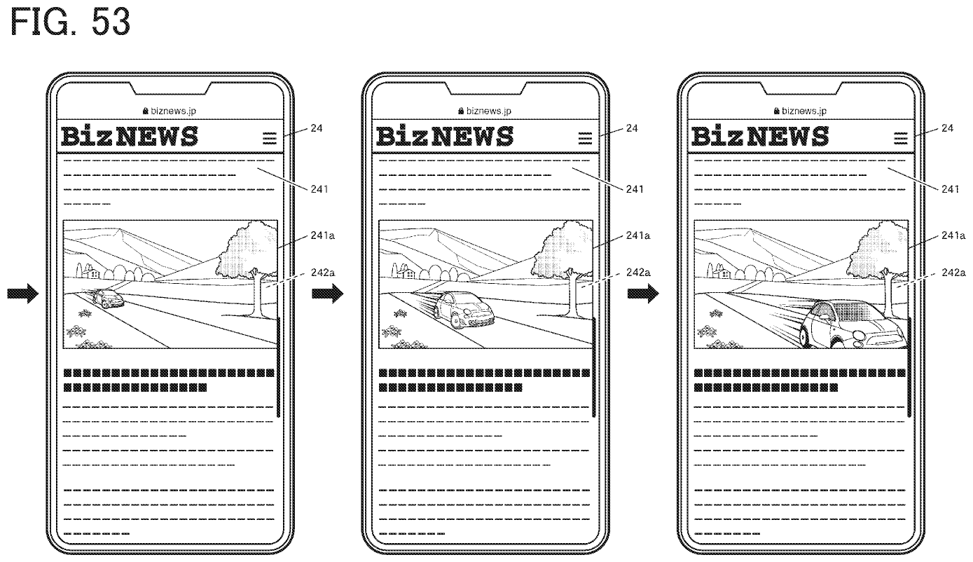

In the examples shown in FIGS. 52 and 53, the web page 241 of the business news site is arranged in the second layer as the main content information based on the main content data, and the whole advertisement image 242a is arranged in the first layer as the advertisement content information based on the advertisement content data distributed in association with the main content data. In this example, the whole advertisement image 242a is a moving image displaying a situation in which an automobile is traveling on the road, and is arranged in the entirety of the first layer.

In the example shown in FIG. 52, the vertical width of the web page 241 is larger than the vertical width of the page display region, and therefore the entirety of the web page 241 cannot fit in the page display region. As a result, in the state where the web page 241 is in the initial position, a portion of the web page 241 including the top portion [TOP] of the web page 241 is displayed in the page display region, and the final portion [END] of the web page 241 is not displayed. Alternatively or additionally, in this example, the transparent region 241a is located between the central portion and the lower portion of the page display region.

The web page 241 scrolls in the screen upward direction due to the user touching the page display region (i.e., a region that is different from the transparent region 241a) and performing a scroll operation of moving his or her finger in the screen upward direction. Accompanying this, the transparent region 241a also scrolls in the screen upward direction. Then, as shown in the rightmost portion of FIG. 52, when the transparent region 241a includes the entirety of the region of interest of the whole advertisement image 242a, it is determined that the playback start condition is satisfied, and as the whole advertisement image 242a, playback of a moving image in which an automobile travels forward on a road is started, for example, without limitation thereto.

Thereafter, as shown in FIG. 53, playback of the whole advertisement image 242a is continued, and the automobile in the whole advertisement image 242a travels forward on the road.

Effects of Tenth Variation

As an example of the effect obtained by such a configuration, it is possible to control playback of a moving image based on various conditions.

### Eleventh Embodiment

The eleventh embodiment is an embodiment in which the entirety of a moving image (whole advertisement image) being played back is displayed based on the second input performed by the user in the tenth embodiment.

The eleventh embodiment corresponds to the third embodiment, but differs therefrom in that the whole advertisement image is not a still image but a moving image.

The features described in the eleventh embodiment can also be applied and/or combined with to other embodiments and variations.

The same constituent elements as those already mentioned are denoted by the same reference numerals, and the redundant description thereof is omitted.

Display Screen Example

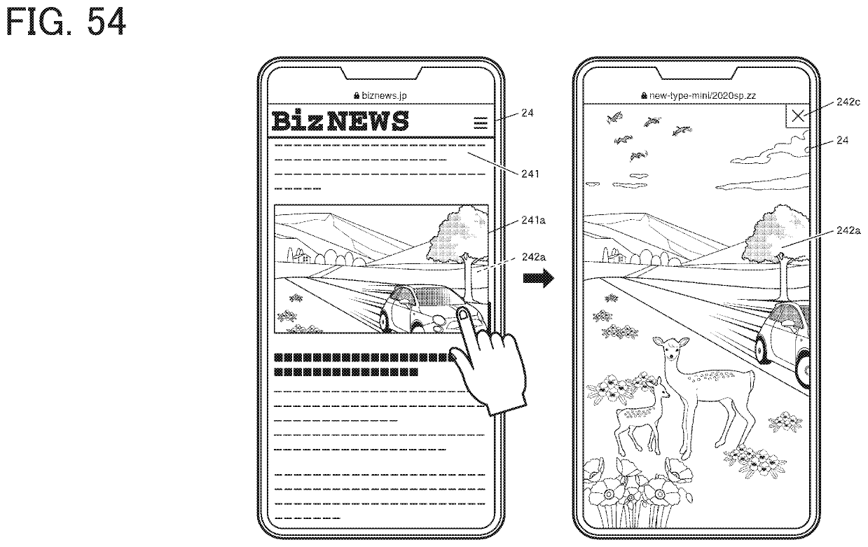

In the example shown in FIG. 54, a state is shown in which the transparent region 241a is touch-operated by the user after the whole advertisement image 242a of the moving image is played back in the examples shown in FIGS. 52 and 53.

In this case, the whole advertisement image 242a being played back is displayed in its entirety based on a touch operation being performed on the transparent region 241a. Specifically, the whole advertisement image 242a that is a moving image of an automobile traveling forward on a road is displayed in the entire page display region, for example, without limitation thereto.

Processing

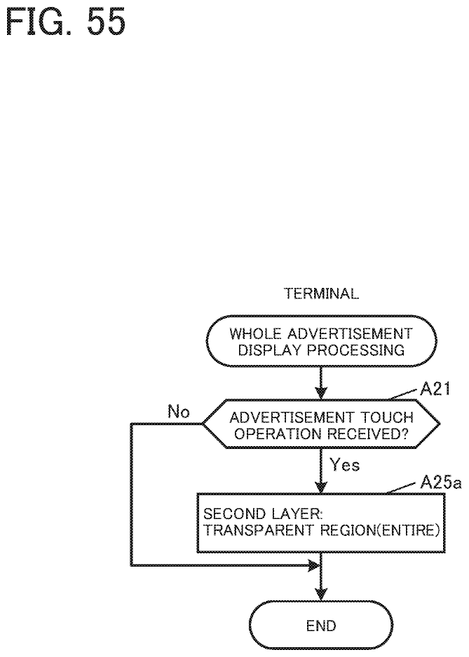

FIG. 55 is a flowchart showing an example of a flow of whole advertisement display processing, which is an example of processing executed by the display processor 211 of the terminal 20 in this embodiment.

This whole advertisement display processing can be executed after the playback flag is set (after A11d in FIG. 10-A), for example, without limitation thereto.

The processing shown in FIG. 10-B is processing in which step A25 in the processing shown in FIG. 12 has been replaced with step A25a.

The terminal 20 determines whether or not a touch operation (second input) has been performed on the transparent region 241a, for example, without limitation thereto (A21). If a touch operation has not been performed by the user (A21: No), the terminal 20 ends the whole advertisement display processing.

On the other hand, if a touch operation has been performed by the user (A21: Yes), the terminal 20 sets the entirety of the web page 241 arranged in the second layer in the transparent region 241a (A25). Due to the entirety of the web page 241 being set in the transparent region 241a, the user can view the whole advertisement image 242a that is a moving image being played back in the first layer.

Note that, any of (1) a method of setting the entirety of the main content information of the second layer in the transparent region, (2) a method of performing a layer change in which the main content information in the second layer is rearranged in the first layer and the whole advertisement image in the first layer is rearranged in the second layer, and (3) a method of hiding the information in the second layer (a method of erasing the main content information in the second layer) may be used as the method for displaying the entirety of the whole advertisement image (the moving image being played back), for example, without limitation thereto.

### Effects of Eleventh Embodiment

The eleventh embodiment shows a configuration in which the whole advertisement image that is a moving image (a non-limiting example of a first moving image) is displayed in the entirety of the page display region based on a touch operation performed by the user (a non-limiting example of second input).

As an example of the effect obtained by such a configuration, the first moving image can be made visible to the user of the terminal based on the second input.

### Twelfth Embodiment

The twelfth embodiment is an embodiment relating to the playback of a partial moving image.

The twelfth embodiment is the same as the tenth embodiment in that the advertisement image is a moving image, but the twelfth embodiment differs in that the advertisement image arranged in the first layer is a partial advertisement image that is a moving image (hereinafter, referred to as a “partial moving image” as appropriate), and control of playback of the partial moving image is executed based on the transparent region.

In this embodiment, the partial moving image is a partial region of the whole advertisement image that is a moving image (non-limiting examples of which include a portion of the whole advertisement image that is a moving image). More specifically, the partial moving image can be formed by trimming a region of a portion of the whole advertisement image, which is a moving image, or the like, for example, without limitation thereto.

The features described in the twelfth embodiment can also be applied to and/or combined with other embodiments and variations.

The same constituent elements as those already mentioned are denoted by the same reference numerals, and redundant description thereof is omitted.

Similarly to the playback start condition of (A-1) described in the tenth embodiment, basically, the playback start condition of the partial advertisement image (partial moving image) can be

(B-1) That a portion of the transparent region is superimposed on the partial advertisement image.

Note that, in addition to the above, similarly to the above-mentioned playback start condition of the whole advertisement image of (A-2) to (A-5), conditions such as

(B-2) That the entirety of the transparent region is superimposed on the partial advertisement image.

(B-3) That a predetermined percentage of the transparent region (non-limiting examples of which include a value of about 30% to 70%) is displayed in the page display region.

(B-4) That a portion of the transparent region is superimposed on the region of interest.

(B-5) That the entirety of the transparent region is superimposed on the region of interest.

can also be set as the playback start condition.

However, if the partial advertisement image is smaller than the transparent region, the implication of the conditions (B-1) and (B-2) is

(B-1) That a portion of the partial advertisement image is included in the transparent region.

(B-2) That the transparent region includes the entirety of the partial advertisement image.

This applies to the conditions of (B-4) and (B-5) as well.

Note that, in relation to the playback start conditions of (B-1) and (B-2), the playback start condition may optionally be that a predetermined percentage of the transparent region is superimposed on the partial advertisement image.

Similarly, in relation to the playback start conditions of (B-4) and (B-5), the playback start condition may optionally be that a predetermined percentage of the transparent region is superimposed on the region of interest.

As described above, the image in the region of interest can be a partial advertisement image. In this case, the conditions of (B-1) and (B-2) among the above-mentioned playback start conditions are the same as the conditions of (B-4) and (B-5), respectively.

Display Screen Example

Although any of the above-mentioned playback start conditions can also be applied, here, as an example, an example of a display screen in the case where the above-mentioned playback start condition (B-3) is applied will be described. In this example, the predetermined percentage will be described as 60%.

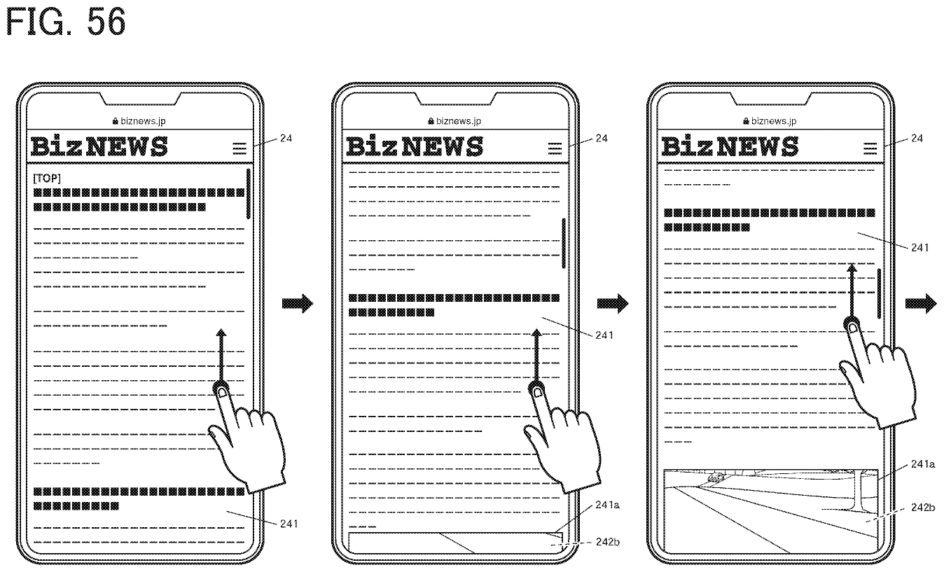

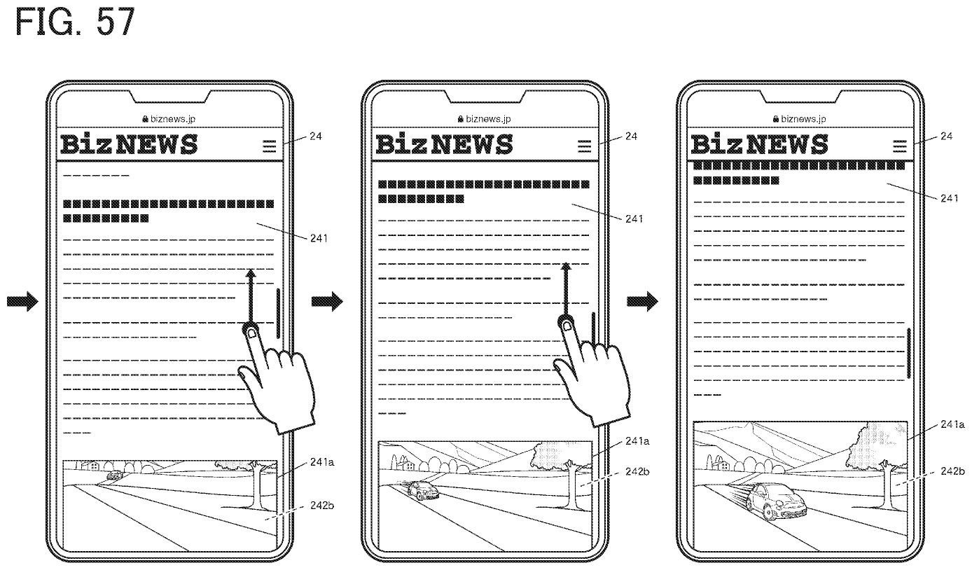

In the examples shown in FIGS. 56 and 57, the web page 241 of the business news site is arranged in the second layer as the main content information based on the main content data, and the partial advertisement image 242b is arranged in the first layer as the advertisement content information based on the advertisement content data distributed in association with the main content data. In this example, the bottom side of the partial advertisement image 242b is arranged along the bottom side of the page display region, for example, without limitation thereto.

In this example, the partial advertisement image 242b is a still image in which an automobile is displayed in the initial state, but in the state where the web page 241 is in the initial position, the transparent region 241a is not displayed in the page display region of the terminal 20, and therefore the user cannot view the partial advertisement image 242b.

When a predetermined percentage of the vertical width of the transparent region 241a (non-limiting examples of which include 60%) is displayed in the page display region of the terminal 20 due to a scroll operation performed by the user, the partial advertisement image 242b is a partial moving image displaying a situation in which an automobile is traveling on a road.

Note that in the examples shown in FIGS. 56 and 57, the partial advertisement image 242b is a horizontally elongated image with a horizontal width that is larger than its vertical width, and is arranged at the lower end of the first layer. The relative position of the partial advertisement image 242b with respect to the page display region is fixed. That is, the partial advertisement image 242b does not change its position even if the user scrolls the web page 241.

In the state where the partial advertisement image 242b is displayed in the page display region, there is no region for displaying other information below the partial advertisement image 242b. It can also be said that the bottom side of the partial advertisement image 242b matches the bottom side of the page display region.

In the example shown in FIG. 56, the vertical width of the web page 241 is larger than the vertical width of the page display region, and therefore the entirety of the web page 241 cannot fit in the page display region. Alternatively or additionally, in this example, the vertical width from the top portion [TOP] of the web page 241 to the transparent region 241a is larger than the vertical width of the page display region, and therefore, in the state where the web page 241 is in the initial position, the transparent region 241a is not located in the page display region. For this reason, in the state where the web page 241 is in the initial position, the user cannot view the partial advertisement image 242b of the first layer at all, and cannot understand whether or not the web page 241 includes a transparent region.

If the web page 241 is in the initial position, the transparent region 241a scrolls in the screen upward direction together with the web page 241 accompanying the scroll operation performed by the user, and the upper portion of the transparent region 241a appears from the lower portion of the screen. Since the upper portion of the transparent region 241a is located in the page display region, the upper portion of the transparent region 241a and the lower portion of the partial advertisement image 242b are superimposed on each other, and the lower portion of the partial advertisement image 242b (in this example, the portion including a portion on the forward side of the road) becomes visible via the transparent region 241a. The partial advertisement image 242b at this time is a still image. This still image is the first frame when the partial advertisement image 242b is played back as a partial moving image, for example, without limitation thereto.

Furthermore, when the user continues to scroll in the screen upward direction, approximately 50% of the vertical width of the transparent region 241a is displayed in the page display region of the terminal 20. At this time, the automobile in the partial advertisement image 242b is visible via the transparent region 241a, but since the partial advertisement image 242b is a still image, the automobile is stationary in the image.

When the user continues to scroll in the screen upward direction, as shown in FIG. 57, playback of the partial moving image (partial advertisement image 242b) in which the automobile travels forward on the road starts based on a predetermined percentage (60%) of the vertical width of the transparent region 241a being displayed in the page display region of the terminal 20.

When the user further continues the scroll operation and scrolls the web page 241 in the screen upward direction, the transparent region 241a moves further upward, and approximately 75% of the vertical width of the transparent region 241a is displayed in the page display region of the terminal 20, for example, without limitation thereto. While the transparent region 241a moves upward, playback of the partial moving image is continued, and the automobile in the partial advertisement image 242b travels forward on the road.

Then, when the user further continues the scroll operation and scrolls the web page 241 in the screen upward direction, the transparent region 241a moves further upward, and approximately 80% of the vertical width of the transparent region 241a is displayed in the page display region of the terminal 20, for example, without limitation thereto. During this period as well, playback of the partial moving image is continued, and the automobile in the partial advertisement image 242b further travels forward on the road.

Processing

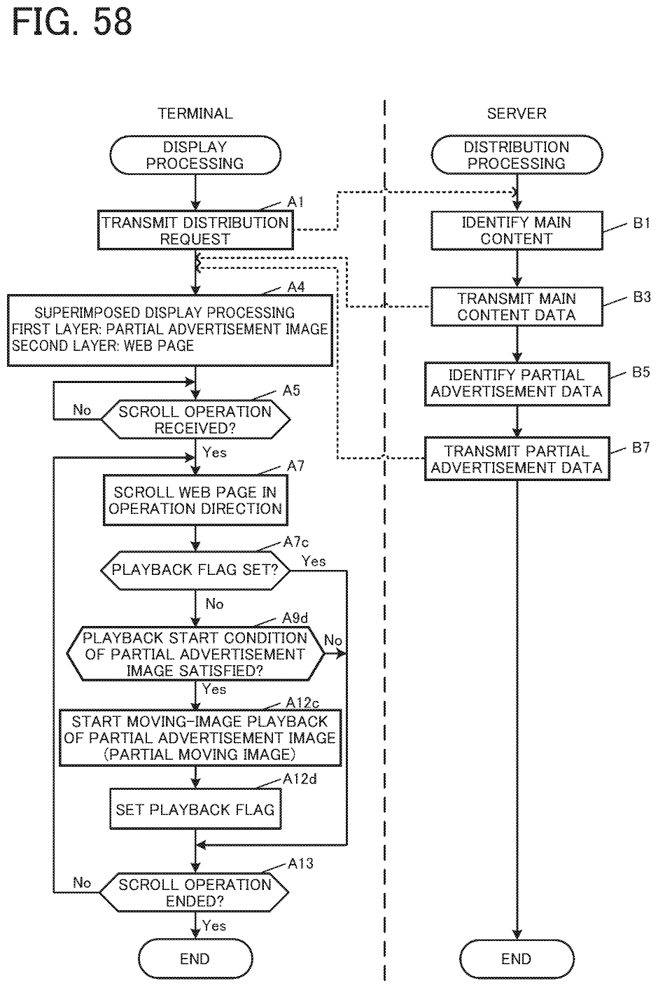

FIG. 58 is a flowchart showing an example of a flow of processing executed by each device in this embodiment.

In this diagram, the distribution processing executed by the distribution processor 111 of the server 10 and the display processing executed by the display processor 211 of the terminal 20 are shown.

The same steps as those in the flowchart described above are denoted by the same reference numerals, redundant description thereof is omitted, and description will be given with a focus on steps that are different.

The flowchart described below merely illustrates the processing in this embodiment, and in the flowchart described below, some steps need not be executed, and additional steps may be inserted.

In FIG. 58, steps A1b to A12a in FIG. 19 have been replaced with steps A7c to A12d as the processing in the case where the partial advertisement image is a moving image.

When the terminal 20 receives the main content data and the partial advertisement data from the server 10, the terminal 20 arranges the partial advertisement image 242b that is a still image based on the partial advertisement data in the first layer, arranges the web page 241 based on the main content data in the second layer, and thereby displays the web page 241 in a superimposed manner on the partial advertisement image 242b (A4).

After A7, the terminal 20 determines whether or not the playback flag has been set (A7c).

The “playback flag” in this processing is a flag that is set if moving-image playback of the partial advertisement image 242b has been started. After the playback flag is set, moving-image playback of the partial advertisement image 242b is continued.

If it has been determined that the playback flag has not been set (A7c; No), the terminal 20 determines whether or not the playback start condition of the partial advertisement image (partial moving image) is satisfied (A9d). Specifically, it is determined whether or not a predetermined percentage (non-limiting examples of which include 60%) of the vertical width of the transparent region 241a is displayed in the page display region of the terminal 20, for example, without limitation thereto.

If the playback start condition is not satisfied (A9d: No), the terminal 20 advances the processing to A13.

On the other hand, if the playback start condition is satisfied (A9d: Yes), the terminal 20 starts moving-image playback of the partial moving image (partial advertisement image 242b) (A12c). Then, after the playback flag is set (A12d), the terminal 20 advances the processing to A13.

### Effects of Twelfth Embodiment

The twelfth embodiment shows a configuration in which the terminal 20 displays a partial advertisement image 242b (a non-limiting example of a first partial moving image) that is a partial region of the whole advertisement image 242a (a non-limiting example of a first moving image) that is a moving image received from the server 10, in at least the page display region (a non-limiting example of the display region of the terminal), and displays, in the page display region, main content information (web page 241) (a non-limiting example of content) that is superimposed on at least a portion of the partial advertisement image 242b and at least partially includes the transparent region 241a. Control for moving in the page display region is executed on at least the transparent region 241a of the web page 241 based on a scroll operation (a non-limiting example of the first input) performed by the user of the terminal 20 on the page display region. Then, control of moving-image playback of the partial advertisement image 242b is executed based on the transparent region 241a.

As an example of the effect obtained by such a configuration, since control of playback of the first partial moving image can be linked with the first input via the movement of the transparent region, start of playback, stopping of playback, and the like of the first partial moving image can be executed at an appropriate timing according to the first input.

The twelfth embodiment shows a configuration in which control of playback of the partial moving image is executed based on the length of at least one side of the transparent region 241a displayed in the page display region.

As an example of the effect obtained by such a configuration, it is possible to execute start of playback, stopping of playback, or the like of the first partial moving image according to the visibility via the transparent region.

The twelfth embodiment shows a configuration in which the advertisement content data (a non-limiting example of the first moving image data) is data relating to an advertisement.

As an example of the effect obtained by such a configuration, it is possible to generate linkage between the transparent region and an advertisement that is a moving image based on the advertisement content data, and to improve the advertisement effect.

The twelfth embodiment shows a configuration in which the first input is a scroll operation performed by the user, and the transparent region 241a is moved in a direction based on the scroll operation.

As an example of the effect obtained by such a configuration, it is possible to increase the likelihood that the user will pay attention to the first partial moving image due to the transparent region moving in the direction intended by the user.

Although an example was shown in which playback of the partial moving image (partial advertisement image 242b) is started when a predetermined percentage of the vertical width of the transparent region 241a is displayed in the page display region of the terminal 20, there is no limitation to such a configuration, and control of playback of the partial moving image (partial advertisement image 242b) may be executed based on the transparent region 241a being displayed in the page display region of the terminal 20.

The terminal 20 can start playback of the partial moving image (partial advertisement image 242b) if at least a portion (including both a portion (the predetermined percentage is less than 100%) and the entirety (the predetermined percentage is 100%) of the transparent region 241a) appears in the page display region due to the scroll operation performed by the user, for example, without limitation thereto.

As an example of the effect obtained by such a configuration, start of playback, stopping of playback, or the like of the first partial moving image can be executed in a state where a portion of the transparent region is visible and a state where the entirety of the transparent region is visible.

Alternatively or additionally, although an example was shown in which playback of the partial moving image (partial advertisement image 242b) is started if a predetermined percentage of the vertical width of the transparent region 241a is displayed in the page display region of the terminal 20, there is no limitation to such a configuration, and control of playback of the partial moving image (partial advertisement image 242b) may be executed based on the size of the transparent region 241a displayed in the page display region of the terminal 20.

The terminal 20 can start playback of the partial moving image (partial advertisement image 242b) when a predetermined percentage of the area of the transparent region 241a appears in the page display region due to the scroll operation performed by the user, for example, without limitation thereto.

As an example of the effect obtained by such a configuration, start of playback, stopping of playback, or the like of the first partial moving image can be executed in a state where a transparent region having a size sufficient for viewing via the transparent region appears in the display region.

Alternatively or additionally, although an example was shown in which playback of the partial moving image (partial advertisement image 242b) is started if a predetermined percentage of the vertical width of the transparent region 241a is displayed in the page display region of the terminal 20, there is no limitation to such a configuration, and control of playback of the partial moving image (partial advertisement image 242b) may be executed based on a partial region of the transparent region 241a being displayed in the page display region of the terminal 20.

The terminal 20 starts playback of the partial advertisement image 242b that is a partial moving image when a specific pixel or a group of pixels among the pixels constituting the transparent region 241a appears in the page display region due to the scroll operation performed by the user, for example, without limitation thereto.

As an example of the effect obtained by such a configuration, start of playback, stopping of playback, or the like of the first partial moving image can be executed at the timing when a region suitable for viewing via the transparent region is displayed in the display region.

The twelfth embodiment shows a configuration in which control of playback of the partial moving image (partial advertisement image 242b) is executed based on whether or not there is superimposition between the transparent region 241a and the partial advertisement image 242b, the superimposition ratio, and the like.

As an example of the effect obtained by such a configuration, control of playback of the first partial moving image can be executed based on the positional relationship between the transparent region and the first partial moving image in the display region.

In this case, control of playback of the partial moving image (partial advertisement image 242b) is executed based on the transparent region 241a being superimposed on at least a portion of the partial advertisement image 242b, and thereby the partial moving image can be played back at an early timing (non-limiting examples of which include the timing when at least a portion of the partial advertisement image becomes visible to the user).

In the above-described embodiment, although an example was shown in which the partial moving image (partial advertisement image 242b) is a portion of the whole advertisement image 242a that is a moving image, there is no limitation to such a configuration, and the partial moving image (partial advertisement image 242b) may optionally be the entirety of the whole advertisement image 242a that is a moving image.

Twelfth Variation (1)

In the twelfth embodiment, an example was shown in which, in the state where the web page 241 is in the initial position, the transparent region 241a of the web page 241 is not displayed in the page display region (see FIGS. 56 and 57). However, there is no limitation to such a configuration, and the transparent region 241a of the web page 241 can also be displayed in the page display region in the state where the web page 241 is in the initial position.

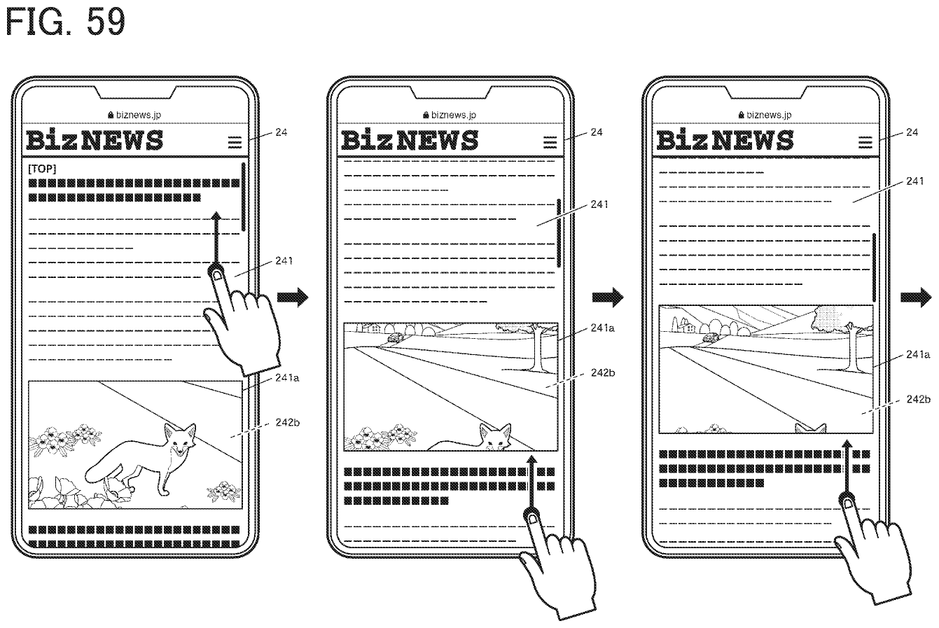

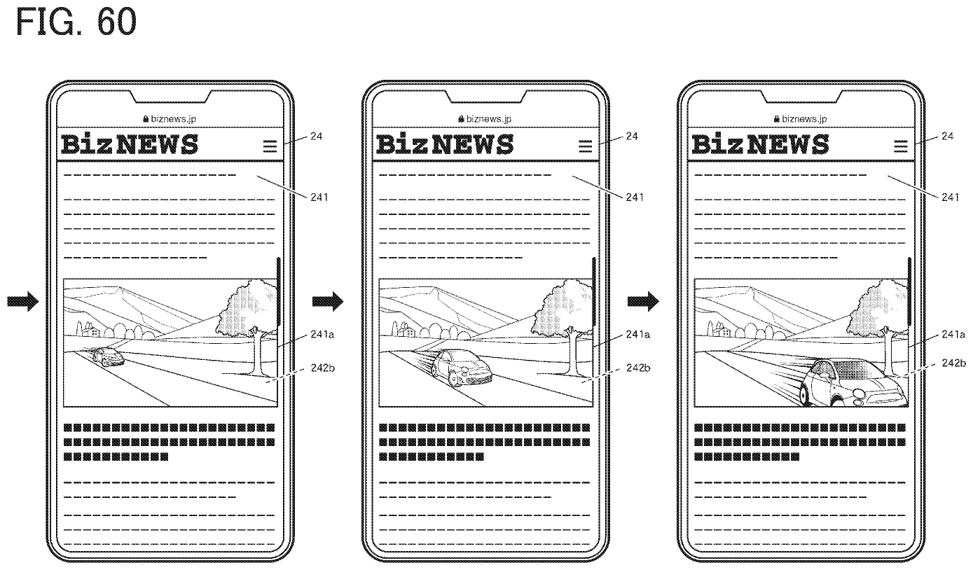

In the example shown in FIG. 59, the transparent region 241a is already displayed in the page display region, and the lower portion (the region including a fox) of the partial advertisement image 242b can be viewed via the transparent region 241a. That is, in this example, the transparent region 241a is already superimposed on the partial advertisement image 242b. If such an arrangement of the transparent region 241a and the partial advertisement image 242b is applied, the above-described playback start condition of (B-4) or (B-5) can be applied, for example, without limitation thereto. Here, a case where the playback start condition of (B-5) is applied is illustrated.

When the transparent region 241a is moved such that the entirety of the region of interest (the region of interest of the whole advertisement image corresponding to the partial advertisement image 242b) is included due to the scroll operation performed by the user, playback of a partial moving image displaying a situation in which an automobile travels on a road is started, for example, without limitation thereto. In this example, an upper predetermined range of the partial advertisement image 242b including the automobile is set as the region of interest.

Specifically, the transparent region 241a moves upward together with the web page 241 accompanying the scroll operation performed by the user, and the automobile in the partial advertisement image 242b becomes visible, but while the entirety of the region of interest is not included in the transparent region 241a, the partial advertisement image 242b remains a still image, and the automobile is stationary in the image.

Furthermore, when the user continues the scroll operation in the screen upward direction and the transparent region 241a includes the entirety of the region of interest, playback of the partial moving image (partial advertisement image 242b) in which the automobile travels forward on the road starts.

As shown in FIG. 60, when the user further continues the scroll operation and scrolls the web page 241 in the screen upward direction, the transparent region 241a moves further upward. While the transparent region 241a moves upward, playback of the partial advertisement image 242b (partial moving image) is continued, and the automobile in the partial advertisement image 242b travels forward on the road.

Then, even if the user stops the scroll operation and the position of the transparent region 241a in the page display region of the terminal 20 does not move, playback of the partial moving image is continued, and the automobile in the partial advertisement image 242b travels forward on the road.

Effects of Twelfth Variation (1)

According to this variation, the transparent region is located in the display region (non-limiting examples of which include the page display region) in the initial state, and the user can view at least a portion of the partial moving image from the beginning via this transparent region, and therefore, the display effect (non-limiting examples of which include the advertisement effect) can be improved. Alternatively or additionally, it is possible to increase the degree of freedom in the arrangement of the transparent region and the degree of freedom in the design of the content (non-limiting examples of which include the web page).

Twelfth Variation (2)

In the twelfth embodiment, an example was shown in which one partial advertisement image 242b is arranged in the first layer by the terminal 20, but there is no limitation to such a configuration, and a plurality of partial advertisement images 242b may be arranged in the first layer.

Display Screen Example

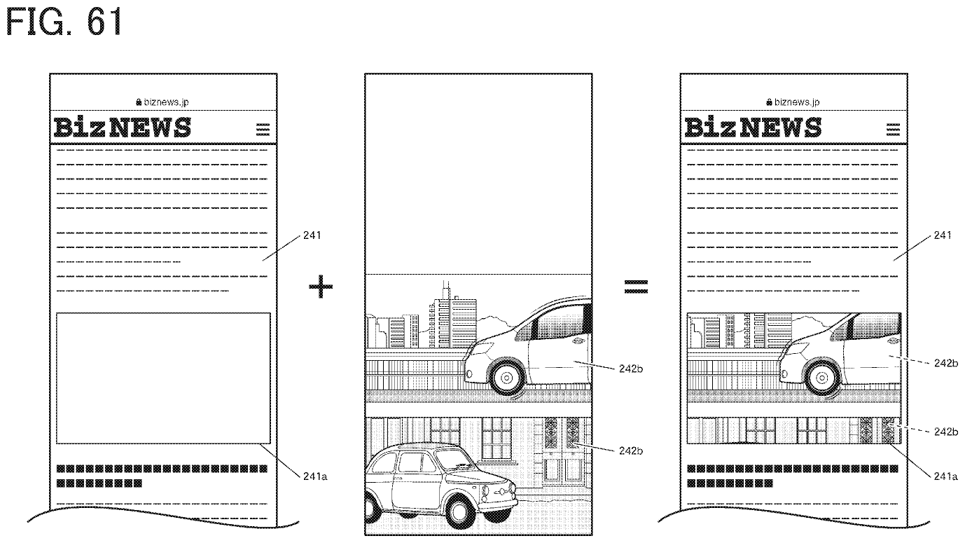

In the examples shown in FIGS. 61 to 64, two partial advertisement images 242b are arranged as advertisement content information in the first layer, and a web page 241 is arranged in the second layer.

In this example, as shown in FIG. 61, a first partial advertisement image 242b of a hatchback-type automobile traveling to the right and a second partial advertisement image 242b of a minivan-type automobile traveling to the left are arranged in the first layer. Alternatively or additionally, the web page 241 of the business news site is arranged as the main content information in the second layer.

The first partial advertisement image 242b and the second partial advertisement image 242b are both horizontally elongated images and are arranged aligned in the vertical direction in the first layer. The relative position of the first partial advertisement image 242b with respect to the page display region and the relative position of the second partial advertisement image 242b with respect to the page display region are fixed. That is, the first partial advertisement image 242b and the second partial advertisement image 242b do not change their positions even if the user scrolls the web page 241.

The first partial advertisement image 242b is a partial moving image formed by trimming a predetermined region of the first whole advertisement image that is a moving image, and is arranged at the lower end of the page display region of the terminal 20, for example, without limitation thereto. In the state where the first partial advertisement image 242b is displayed in the page display region, there is no region for displaying other information below the partial advertisement image 242b. It can also be said that the bottom side of the first partial advertisement image 242b matches the bottom side of the page display region.

The first partial advertisement image 242b is a still image in which the first portion of the hatchback-type automobile is displayed in the initial state. This still image is the first frame when the first partial advertisement image 242b is played back as a partial moving image, for example, without limitation thereto.

In the first partial advertisement image 242b, if a predetermined percentage or more, non-limiting examples of which include 70% or more, of the area of the transparent region 241a is superimposed on the first partial advertisement image 242b due to the scroll operation performed by the user, playback of the partial moving image is started, and if 70% or more of the area of the transparent region 241a is not superimposed on the first partial advertisement image 242b, playback of the partial moving image is stopped.

The second partial advertisement image 242b is a partial moving image formed by trimming a predetermined region of the second whole advertisement image that is a moving image, and is arranged adjacent to the upper side of the first partial advertisement image 242b, for example, without limitation thereto. That is, the first partial advertisement image 242b and the second partial advertisement image 242b are located at the lower portion of the screen and the central portion of the screen, respectively.

The second partial advertisement image 242b has approximately the same size as the first partial advertisement image 242b, and is a still image in which the first portion of the minivan-type automobile is displayed in the state before the start of playback. This still image is the first frame when the second partial advertisement image 242b is played back as a partial moving image, for example, without limitation thereto.

In the second partial advertisement image 242b, if a predetermined percentage or more, non-limiting examples of which include 70% or more, of the area of the transparent region 241a is superimposed on the second partial advertisement image 242b due to a scroll operation performed by the user, playback of the partial moving image is started, and if 70% or more of the area of the transparent region 241a is not superimposed on the second partial advertisement image 242b, playback of the partial moving image is stopped.

In this example, the partial advertisement image 242b is a still image in which the automobile is displayed in the initial state, but in the state where the web page 241 is in the initial position, a portion of the upper side of the transparent region 241a is displayed in the page display region of the terminal 20, and the user can view part of the lower portion of the first partial advertisement image 242b.

When a predetermined percentage (non-limiting examples of which include 70%) of the area of the transparent region 241a is superimposed on the first partial advertisement image 242b due to the scrolling operation performed by the user, the first partial advertisement image 242b is a partial moving image displaying a situation in which an automobile travels on a road.

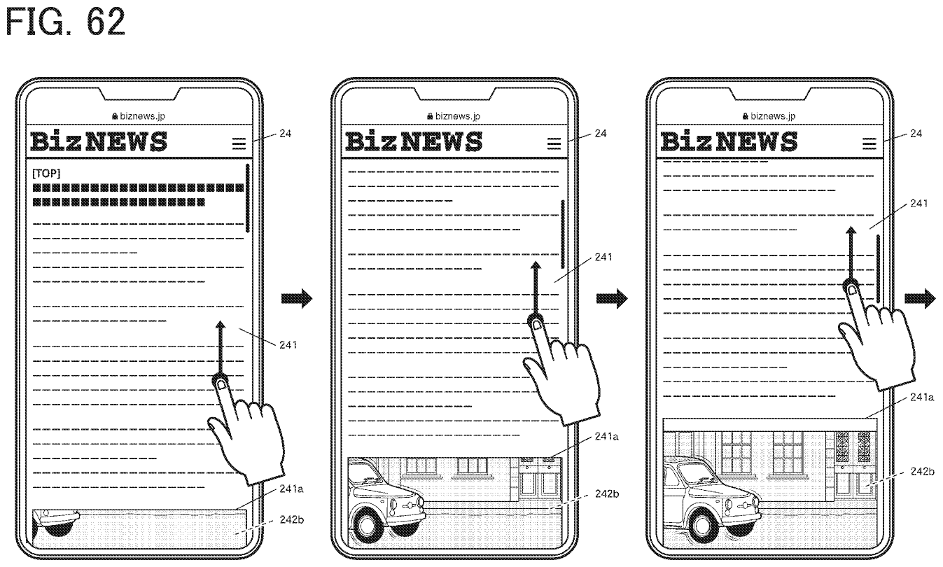

In the example shown in FIG. 62, the vertical width of the web page 241 is larger than the vertical width of the page display region, and therefore the entirety of the web page 241 cannot fit in the page display region. In this example, a portion of the upper side of the transparent region 241a is located on the lower side of the page display region of the terminal 20. At this time, the lower portion of the hatchback-type automobile in the partial advertisement image 242b is visible via the transparent region 241a, but since the partial advertisement image 242b is a still image, the hatchback-type automobile is stationary in the image.

If the web page 241 is in the initial position, the transparent region 241a scrolls in the screen upward direction together with the web page 241 accompanying a scroll operation performed by the user, and playback of the partial advertisement image 242b that is a partial moving image in which a hatchback-type automobile travels to the right side on a road starts based on 70% or more of the area of the transparent region 241a being superimposed on the first partial advertisement image 242b.

When the user further continues the scroll operation and scrolls the web page 241 in the screen upward direction, the transparent region 241a moves further upward, and 100% of the area of the transparent region 241a is superimposed on the first partial advertisement image 242b. While the transparent region 241a moves upward, playback of the partial moving image of the first partial advertisement image 242b is continued, and the hatchback-type automobile in the first partial advertisement image 242b travels to the right side on the road.

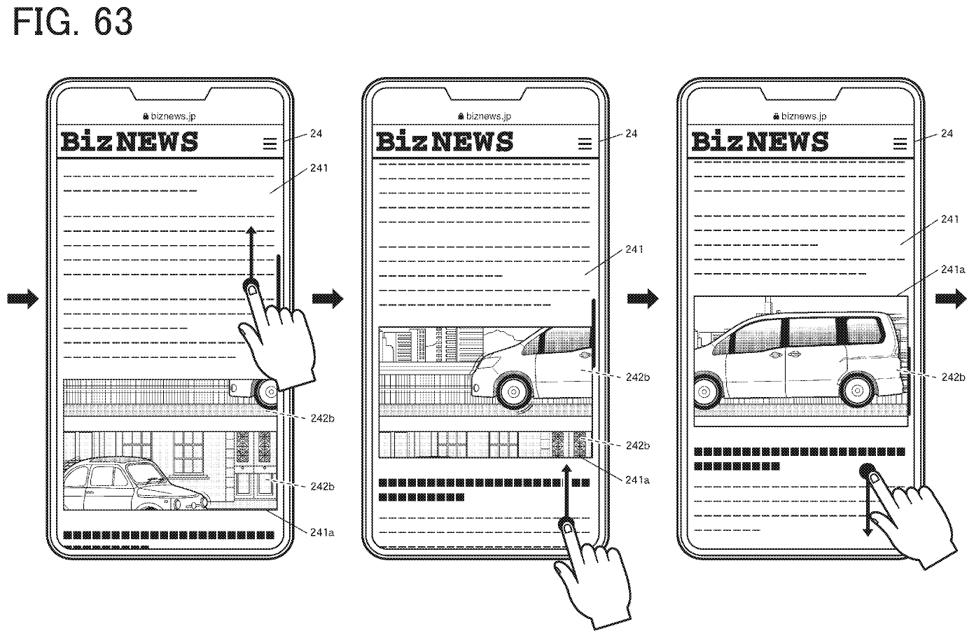

As shown in FIG. 63, when the user continues the scroll operation in the screen upward direction, the transparent region 241a moves further upward, and a portion of the upper side of the transparent region 241a and a portion of the lower side of the second partial advertisement image 242b are superimposed on each other. During this time, playback of the partial moving image of the first partial advertisement image 242b is continued, and the hatchback-type automobile in the first partial advertisement image 242b further travels to the right side on the road.

Then, when the user further continues the scroll operation and scrolls the web page 241 in the screen upward direction, the transparent region 241a moves further upward, and playback of the second partial advertisement image 242b that is a partial moving image in which a minivan-type automobile travels to the left side on a road starts based on 70% or more of the area of the transparent region 241a being superimposed on the second partial advertisement image 242b. On the other hand, regarding the first partial advertisement image 242b, 70% or more of the area of the transparent region 241a is not superimposed on the first partial advertisement image 242b, and thus playback of the partial moving image of the first partial advertisement image 242b is stopped.

When the user further continues the scroll operation and scrolls the web page 241 in the screen upward direction, the transparent region 241a moves further upward, 100% of the area of the transparent region 241a is superimposed on the second partial advertisement image 242b, and the first partial advertisement image 242b cannot be viewed via the transparent region 241a. While the transparent region 241a moves upward, playback of the partial moving image of the second partial advertisement image 242b is continued, and the minivan-type automobile in the second partial advertisement image 242b travels to the left side on the road. On the other hand, in the first partial advertisement image 242b, playback of the partial moving image remains stopped.

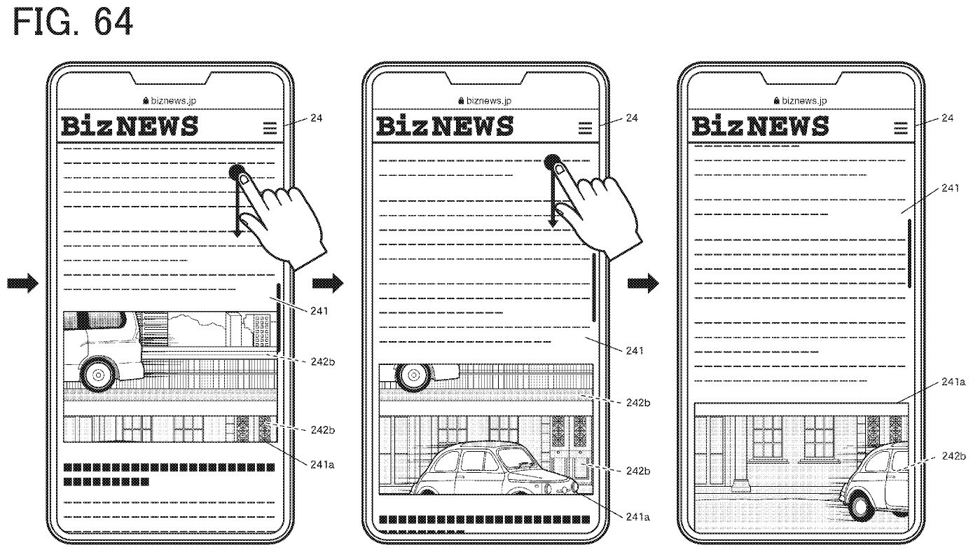

As shown in FIG. 64, when the user switches direction of the scroll operation to the screen downward direction, the transparent region 241a moves downward, and a portion of the lower side of the transparent region 241a and a portion of the upper side of the first partial advertisement image 242b are superimposed on each other. During this time, playback of the partial moving image of the second partial advertisement image 242b is continued, and the minivan-type automobile in the second partial advertisement image 242b further travels to the left side on the road.

Then, when the user further continues the scroll operation and scrolls the web page 241 in the screen downward direction, the transparent region 241a moves further downward, and playback of the first partial advertisement image 242b that is a partial moving image in which a hatchback-type automobile travels to the right side on a road starts based on 70% or more of the area of the transparent region 241a being superimposed on the first partial advertisement image 242b again. On the other hand, regarding the second partial advertisement image 242b, 70% or more of the area of the transparent region 241a is no longer superimposed on the second partial advertisement image 242b, and playback of the partial moving image of the second partial advertisement image 242b stops.

When the user further continues the scroll operation and scrolls the web page 241 in the screen downward direction, the transparent region 241a moves further downward, 100% of the area of the transparent region 241a overlaps with the first partial advertisement image 242b, and the second partial advertisement image 242b is no longer visible via the transparent region 241a. While the transparent region 241a moves downward, playback of the partial moving image of the first partial advertisement image 242b is continued, and the hatchback-type automobile in the first partial advertisement image 242b travels to the right side on the road. On the other hand, in the second partial advertisement image 242b, playback of the partial moving image remains stopped.

Processing

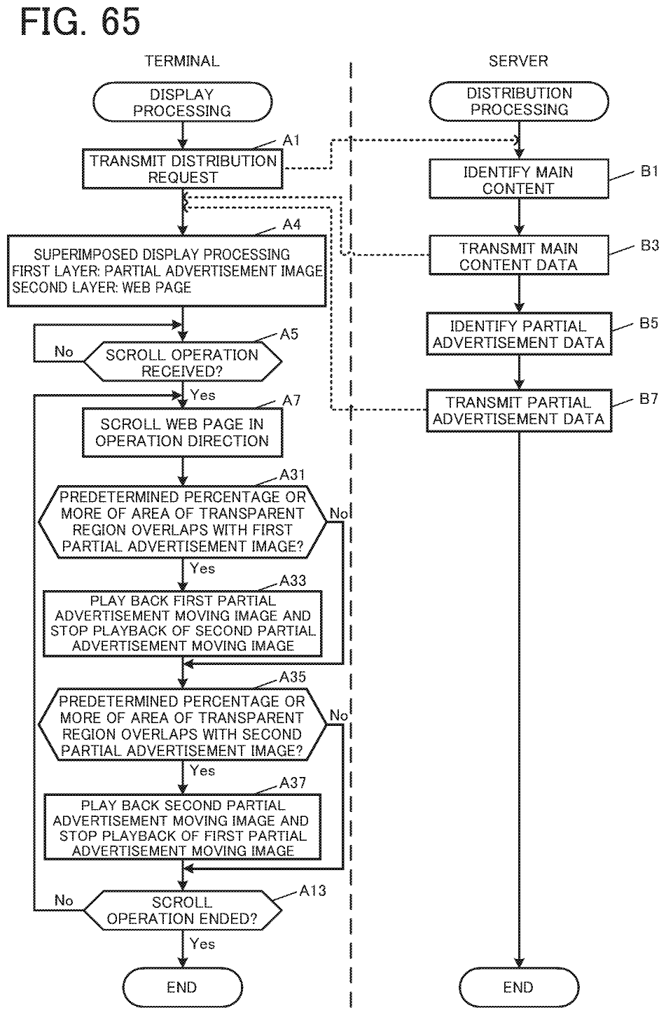

FIG. 65 is a flowchart showing an example of a flow of processing executed by each device in this embodiment.

In this diagram, the distribution processing executed by the distribution processor 111 of the server 10 and the display processing executed by the display processor 211 of the terminal 20 are shown.

The same steps as those in the flowchart described above are denoted by the same reference numerals, redundant description thereof is omitted, and description will be given with a focus on steps that are different.

The flowchart described below merely illustrates the processing in this embodiment, and in the flowchart described below, some steps need not be executed, and additional steps may be inserted.

FIG. 65 is a flowchart obtained by replacing steps A10 and A12 in the flowchart shown in FIG. 19 with steps (non-limiting examples of which include step A31 and step A33) of processing in which playback of the first partial advertisement image 242b that is a partial moving image is started and playback of the second partial advertisement image 242b that is a partial moving image is stopped if a predetermined percentage or more, non-limiting examples of which include 70% or more, of the area of the transparent region 241a is superimposed on the first partial advertisement image 242b, and steps (non-limiting examples of which include step A35 and step A37) of processing in which playback of the second partial advertisement image 242b that is a partial moving image is started and playback of the first partial advertisement image 242b that is a partial moving image is stopped if a predetermined percentage or more, non-limiting examples of which include 70% or more, of the area of the transparent region 241a is superimposed on the second partial advertisement image 242b.

When the terminal 20 receives the main content data, the first partial advertisement data, and the second partial advertisement data from the server 10, the terminal 20 arranges the first partial advertisement image 242b that is a still image based on the first partial advertisement data and the second partial advertisement image 242b that is a still image based on the second partial advertisement data in the first layer. Alternatively or additionally, the terminal 20 arranges the web page 241 based on the main content data in the second layer, and displays the web page 241 in a superimposed manner on the first partial advertisement image 242b and the second partial advertisement image 242b that are still images (A4).

If a scroll operation has been performed (A5: Yes), the terminal 20 moves the web page 241 in the direction of the scroll operation (A7), and determines whether or not 70% or more of the area of the transparent region 241a is superimposed on the first partial advertisement image 242b (A31).

If 70% or more of the area of the transparent region 241a is superimposed on the first partial advertisement image 242b (A31: Yes), the terminal 20 starts playback of the first partial advertisement image 242b that is a partial moving image and stops playback of the second partial advertisement image 242b that is a partial moving image (A33). Note that the terminal 20 does nothing with respect to the second partial advertisement image 242b if playback of the second partial advertisement image 242b that is a partial moving image was originally stopped.

If 70% or more of the area of the transparent region 241a is not superimposed on the first partial advertisement image 242b (A31: No), the terminal 20 determines whether or not 70% or more of the area of the transparent region 241a is superimposed on the second partial advertisement image 242b (A35).

When 70% or more of the area of the transparent region 241a is superimposed on the second partial advertisement image 242b (A35: Yes), the terminal 20 starts playback of the second partial advertisement image 242b that is a partial moving image and stops playback of the first partial advertisement image 242b that is a partial moving image (A37). Note that the terminal 20 does nothing with respect to the first partial advertisement image 242b if playback of the first partial advertisement image 242b that is a partial moving image is originally stopped.

If 70% or more of the area of the transparent region 241a is not superimposed on the second partial advertisement image 242b (A35: No), the processing is advanced to A13.

Note that in the processing of A31 and A35, an example was shown in which it is determined whether or not a predetermined percentage or more of the area of the transparent region 241a is superimposed on the first partial advertisement image 242b or the second partial advertisement image 242b, but there is no limitation to such a configuration, and it may be determined whether or not a predetermined percentage or more of the vertical width of the transparent region 241a is superimposed on the first partial advertisement image 242b or the second partial advertisement image 242b.

Alternatively or additionally, in the processing of A31 and A35, an example was shown in which it is determined whether or not a predetermined percentage or more of the area of the transparent region 241a is superimposed on the first partial advertisement image 242b or the second partial advertisement image 242b, but there is no limitation to such a configuration, and it may be determined whether or not the transparent region 241a and at least a portion of the first partial advertisement image 242b or at least a portion of the second partial advertisement image 242b are superimposed on each other.

If the transparent region 241a is not superimposed on the second partial advertisement image 242b but is superimposed on a portion or the entirety of the first partial advertisement image 242b, the terminal 20 plays back only the first partial advertisement image 242b that is a partial moving image, for example, without limitation thereto. Alternatively or additionally, if the transparent region 241a is not superimposed on the first partial advertisement image 242b but is superimposed on a portion or the entirety of the second partial advertisement image 242b, the terminal 20 plays back only the second partial advertisement image 242b that is a partial moving image. Alternatively or additionally, if the transparent region 241a overlaps with a portion of the first partial advertisement image 242b and a portion of the second partial advertisement image 242b, the terminal 20 plays back both the first partial advertisement image 242b that is a partial moving image and the second partial advertisement image 242b that is a partial moving image.

Effects of Twelfth Variation (2)

In this modification, a configuration is shown in which control of playback of the first partial advertisement image 242b that is a partial moving image is executed based on the positional relationship between the transparent region 241a and the first partial advertisement image 242b that is a partial moving image (a non-limiting example of a first partial moving image) on the page display region (a non-limiting example of a display region).

As an example of the effect obtained by such a configuration, control of playback of the first partial moving image can be linked to the relative position of the transparent region with respect to the first partial moving image, for example, without limitation thereto.

In this variation, a configuration is shown in which control of playback of the first partial advertisement image 242b that is a partial moving image is executed based on the transparent region 241a being superimposed on at least a portion of the first partial advertisement image 242b that is a partial moving image.

As an example of the effect obtained by such a configuration, it is possible to execute start of playback, stopping of playback, or the like of the first partial moving image in a linked manner with the visibility via the transparent region.

In this variation, a configuration is shown in which control of playback of the first partial advertisement image 242b that is a partial moving image is controlled based on the size by which the transparent region 241a is superimposed on the first partial advertisement image 242b.

As an example of the effect obtained by such a configuration, it is possible to execute start of playback, stopping of playback, or the like of the first partial moving image in a state where the transparent region and the first partial moving image are superimposed on each other with a size sufficient for viewing.

In this variation, a configuration is shown in which the second partial advertisement image 242b (a non-limiting example of a second moving image) that is a partial moving image, which is a partial region of the second whole advertisement image 242a (a non-limiting example of a second moving image) that is a second moving image, is displayed in at least the page display region, and control of playback of the second partial advertisement image 242b that is a partial moving image is executed based on the transparent region 241a.

As an example of the effect obtained by such a configuration, since control of playback of the second partial moving image can be linked to the first input via the movement of the transparent region, start of playback, stopping of playback, or the like of the second partial moving image can be executed at a suitable timing according to the first input.

In this variation, a configuration is shown in which the display region of the display 24 is a vertically elongated region with a vertical direction that is longer than its horizontal direction, the first whole advertisement image 242a based on the whole advertisement data has a first side in a vertical direction and a second side in a horizontal direction that is shorter than the first side, and the first partial advertisement image 242b has a third side in the vertical direction and a fourth side in the horizontal direction that is longer than the third side, and the first partial advertisement image 242b that is a partial moving image is displayed in the page display region with the third side arranged along the longitudinal direction of the page display region and the fourth side arranged along the lateral direction of the page display region.

As an example of the effect obtained by such a configuration, by making the first partial moving image a horizontally elongated moving image with the third side that is shorter than the fourth side, the display region of the content information can be prevented from being excessively restricted by an advertisement or the like. As a result, it is possible to prevent the user from feeling uncomfortable with the advertisement or the like.

In this variation, a configuration is shown in which control of playback of the first partial advertisement image 242b that is a partial moving image is executed based on the transparent region 241a being superimposed on at least a portion of the first partial advertisement image 242b that is a partial moving image, control of playback of the second partial advertisement image 242b that is a partial moving image is executed based on the transparent region 241a being superimposed on at least a portion of the second partial advertisement image 242b that is a partial moving image, and control for stopping playback of the first partial advertisement image 242b that is a partial moving image is executed by the controller 21 based on the transparent region 241a being superimposed on at least a portion of the second partial advertisement image 242b that is a partial moving image.

As an example of the effect obtained by such a configuration, the first partial moving image or the second partial moving image in a state where the visibility via the transparent region is favorable can be played back, whereas playback of the first partial moving image or the second partial moving image in a state where the visibility via the transparent region is not favorable can be stopped.

### Thirteenth Embodiment

The thirteenth embodiment is an embodiment in which the whole advertisement image 242a corresponding to the partial advertisement image 242b is made visible based on the second input performed by the user on the partial advertisement image 242b, for example, without limitation thereto. The display control of the thirteenth embodiment is executed after the execution of the superimposed display processing (A4) shown in FIG. 58, for example, without limitation thereto.

The thirteenth embodiment corresponds to the eleventh embodiment, but differs in that, in the terminal 20, the data of the whole advertisement image corresponding to the partial advertisement image is acquired from the server 10 based on the second input performed on the partial advertisement image, and control for making the whole advertisement image visible is executed. The thirteenth embodiment differs from the eleventh embodiment in that, at the time when the data of the partial advertisement image is acquired from the server 10 and displayed, the terminal 20 does not have the data of the whole advertisement image, and in order to make the whole advertisement image visible, the data of the whole advertisement image is separately acquired from the server 10.

The features described in the thirteenth embodiment can also be applied and/or combined with to other embodiments and variations.

The same constituent elements as those already mentioned are denoted by the same reference numerals, and redundant description thereof is omitted.

Display Screen Example

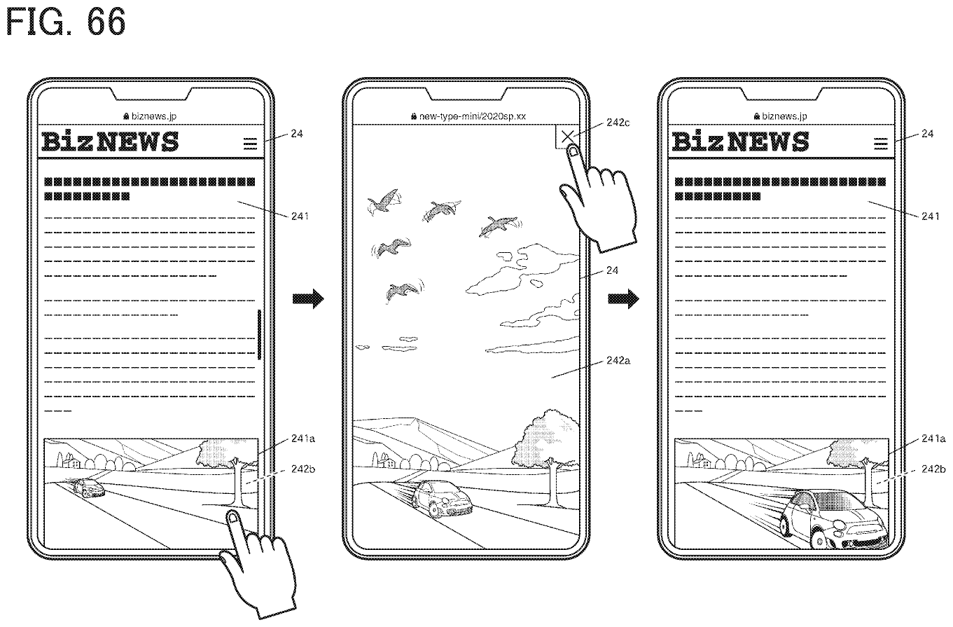

On the display screen shown in FIG. 66, the partial advertisement image 242b that is a partial moving image is played back due to a scroll operation (A5 to A13) being performed after the superimposed display processing (A4) of FIG. 58 is executed (A12). For this reason, a partial moving image in which an automobile in the partial advertisement image 242b travels forward on a road is visible via the transparent region 241a.

In this state, the whole advertisement image 242a that is a moving image corresponding to the partial advertisement image 242b becomes visible due to the user performing a touch operation (a non-limiting example of the second input) on the partial advertisement image 242b (a non-limiting example of the first partial moving image) that is a visible partial moving image, on the touch panel. The whole advertisement image 242a that is a moving image is a moving image of a vertically elongated advertisement displayed in the entire page display region. When switching from the partial advertisement image 242b that is a partial moving image to the whole advertisement image 242a that is a moving image, playback of the moving image is continued.

The whole advertisement image 242a that is a moving image is a moving image that includes the entire region of the partial advertisement image 242b that is a partial moving image and includes the region not included in the partial advertisement image 242b. In this example, the information included in the partial advertisement image 242b that is a partial moving image is an automobile traveling on a road with a mountain or the like in the background. In contrast to this, the information included in the whole advertisement image 242a that is a moving image is such that the background of the partial advertisement image 242b that is a partial moving image is enlarged at the upper portion, and the sky and five birds flying in the sky are included in the enlarged background.

That is, in this example, the partial advertisement image 242b is a partial moving image formed by trimming the lower side of the whole advertisement image 242a that is a moving image.

Processing

The terminal 20 switches from display of the partial advertisement image 242b that is a partial moving image to display of the whole advertisement image 242a that is a moving image by executing the processing of the flowchart shown in FIG. 21, for example, without limitation thereto.

In this example, when the terminal 20 receives the whole advertisement data from the server 10, the whole advertisement image 242a that is a moving image based on the whole advertisement data is arranged in the first layer, and the entirety of the web page 241 arranged in the second layer is set to the transparent region 241a (A25).

In this case, the terminal 20 measures the elapsed time from the start of playback of the partial advertisement image 242b that is a partial moving image, and saves the elapsed time at the timing when the touch operation on the partial advertisement image 242b is performed. Then, the whole advertisement image 242a that is a moving image based on the whole advertisement data is arranged in the first layer, moving-image playback of the whole advertisement image 242a is started from the timing corresponding to the saved elapsed time.

As a result, the entirety of the whole advertisement image 242a arranged in the first layer can be viewed by the user.

### Effects of Thirteenth Embodiment

The thirteenth embodiment shows a configuration in which the controller 21 executes control for making the whole advertisement image 242a that is a moving image visible to the user of the terminal 20 based on the second input performed by the user of the terminal 20 on the partial advertisement image 242b that is a partial moving image.

As an example of the effect obtained by such a configuration, a user who is interested in the first partial moving image can be guided to the first moving image based on the second input performed on the first partial moving image, for example, without limitation thereto.

The thirteenth embodiment shows a configuration in which the entire region of the second layer in which the main content information is arranged is set as a transparent region based on the second input performed by the user of the terminal 20 on the partial advertisement image 242b that is a partial moving image.

As an example of the effect obtained by such a configuration, the first moving image can be made visible without changing the layer in which the first moving image is arranged to the second layer, which is higher than the first layer, for example, without limitation thereto.

The thirteenth embodiment shows a configuration in which the second input performed by the user on the partial advertisement image 242b that is a partial moving image is an operation of touching the partial advertisement image 242b that is a partial moving image.

As an example of the effect obtained by such a configuration, if the user is interested in the first partial moving image, the first moving image can be made visible based on input performed through an operation of touching the first partial moving image by the user of the terminal, for example, without limitation thereto.

Thirteenth Variation (1)

In the thirteenth embodiment, the entirety of the whole advertisement image 242a that is a moving image was made visible by setting the entire region of the web page 241 arranged in the second layer as the transparent region 241a in the state where the whole advertisement image 242a that is a moving image is arranged in the first layer, but there is no limitation to such a configuration. The whole advertisement image 242a that is a moving image may be arranged in the second layer and the web page including the transparent region 241a may be arranged in the first layer based on the user touching the partial advertisement image 242b that is a partial moving image.

That is, the entirety of the advertisement information may be made visible due to a layer change in which the advertisement information arranged in the first layer and the main content information arranged in the second layer are swapped being performed based on the second input performed by the user, and the advertisement information being arranged in a layer higher than that of the main content information as a result.

As an example of the effect obtained by such a configuration, the first moving image can be made visible without changing the transparent region.

Thirteenth Variation (2)

In the thirteenth embodiment, the web page 241 arranged in the second layer may become visible again based on the elapse of a predetermined period (predetermined amount of time) after the processing of A25 is executed and the whole advertisement image 242a of the moving image becomes visible, or based on the user executing an operation for making the main content information visible again.

Due to the user touching the erase icon 242c indicated by “x” displayed in the upper right portion of the whole advertisement image 242a that is a moving image shown in FIG. 66, the transparent region setting in the second layer is removed and the web page 241 in the second layer becomes visible again, for example, without limitation thereto. At this time, the web page 241 in the second layer is superimposed on the whole advertisement image 242a in the first layer, and a portion of the whole advertisement image 242a that is a moving image, that is, the partial advertisement image 242b that is a partial moving image is visible via the transparent region 241a. When switching from the whole advertisement image 242a that is a moving image to the partial advertisement image 242b that is a partial moving image, playback of the moving image is continued. For this reason, the automobile in the partial advertisement image 242b that is a partial moving image travels further forward on the road.

Note that regarding the thirteenth variation (1) as well, the web page 241 arranged in the first layer may become temporarily visible due to being arranged in the second layer again based on the elapse of a predetermined period (predetermined amount of time) after the whole advertisement image 242a that is a moving image becomes visible, or based on the user executing an operation for making the main content information visible again.

If the user touches the erase icon 242c indicated by “x” displayed in the upper right portion of the whole advertisement image 242a that is a moving image shown in FIG. 66, a layer change in which the main content information arranged in the first layer and the advertisement information arranged in the second layer are swapped is executed, and as a result, the main content information is arranged in a layer above that of the advertisement information again, whereby the main content information may become visible, for example, without limitation thereto. At this time, the web page 241 of the second layer is superimposed on the whole advertisement image 242a that is moving image in the first layer, and a portion of the whole advertisement image 242a that is a moving image, that is, the partial advertisement image 242b that is a partial moving image is visible via the transparent region 241a.

Each of the above-described variations shows a configuration in which the whole advertisement image 242a that is a moving image is displayed in the page display region, and the web page 241 (a non-limiting example of content) superimposed on at least a portion of the whole advertisement image 242a that is a moving image is displayed in the page display region.

As an example of the effect obtained by such a configuration, the user can browse the content again even after the first moving image is displayed in the entire display region.

Thirteenth Variation (3)

In the example shown in FIG. 66, after playback of the partial advertisement image 242b that is a partial moving image is started (A12), the whole advertisement image 242a that is a moving image is displayed based on a touch operation performed on the partial advertisement image 242b, but there is no limitation to such a mode, and playback of the whole advertisement image 242a that is a moving image may be started based on a touch operation performed on the partial advertisement image 242b that is a still image before playback of the partial advertisement image 242b that is a partial moving image is started.

The whole advertisement image 242a may be displayed based on a touch operation performed on a portion of the partial advertisement image 242b that is a still image that is visible via the transparent region 241a with the web page 241 in the initial position, and playback of the whole advertisement image 242a of the moving image may be started, for example, without limitation thereto.

As an example of the effect obtained by such a configuration, if the user is interested in the advertisement before seeing the region of interest, the first moving image can be displayed at that stage.

Thirteenth Variation (4)

In the thirteenth embodiment, due to the user performing a touch operation (an example of second input) on the partial advertisement image 242b that is a partial moving image that is visible on the touch panel, display is switched from the partial advertisement image 242b that is a partial moving image to the whole advertisement image 242a that is a moving image, and at that time, playback of the moving image is continued, but there is no limitation to this.

Specifically, the moving image may optionally be played back from the beginning when the display is switched from the partial advertisement image 242b that is a partial moving image to the whole advertisement image 242a that is a moving image, for example, without limitation thereto.

In this case, when the terminal 20 receives the whole advertisement data from the server 10, the whole advertisement image 242a that is a moving image based on the whole advertisement data is arranged in the first layer, and the entirety of the web page 241 arranged in the second layer is set to the transparent region 241a. In this case, the terminal 20 plays back the whole advertisement image 242a that is a moving image from the beginning based on the whole advertisement data received from the server 10.

### Fourteenth Embodiment

The fourteenth embodiment is an embodiment relating to the setting of the partial advertisement image 242b and the transparent region 241a, and to the setting of the playback start condition of the partial advertisement image 242b, for example, without limitation thereto.

In the fourteenth embodiment, a method of setting the playback start condition of the partial advertisement image 242b based on the relationship between the page display region, the partial advertisement image 242b, and the transparent region 241a (non-limiting examples of which include the relationship between the vertical widths thereof) is illustrated, for example, without limitation thereto.

The features described in the fourteenth embodiment can also be applied and/or combined with to other embodiments and variations.

The same constituent elements as those already mentioned are denoted by the same reference numerals, and redundant description thereof is omitted.

Functional Configuration

(1) Functional Configuration of Server

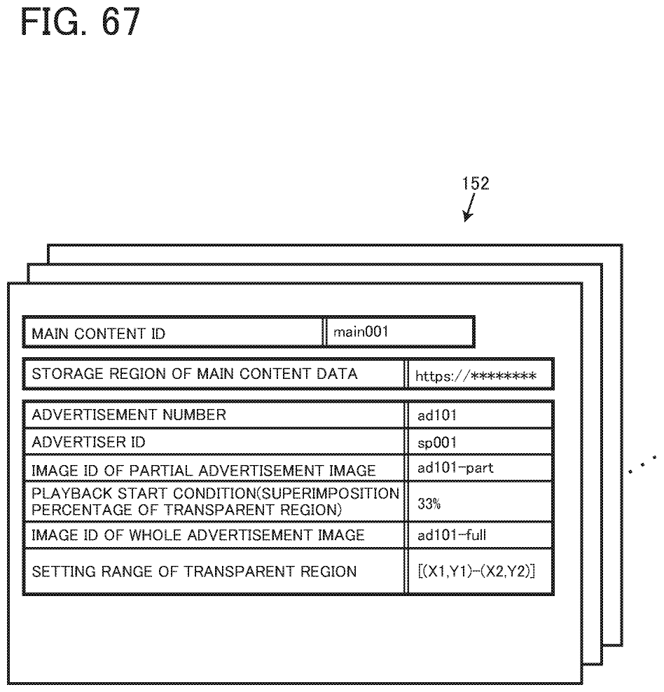

In the main content database 152 shown in FIG. 67, the main content ID, the storage region of the main content data, the advertisement number, the advertiser ID, the image ID for identifying the partial advertisement image relating to the advertisement with the advertisement number, the playback start condition (in this example, the superimposition percentage of the transparent region with respect to the partial advertisement image) of the partial advertisement image (partial moving image), the image ID for identifying the whole advertisement image relating to the advertisement with the advertisement number, and the setting range of the transparent region are stored in association with each other, for example, without limitation thereto.

In this example, the above-described case where the playback start condition is that a predetermined percentage of the transparent region is superimposed on the partial advertisement image is illustrated, and the superimposition percentage corresponding to the predetermined percentage is stored in the playback start condition column.

If the playback start condition (superimposition percentage) is 33%, when 33% of the vertical width of the transparent region is superimposed on the partial advertisement image, playback of the partial moving image of the partial advertisement image is started, for example, without limitation thereto.

(2) Setting of Partial Advertisement Image by Advertiser

As described above, the advertiser can set which region of the whole advertisement image the partial advertisement image is to be, as appropriate. Alternatively or additionally, in this case, the advertiser can set the partial advertisement image by operating the above-described setting device, for example, without limitation thereto.

In this embodiment, a case where the partial advertisement image is arranged on the lower side of the page display region of the terminal 20 by default is illustrated.

Alternatively or additionally, in this embodiment, a case where a partial advertisement image having a vertical width that is about ⅓ of the vertical width of the page display region is set is illustrated.

The setting device transmits a registration request including the data of the whole advertisement image and the data of the partial advertisement image to the server 10 based on the operation performed by the advertiser.

When the server 10 receives the registration request from the setting device through the communication I/F 14, the server 10 stores the data of the whole advertisement image and the data of the partial advertisement image included in the received registration request in the whole advertisement database 153a (see FIG. 16) and the partial advertisement database 153b (see FIG. 17), respectively.

Alternatively or additionally, the server 10 specifies the advertiser ID from the unique address of the setting device that is the transmission source, assigns a unique advertisement number, and stores the advertisement number, the advertiser ID, the image ID of the partial advertisement image, and the image ID of the whole partial advertisement image in association with the main content ID in the main content database 152, for example, without limitation thereto.

(3) Setting of Transparent Region by Server

When the partial advertisement image is set, the controller 11 of the server 10 sets the transparent region based on the vertical width of the page display region, for example, without limitation thereto.

In this example, the server 10 sets a transparent region 241a of a fixed size based on the initial setting. Specifically, the server 10 sets about ⅔ of the vertical width of the page display region of the terminal 20 as the vertical width of the transparent region, and set a horizontal width that is substantially the same as the horizontal width of the page display region as the horizontal width of the transparent region, for example, without limitation thereto.

Alternatively or additionally, the server 10 determines the position of the transparent region. Specifically, the server 10 determines the position of the transparent region in the main content information such that the vertical width from the top portion of the web page to the transparent region is larger than the vertical width of the page display region in a state where the web page is in the initial position, for example, without limitation thereto. That is, although the user cannot view the partial advertisement image in the state where the web page is in the initial position, the user can view the partial advertisement image by moving the web page upward through the scroll operation. The server 10 stores the determined position of the transparent region in association with the main content ID in the main content database 152.

(4) Setting of Playback Start Condition by Server

When the transparent region is set, the controller 11 of the server 10 sets the playback start condition of the partial moving image based on the vertical width of the transparent region.

In this example, the vertical width of the transparent region is as large as about ⅔ of the page display region of the terminal 20, and therefore the server 10 sets the playback start condition such that playback of the partial moving image of the partial advertisement image is started when a predetermined percentage (non-limiting examples of which include 33%) of the vertical width of the transparent region is superimposed on the partial advertisement image. The server 10 stores the set playback start condition in association with the main content ID in the main content database 152.

That is, when a transparent region having a vertical width that is 33% of the vertical width of the transparent region appears from the lower side of the page display region of the terminal 20, playback of the partial moving image of the partial advertisement image superimposed on the transparent region is started. At this time, since approximately ⅔ of the vertical width of the partial advertisement image is visible via the transparent region, playback of the partial moving image can be started at the timing when the region to which the attention of the user is to be drawn becomes visible.

Although an example was shown in which the playback start condition of the partial moving image is set by the server 10, there is no limitation to such a mode. The playback start condition of the partial moving image may be set by a user such as an advertiser.

Effects of Fourteenth Embodiment

The fourteenth embodiment shows a configuration in which the advertiser requests transmission of the advertisement content data (non-limiting examples of which include the whole advertisement data including the whole advertisement image) to the terminal 20 of the user, and the partial advertisement image that is a partial moving image is set by the advertiser.

As an example of the effect obtained by such a configuration, the region of the first moving image that the business operator (non-limiting examples of which include the advertiser) wants to draw the attention of the user to can be set as the region of the first partial moving image.

Fourteenth Variation (1)

In the fourteenth embodiment, an example was shown in which the vertical width of the transparent region is large (approximately ⅔ of the vertical width of the page display region of the terminal 20), but there is no limitation to such a mode. The vertical width of the transparent region may be small.

In this variation, the setting of the vertical width and the horizontal width of the transparent region can be changed by an operator of the server, the advertiser, or the like.

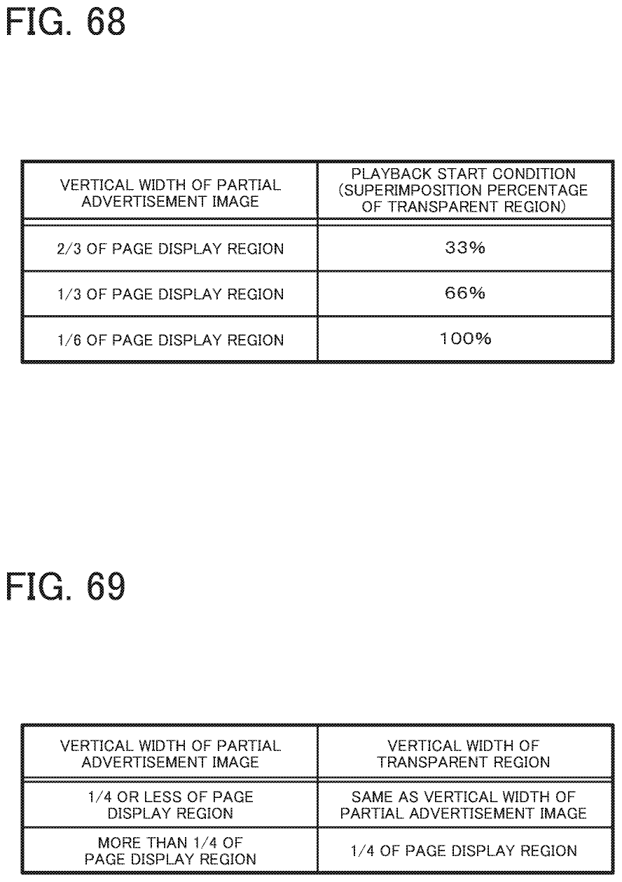

FIG. 68 is a diagram showing an example of a table for setting the playback start condition.

In this table, the vertical width of the transparent region and the playback start condition (superimposition percentage of the transparent region with respect to the partial advertisement image) are defined in association with each other.

As the vertical width of the transparent region based on the percentage with respect to the vertical width of the page display region, three vertical widths of the transparent region are defined, namely “⅔ of the page display region”, “⅓ of the page display region”, and “⅙ of the page display region”, for example, without limitation thereto.

“33%” is defined as the playback start condition in “⅔ of the page display region”. This is the same condition as in the above-described embodiment.

“66%” is defined as the playback start condition in “⅓ of the page display region”. This is a condition indicating that when 66% of the vertical width of the transparent region is superimposed on the partial advertisement image, playback of the partial moving image of the partial advertisement image is started.

“100%” is defined as the playback start condition in “⅙ of the page display region”. This is a condition indicating that when the entire vertical width (100%) of the transparent region is superimposed on the partial advertisement image, playback of the partial moving image of the partial advertisement image is started.

In this manner, the relationship between the vertical width of the transparent region and the playback start condition is defined such that the smaller the vertical width of the transparent region is (the smaller the percentage with respect to the vertical width of the page display region is), the higher the superimposition percentage required for playback of the partial moving image (i.e., the stricter the playback condition is).

The server 10 sets the vertical width of the transparent region based on the percentage with respect to the vertical width of the page display region, for example, without limitation thereto. Alternatively or additionally, a horizontal width that is substantially the same as the horizontal width of the page display region is set as the horizontal width of the transparent region, for example, without limitation thereto.

Then, the server 10 sets the playback start condition according to the above-described table based on the set vertical width of the transparent region, for example, without limitation thereto. Then, the server 10 stores the set playback start condition in association with the main content ID in the main content database 152.

If the vertical width of the transparent region is set to “1/6 of the page display region” in the above-described table, the vertical width of the transparent region is as small as about ⅙ of the page display region of the terminal 20, and therefore the playback start condition is set such that when the entire vertical width of the transparent region, that is, 100% of the vertical width is superimposed on the partial advertisement image, playback of the partial moving image of the partial advertisement image is started, for example, without limitation thereto.

That is, when all of the transparent region appears from the lower side of the page display region of the terminal 20, playback of the partial moving image of the partial advertisement image superimposed on the transparent region is started. At this time, since approximately ½ of the partial advertisement image is visible via the transparent region, it is possible to start playback of the partial moving image at the timing when the region to which the attention of the user is to be drawn becomes visible.

Although an example was shown in which the playback start condition of the partial moving image is defined by the ratio between of the vertical width of the transparent region superimposed on the partial advertisement image and the vertical width of the transparent region, there is no limitation to such a mode. The playback start condition of the partial moving image may be defined by the ratio between the area of the transparent region superimposed on the partial advertisement image and the area of the entire transparent region.

This variation shows a configuration in which control of playback of the partial moving image of the partial advertisement image 242b is changed based on the size of the transparent region 241a or the length of a side of the transparent region 241a.

As an example of the effect obtained by such a configuration, the timing of the playback control of the first partial moving image can be changed according to the size of the transparent region or the length of a side of the transparent region. It is possible to prevent the start of playback of the first partial moving image from being delayed due to the size of the length of a side of the transparent region being large, or to prevent the start of playback of the first partial moving image from being too early due to the size or the length of a side of the transparent region being small, for example, without limitation thereto.

Fourteenth Variation (2)

In the fourteenth embodiment, an example was shown in which a transparent region of a fixed size is set regardless of the size of the partial advertisement image, but there is no limitation to such a mode. The size of the transparent region may be changeable based on the length of a side or the size of the partial advertisement image.

FIG. 69 is a diagram showing an example of a table for setting the vertical width of the transparent region.

In this table, the vertical width of the partial advertisement image and the vertical width of the transparent region are defined in association with each other.

The vertical width of the partial advertisement image includes “¼ or less of the page display region” and “more than ¼ of the page display region”.

In “¼ or less of the page display region”, “the same as the vertical width of the partial advertisement image” is defined as the vertical width of the transparent region. This indicates that if the vertical width of the partial advertisement image is a length that is ¼ or less of the page display region, a length that is the same as the vertical width of the partial advertisement image is set as the vertical width of the transparent region.

In “more than ¼ of the page display region”, “¼ of the page display region” is defined as the vertical width of the transparent region. This indicates that if the vertical width of the partial advertisement image is a length that is more than ¼ of the page display region, a length that is ¼ of the page display region is set as the vertical width of the transparent region.

This is because if the vertical width of the transparent region exceeds about ¼ of the page display region for example, without limitation thereto, the transparent region will be too large, and thereby there is a likelihood that the information that the user wants to browse, such as a news article, will be hindered. In view of this, in this example, the vertical width of the transparent region is set based on the vertical width of the partial advertisement image such that the upper limit of the vertical width of the transparent region is ¼ of the page display region.

Note that in this case, a horizontal width that is substantially the same as the horizontal width of the page display region (non-limiting examples of which include 90% to 100% of the horizontal width of the page display region) can be set as the horizontal width of the transparent region, for example, without limitation thereto.

In this case, if the server 10 sets a vertical width that is the same as the vertical width of the partial advertisement image as the vertical width of the transparent region, the server 10 sets the playback start condition such that playback of the partial moving image of the partial advertisement image is started when a first predetermined percentage (non-limiting examples of which include 70%) of the vertical width of the transparent region is superimposed on the partial advertisement image, for example, without limitation thereto. The server 10 stores the set playback start condition in association with the main content ID in the main content database 152.

That is, when the transparent region having a vertical width that is 70% of the vertical width of the transparent region appears from the lower side of the page display region of the terminal 20, playback of the partial moving image of the partial advertisement image superimposed on the transparent region is started. At this time, since approximately 70% of the vertical width of the partial advertisement image is visible via the transparent region, playback of the partial moving image can be started at the timing when the region to which the attention of the user is to be drawn becomes visible.

Alternatively or additionally, if the server 10 has set a length that is ¼ of the page display region as the vertical width of the transparent region, the vertical width of the partial advertisement image is longer than the vertical width of the transparent region, and therefore the server 10 sets the playback start condition such that playback of the partial moving image of the partial advertisement image is started when a second predetermined percentage (non-limiting examples of which include 100%) that is larger than the first predetermined percentage of the vertical width of the transparent region is superimposed on the partial advertisement image, for example, without limitation thereto. Then, the server 10 stores the set playback start condition in association with the main content ID in the main content database 152.

Note that instead of changing the vertical width of the transparent region according to the vertical width of the partial advertisement image as described above, a vertical width that is approximately the same as the vertical width of the partial advertisement image (non-limiting examples of which include 90% to 110% of the vertical width of the partial advertisement image) may optionally be set as the vertical width of the transparent region.

Alternatively or additionally, in this case, the transparent region may optionally be set to an area that is substantially the same as the area of the partial advertisement image.

In this variation, a configuration is shown in which the size of the transparent region 241a or the length of a side of the transparent region 241a is determined based on the partial advertisement image 242b of the partial moving image.

As an example of the effect obtained by such a configuration, since a transparent region having a size or a length of a side corresponding to the first partial moving image can be set, playback of the first partial moving image can be controlled at an appropriate timing.

### Fifteenth Embodiment

The fifteenth embodiment is an embodiment in which the relative positions of the main content and the partial advertisement image is always fixed.

The fifteenth embodiment differs from the first to fourteenth embodiments in that the transparent region is not formed in the main content information, and the main content information and the advertisement content information are arranged and displayed in the same layer.

The features described in the fifteenth embodiment can also be applied and/or combined with to other embodiments and variations.

The same constituent elements as those already mentioned are denoted by the same reference numerals, and redundant description thereof is omitted.

Display Screen Example

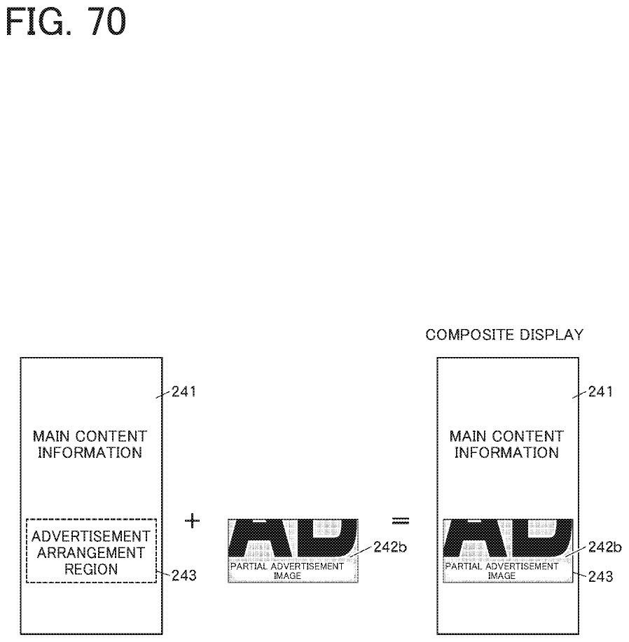

FIG. 70 is an illustrative diagram showing the relationship between the main content information and the partial advertisement image arranged in the layer in this example.

In the present embodiment, an advertisement arrangement region 243 in which the advertisement content information (non-limiting examples of which include an advertisement image) is arranged is set in the main content data distributed from the server 10. As a result, based on the terminal 20 receiving the main content data, the main content information based on the main content data and the advertisement content information based on the advertisement content data distributed in association with the main content data are arranged in a common layer (a single layer).

Documents and images respectively based on document data and image data included in the main content data are not arranged in the advertisement arrangement region 243. That is, in the state where the main content information is displayed in the page display region, the main content information is displayed in the region of the page display region where the page display region and the advertisement arrangement region 243 do not overlap, and is not displayed in the region of the page display region where the page display region and the advertisement arrangement region 243 overlap.

In this embodiment, description will be given assuming that, the partial advertisement image 242b that is a moving image (a non-limiting example of first information that is a portion of first content information) is arranged as the advertisement content information based on the advertisement content data in the advertisement arrangement region 243, and the advertisement arrangement region 243 has the same size as the partial advertisement image 242b, for example, without limitation thereto.

In the page display region of the terminal 20, since the main content information and the partial advertisement image do not overlap, the user can preferably view both the main content information and the partial advertisement image.

Note that the size of the advertisement arrangement region does not necessarily need to be the same size as the partial advertisement image, and the size of the advertisement arrangement region may be larger than the size of the partial advertisement image.

It is not always necessary to arrange the partial advertisement image in the advertisement arrangement region, and the image of the region of interest may optionally be arranged in the advertisement arrangement region 243, for example, without limitation thereto.

The partial advertisement image (partial moving image) arranged in the advertisement arrangement region is played back based on satisfaction of the playback start condition. As a non-limiting example, the playback start condition can be

(C-1) That a predetermined percentage of the partial advertisement image (vertical width of the partial advertisement image) is displayed in the page display region.

Note that, as described above, the image in the region of interest can be a partial advertisement image, and the image in the region of interest can be arranged in the advertisement arrangement region, for example, without limitation thereto. In this case, the above-described playback start condition is

(C-2) That a predetermined percentage of the region of interest (vertical width of the region of interest) is displayed in the page display region.

The above-described predetermined percentage can be set as appropriate, and can be set as a value that is about 30% to 70%, for example, without limitation thereto. Here, it should be noted that the above-described predetermined percentage is not a percentage with respect to the vertical width of the whole advertisement image, but a percentage with respect to the vertical width of the partial advertisement image (or the region of interest).

A case where the partial advertisement image is arranged in the advertisement arrangement region will be described as an example.

The partial advertisement image is an image generated by trimming a portion of the whole advertisement image. If the predetermined percentage is 50%, moving-image playback of the partial advertisement image is started when 50% of the partial advertisement image is displayed in the page display region, but moving-image playback of the partial advertisement image is not necessarily started when 50% of the whole advertisement image is displayed in the page display region, for example, without limitation thereto.

In a state where the vertical width of the web page is larger than the vertical width of the page display region and the web page is in the initial position, the partial advertisement image is not displayed in the page display region, and it is assumed that the partial advertisement image appears in the page display region by scrolling the web page in the upward direction, for example, without limitation thereto.

In this case, if the region of the lower half of the whole advertisement image corresponding to the partial advertisement image is set as the partial advertisement image, 50% of the partial advertisement image being displayed in the page display region is equivalent to 75% of the whole advertisement image being displayed in the page display region, for example, without limitation thereto.

This also applies to the case where the image of the region of interest is arranged in the advertisement arrangement region.

Note that a case is envisioned in which the web page is scrolled in a horizontal direction, and it may optionally be determined whether or not the above-described playback start condition was satisfied based on the horizontal width of the partial advertisement image (or region of interest), for example, without limitation thereto.

Alternatively or additionally, playback of the partial moving image may optionally be stopped if the playback start condition is no longer satisfied after playback of the partial moving image is started.

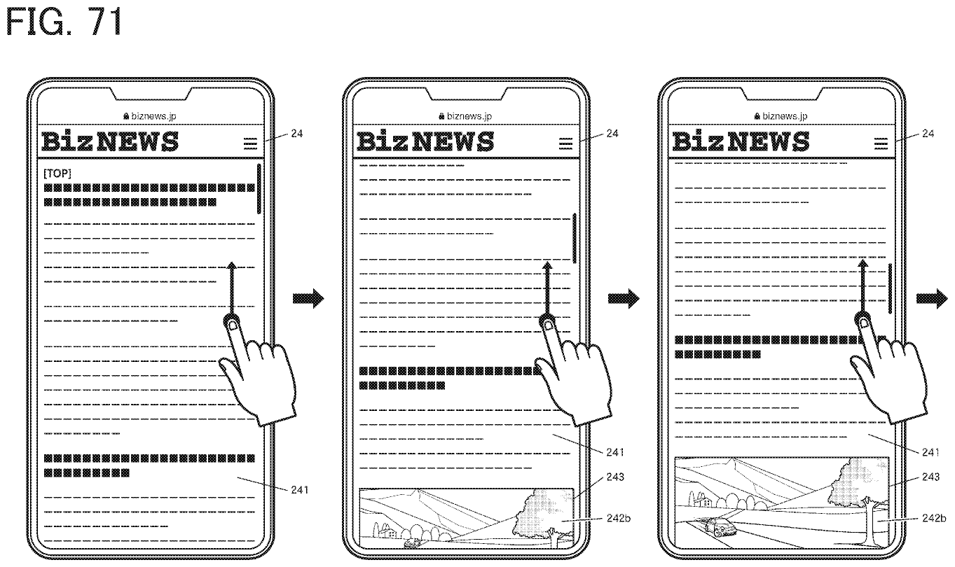

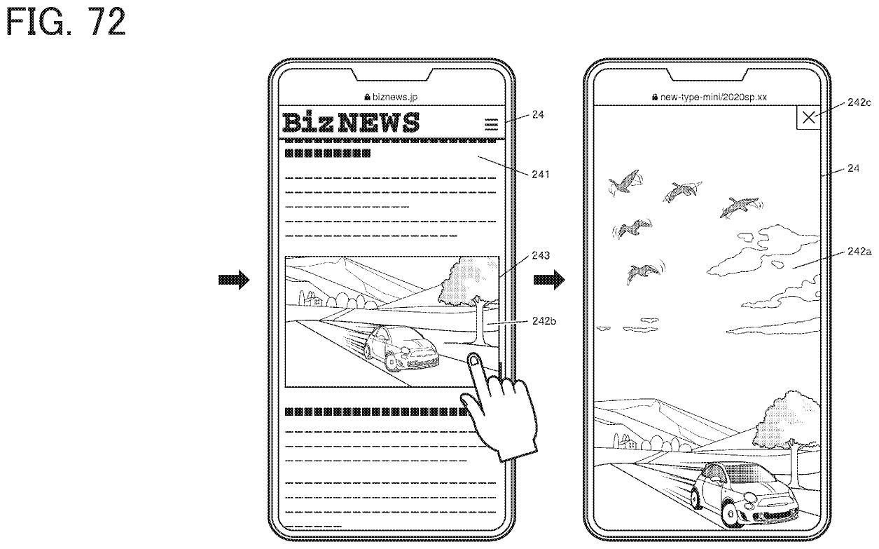

In the examples shown in FIGS. 71 and 72, the web page 241 of the business news site serving as the main content information based on the main content data, and the partial advertisement image 242b serving as the advertisement content information based on the advertisement content data distributed in association with the main content data are arranged in the same layer. The web page 241 includes a document (a non-limiting example of text information included in the second content information) and an image (a non-limiting example of image information included in the second content information) constituting a news article.

In this example, the partial advertisement image 242b is a still image in which an automobile is displayed in an initial state, but in the state where the web page 241 is in the initial position, the partial advertisement image 242b is not displayed in the page display region of the terminal 20, and therefore the user cannot view the partial advertisement image 242b.

When a predetermined percentage (non-limiting examples of which include 70%) of the vertical width of the partial advertisement image 242b is displayed in the page display region of the terminal 20 due to a scroll operation performed by the user, the partial advertisement image 242b is a partial moving image displaying a situation in which an automobile is traveling on a road.

Note that in the examples shown in FIGS. 71 and 72, the partial advertisement image 242b is a horizontally elongated image with a horizontal width that is larger than its height.

In the example shown in FIG. 71, the vertical width of the web page 241 is larger than the vertical width of the page display region, and therefore the entirety of the web page 241 cannot fit in the page display region. Alternatively or additionally, in this example, the vertical width from the top portion [TOP] of the web page 241 to the partial advertisement image 242b is larger than the vertical width of the page display region, and therefore, in the state where the web page 241 is in the initial position, the partial advertisement image 242b is not located in the page display region. For this reason, in the state where the web page 241 is in the initial position, the user cannot view the partial advertisement image 242b at all.

If the web page 241 is in the initial position, the web page 241 scrolls in the screen upward direction due to the user touching the page display region (i.e., a region different from the partial advertisement image 242b) and performing a scroll operation of moving his or her finger in the screen upward direction. Accompanying this, the partial advertisement image 242b arranged in the advertisement arrangement region 243 also scrolls in the screen upward direction, and the upper portion of the partial advertisement image 242b appears from the lower portion of the screen. Due to the upper portion of the partial advertisement image 242b being located in the page display region, the upper portion of the partial advertisement image 242b (in this example, the portion including an automobile, a mountain in the background, and a tree in the foreground) can be viewed. The partial advertisement image 242b at this time is a still image. This still image is the first frame when the partial advertisement image 242b is reproduced as a partial moving image, for example, without limitation thereto.

Due to the user continuing to scroll further in the screen upward direction, playback of the partial advertisement image 242b that is a partial moving image in which an automobile travels forward on a road starts based on a predetermined percentage (non-limiting examples of which include 70%) of the vertical width of the partial advertisement image 242b being displayed in the page display region of the terminal 20, for example, without limitation thereto.

As shown in FIG. 72, when the user continues the scroll operation and scrolls the web page 241 in the screen upward direction, the partial advertisement image 242b moves further upward, and all of the partial advertisement image 242b is displayed in the page display region of the terminal 20. While the partial advertisement image 242b moves upward, playback of the partial moving image corresponding to the partial advertisement image 242b is continued, and the automobile in the partial advertisement image 242b travels forward on the road.

In this state, the whole advertisement image 242a that is a moving image corresponding to the partial advertisement image 242b becomes visible due to the user performing a touch operation (a non-limiting example of second input) of briefly touching the partial advertisement image 242b that is a partial moving image that is visible (a non-limiting example of the first information and the first partial moving image) once on the touch panel. The whole advertisement image 242a that is a moving image is a moving image of a vertically elongated advertisement displayed in the entire page display region. When switching from the partial advertisement image 242b that is a partial moving image to the whole advertisement image 242a that is a moving image, playback of the moving image is continued.

The whole advertisement image 242a that is a moving image is a moving image that includes the entire region of the partial advertisement image 242b that is a partial moving image and includes the region not included in the partial advertisement image 242b. In this example, the partial advertisement image 242b that is a partial moving image is an automobile traveling on a road with a mountain or the like in the background. In contrast to this, the whole advertisement image 242a that is a moving image has a background in which the background of the partial advertisement image 242b that is a partial moving image is enlarged at the upper portion, and the background includes the sky and five birds flying in the sky.

In other words, the partial advertisement image is a partial moving image formed by trimming a predetermined region of the whole advertisement image that is a moving image, or the like. That is, in this example, the partial advertisement image 242b is a partial moving image formed by trimming the lower side of the whole advertisement image 242a that is a moving image. In this example, the horizontal width of the partial advertisement image is smaller than the horizontal width of the whole advertisement image, and the vertical width of the partial advertisement image is smaller than the vertical width of the whole advertisement image.

Processing

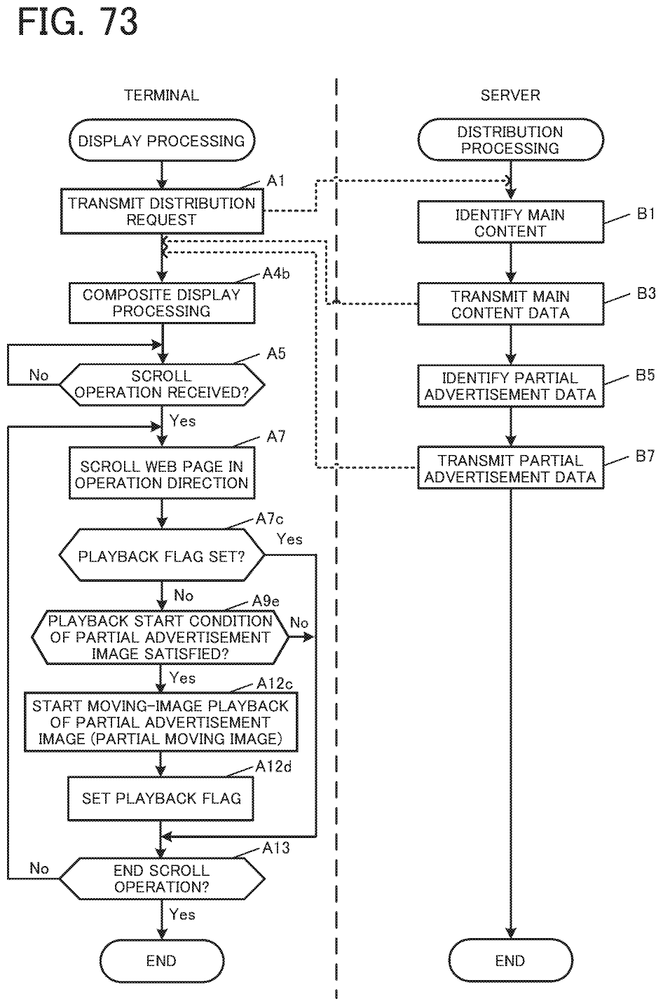

FIG. 73 is a flowchart showing an example of a flow of processing executed by each device in this embodiment.

In this diagram, the distribution processing executed by the distribution processor 111 of the server 10 and the display processing executed by the display processor 211 of the terminal 20 are shown.

The same steps as those in the flowchart described above are denoted by the same reference numerals, redundant description thereof is omitted, and description will be given focusing on steps that are different.

The flowchart described below merely illustrates the processing in this embodiment, and in the flowchart described below, some steps need not be executed, and additional steps may be inserted.

FIG. 73 is a flowchart obtained by replacing the step of superimposed display processing (non-limiting examples of which include step A4) for displaying the web page 241 superimposed on the partial advertisement image 242b of the flowchart shown in FIG. 19, with the step of composite display processing (non-limiting examples of which include step A4b) for compositing the partial advertisement image 242b on the web page 241 including the advertisement arrangement region 243, and replacing the steps of processing (non-limiting examples of which include steps A1b to A12a) for fixing the relative position of the transparent region 241a with respect to the partial advertisement image 242b if the region of interest and the transparent region 241a are superimposed on each other, with steps of processing (non-limiting examples of which include steps A7c to A12d) for starting playback of the partial advertisement image 242b that is a partial moving image if a predetermined percentage (non-limiting examples of which include 70%) of the vertical width of the partial advertisement image 242b is displayed in the page display region of the terminal 20, for example, without limitation thereto.

When the terminal 20 receives the main content data and the partial advertisement data from the server 10, the terminal 20 executes composite display processing (A4b).

Specifically, the size of the partial advertisement image 242b is acquired based on the partial advertisement data, for example, without limitation thereto. Then, the terminal 20 arranges the web page 241 in which the advertisement arrangement region 243 is formed in a layer based on the main content data. Then, the terminal 20 arranges the partial advertisement image 242b in the advertisement arrangement region 243 of the web page 241 and performs composite display of the web page 241 and the partial advertisement image 242b .

If the playback flag has not been set (A7c: No), the terminal 20 determines whether or not the playback start condition of the partial advertisement image 242b (partial moving image) arranged in the advertisement arrangement region is satisfied (A9e). Specifically, it is determined whether or not a predetermined percentage of the vertical width of the partial advertisement image is displayed in the page display region, for example, without limitation thereto.

If the playback start condition is not satisfied (A9e: No), the terminal 20 advances the processing to A13.

On the other hand, if the playback start condition is satisfied (A9e: Yes), the terminal 20 advances the processing to A12c.

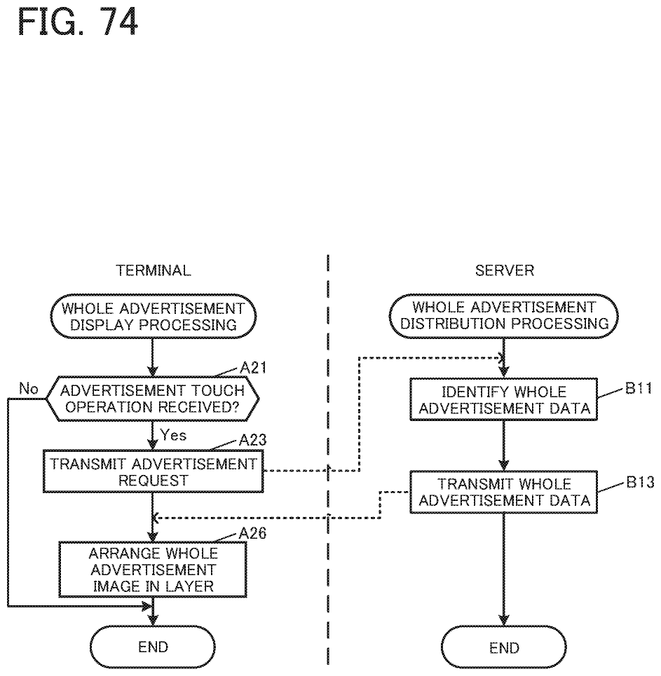

FIG. 74 is a flowchart showing an example of a flow of the whole advertisement display processing executed by the terminal 20 and the whole advertisement distribution processing executed by the server 10 in this embodiment.

FIG. 74 is a flowchart obtained by replacing the step (non-limiting examples of which include step A25) of processing for arranging the whole advertisement image 242a based on the whole advertisement data in the second layer and setting the entirety of the web page 241 arranged in the second layer as the transparent region 241a in the flowchart of FIG. 21, with the step (non-limiting examples of which include step A26) of processing for displaying the whole advertisement image 242a in the page display region of the terminal 20.

When the terminal 20 receives the whole advertisement data from the server 10, the terminal 20 arranges the whole advertisement image 242a based on the whole advertisement data in the layer in which the web page 241 and the partial advertisement image 242b are composited (A26), and ends the whole advertisement display processing.

Although an example was shown in which the whole advertisement image 242a that is a moving image is displayed in the page display region when the user performs a touch operation on the partial advertisement image 242b, there is no limitation to such a configuration, and the whole advertisement image 242a that is a still image may optionally be displayed in the page display region when the user performs a touch operation on the partial advertisement image 242b.

Alternatively or additionally, although an example was shown in which the partial advertisement image 242b that is a partial moving image is arranged in the advertisement arrangement region 243 of the web page 241, there is no limitation to such a configuration, and the partial advertisement image 242b that is a still image may be arranged in the advertisement arrangement region 243 of the web page 241. In this case, when the user performs a touch operation on the partial advertisement image 242b, the whole advertisement image 242a that is a still image or the whole advertisement image 242a that is a moving image can be displayed in the page display region, for example, without limitation thereto.

### Effects of Fifteenth Embodiment

The fifteenth embodiment shows a configuration in which the page display region of the display 24 is a vertically elongated region whose vertical direction is longer than its horizontal direction, and the whole advertisement image 242a based on the whole advertisement data (a non-limiting example of the first content information) has a first side in the vertical direction and a second side in the horizontal direction that is shorter than the first side, the partial advertisement image 242b (a non-limiting example of the first information), which is a portion of the whole advertisement image 242a, is displayed in the page display region of the terminal 20 (a non-limiting example of the display region of the terminal), the main content information (a non-limiting example of the second content information) is displayed in a region of the page display region different from that of the partial advertisement image 242b (a non-limiting example of a region), and control for moving in the page display region is executed on the partial advertisement image 242b and the main content information based on a scroll operation (a non-limiting example of first input) performed by the user on the page display region.

Then, the whole advertisement image 242a is arranged in the page display region with the first side arranged along the longitudinal direction of the page display region and the second side arranged along the lateral direction of the page display region based on a touch operation (a non-limiting example of second input) performed by the user on the partial advertisement image 242b.

As an example of the effect obtained by such a configuration, when the second content information moves the display region based on the first input, the first information that has a small size and is easily visible is moved together with the second content information, whereby it is possible to allow the user to view the first information such that the viewing of the second content information is not impeded. Then, a user who is interested in the first information and who has performed the second input on the first information, for example, without limitation thereto, can be allowed to view the vertically elongated first content information. That is, it is possible to guide the user who is interested in the first information to the vertically elongated first content information while preventing the vertically elongated first content information from suddenly being suddenly displayed in the display region and impairing the visibility of the second content information.

The fifteenth embodiment shows a configuration in which the whole advertisement image 242a is a moving image (a non-limiting example of the first moving image data) based on the whole advertisement data (a non-limiting example of the first moving image data), and the partial advertisement image 242b is a partial moving image (a non-limiting example of the first partial moving image) that is a partial region of the whole advertisement image 242a.

As an example of the effect obtained by such a configuration, by displaying the continuation of the content of the first partial moving image in the first moving image when switching from the first information to the first content information, a user who is interested in the first partial moving image can be guided to the first moving image without experiencing a feeling of strangeness.

The fifteenth embodiment shows a configuration in which control of playback of the partial advertisement image 242b that is a partial moving image is executed by the controller 21 based on at least the length of one side of the partial advertisement image 242b in the partial advertisement image 242b displayed in the page display region.

As an example of the effect obtained by such a configuration, it is possible to execute the start of playback, stopping of playback, or the like of the first partial moving image according to the visibility of the first partial moving image displayed in the display region.

The fifteenth embodiment shows a configuration in which the partial advertisement image 242b that is a partial moving image has a third side that is shorter than the first side of the whole advertisement image 242a and a fourth side that is shorter than the second side of the whole advertisement image 242a, and is displayed in the page display region with the third side arranged along the longitudinal direction of the page display region and the fourth side arranged along the lateral direction of the page display region.

As an example of the effect obtained by such a configuration, due to the first partial moving image being a horizontally elongated moving image with a third side that is shorter than its fourth side, the display region of the content information can be prevented from being excessively restricted by an advertisement or the like. As a result, it is possible to prevent the user from feeling uncomfortable with the advertisement or the like.

The fifteenth embodiment shows a configuration in which the first input is a scroll operation performed by the user, and the partial advertisement image 242b and the web page 241 are moved in a direction based on the scroll operation.

As an example of the effect obtained by such a configuration, it is possible to increase the likelihood that the user will pay attention to the first information due to the first information and the second content information moving in the direction intended by the user.

The fifteenth embodiment shows a configuration in which the second input performed by the user on the partial advertisement image 242b is an operation of touching the partial advertisement image 242b.

As an example of the effect obtained by such a configuration, if the user is interested in the first information for example, without limitation thereto, the first content information can be displayed by touching the display region.

The fifteenth embodiment shows a configuration in which the first content information is advertisement information (non-limiting examples of which include the whole advertisement image 242a), and the first information (non-limiting examples of which include the partial advertisement image 242b) is a portion thereof.

As an example of the effect obtained by such a configuration, the advertisement effect can be improved by displaying the advertisement information in the display region via the first information that moves in a linked manner with the second content information.

Although an example was shown in which playback of the partial advertisement image 242b of the partial moving image is started when a predetermined percentage of the vertical width of the partial advertisement image 242b is displayed in the page display region of the terminal 20, there is no limitation to such a configuration.

Specifically, control of playback of the partial advertisement image 242b that is a partial moving image may optionally be executed based on display of the partial advertisement image 242b that is a partial moving image based on the first input in the page display region.

The terminal 20 starts playback of the partial advertisement image 242b that is a partial moving image when the entirety of the partial advertisement image 242b appears in the page display region due to the scroll operation performed by the user, for example, without limitation thereto.

As an example of the effect obtained by such a configuration, it is possible to execute start of playback, stopping of playback, or the like of the first partial moving image in a state where viewing of the first information is preferable.

Alternatively or additionally, control of playback of the partial advertisement image 242b of the partial moving image may optionally be executed based on the size by which the partial advertisement image 242b is displayed in the page display region of the terminal 20.

The terminal 20 starts playback of the partial advertisement image 242b that is a partial moving image when a predetermined percentage of the area of the partial advertisement image 242b appears in the page display region due to the scroll operation performed by the user, for example, without limitation thereto.

As an example of the effect obtained by such a configuration, it is possible to execute start of playback, stopping of playback, or the like of the first partial moving image in a state where the first information having a sufficient size for viewing appears in the display region.

Alternatively or additionally, control of playback of the partial advertisement image 242b that is a partial moving image may optionally be executed based on a partial region of the partial advertisement image 242b being displayed in the page display region of the terminal 20.

The terminal 20 starts playback of the partial advertisement image 242b that is a partial moving image when a specific pixel or group of pixels among the pixels constituting the partial advertisement image 242b appears in the page display region due to a scroll operation performed by the user, for example, without limitation thereto.

As an example of the effect obtained by such a configuration, start of playback, stopping of playback, and the like of the first partial moving image can be executed at the timing when a partial region of the first information suitable for viewing is displayed in the display region.

Alternatively or additionally, although an example was shown in which the whole advertisement image 242a is displayed in the page display region based on a touch operation on the partial advertisement image 242b by the user of the terminal 20, there is no limitation to such a configuration. The whole advertisement image 242a may optionally be displayed in the page display region based on a pinch-out operation performed by the user of the terminal 20 on the partial advertisement image 242b. Alternatively or additionally, the whole advertisement image 242a may optionally be displayed in the page display region based on an operating of inputting a voice saying “I want to see the advertisement” performed by the user of the terminal 20.

### Sixteenth Embodiment

The sixteenth embodiment is an embodiment obtained by adding the setting of the partial advertisement image 242b and the billing processing based on the partial advertisement image 242b to the above-described embodiment.

The sixteenth embodiment corresponds to the sixth embodiment, but differs in that the main content information and the set partial advertisement image are arranged in a common layer (single layer) as described in the fifteenth embodiment.

The features described in the sixteenth embodiment can also be applied and/or combined with to other embodiments and variations.

The same constituent elements as those already mentioned are denoted by the same reference numerals, and redundant description thereof is omitted.

Functional Configuration

(1) Functional Configuration of Server

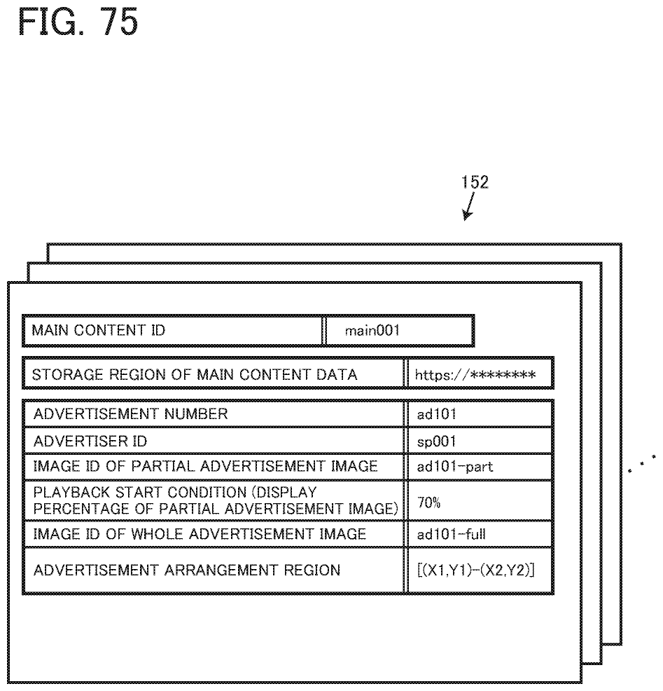

In the main content database 152 shown in FIG. 75, the main content ID, the storage region of the main content data, the advertisement number, the advertiser ID, the image ID for identifying the partial advertisement image, the playback start condition of the partial moving image, the image ID for identifying the whole advertisement image, and the setting range of the advertisement arrangement region in the main content information are stored in association with each other, for example, without limitation thereto.

In this example, the playback start condition of the partial moving image is determined by the ratio between the vertical width of the partial advertisement image displayed in the page display region and the vertical width of the partial advertisement image. Specifically, if the playback start condition of the partial moving image is 70%, playback of the partial moving image of the partial advertisement image is started when 70% of the vertical width of the partial advertisement image is displayed in the page display region.

Alternatively or additionally, the image ID of the partial advertisement image and the image ID of the whole advertisement image corresponding to the partial advertisement image include a common advertisement number. For this reason, the server 10 can identify the partial advertisement image and the whole advertisement image constituting the advertisement with the advertisement number based on the advertisement number.

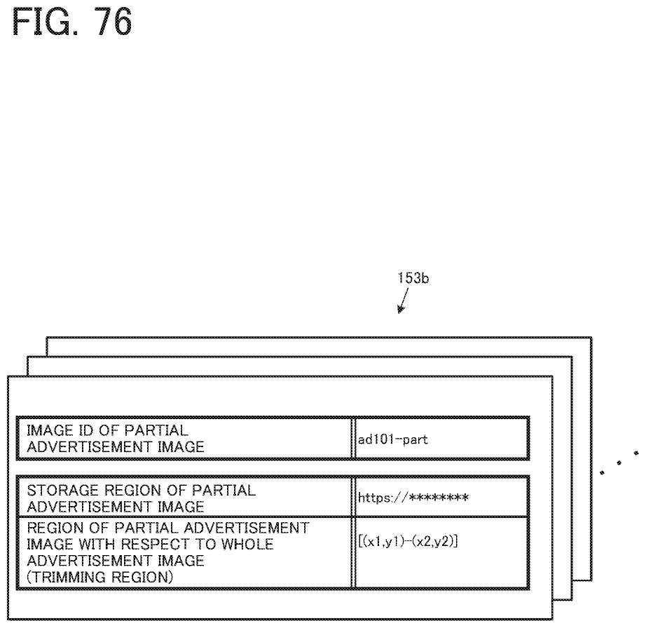

The partial advertisement database 153b shown in FIG. 76 stores the storage region of the partial advertisement image and a trimming region of the partial advertisement image in association with the image ID of the partial advertisement image, for example, without limitation thereto.

Here, FIGS. 25 and 29 described above show an example of the relationship between the size of the partial advertisement image and the billing amount, for example, without limitation thereto.

The controller 11 of the server 10 determines the billing amount in the case where the whole advertisement image corresponding to the partial advertisement image is displayed based on the set size of the partial advertisement image, and associates the determined billing amount with the whole advertisement image.

Specifically, the billing amount can basically be set based on the vertical width of the partial advertisement image, similarly to the method described in FIG. 25, for example, without limitation thereto.

Note that, similarly to the method described in FIG. 29 for example, without limitation thereto, the billing amount may optionally be determined with consideration given not only to the vertical width of the partial advertisement image but also to the horizontal width of the partial advertisement image.

Alternatively or additionally, in the case of a vertically elongated image in which the vertical width of the partial advertisement image is larger than the horizontal width, the billing amount can be higher than that in the case of a horizontally elongated image, for example, without limitation thereto.

(2) Setting of Partial Advertisement Image by Server

As described above, the advertiser can set which region of the whole advertisement image the partial advertisement image is to be, as appropriate. In this case, the advertiser can set the partial advertisement image by operating the above-described setting device, for example, without limitation thereto.

In this embodiment, a case is illustrated in which a partial advertisement image having a vertical width that is approximately ½ of the vertical width of the page display region is set.

The setting device transmits a registration request including the data of the whole advertisement image and the data of the partial advertisement image to the server 10 based on an operation performed by the advertiser.

When the server 10 receives the registration request from the setting device through the communication I/F 14, the server 10 stores the data of the whole advertisement image and the data of the partial advertisement image included in the received registration request in the whole advertisement database 153a (see FIG. 3) and the partial advertisement database 153b (see FIG. 68), respectively.

Alternatively or additionally, the server 10 specifies the advertiser ID from the unique address of the setting device that is the transmission source, assigns a unique advertisement number, and stores the advertisement number, the advertiser ID, the image ID of the partial advertisement image, the image ID of the whole partial advertisement image, and the main content ID in association with each other in the main content database 152, for example, without limitation thereto.

(3) Setting ofAdvertisement Arrangement Region by Server

When the partial advertisement image is set, the controller 11 of the server 10 sets the advertisement arrangement region of the main content information (web page) associated with the partial advertisement image based on the size of the partial advertisement image, for example, without limitation thereto.

In this example, the server 10 sets the size of the advertisement arrangement region to the same size as the partial advertisement image, for example, without limitation thereto.

Alternatively or additionally, the server 10 determines the position of the advertisement arrangement region. Specifically, the server 10 determines the position of the advertisement arrangement region in the main content information such that the vertical width from the top portion of the web page to the advertisement arrangement region is larger than the vertical width of the page display region in a state where the web page is in the initial position, for example, without limitation thereto. That is, the user cannot view the partial advertisement image in the state where the web page is in the initial position, but can view the partial advertisement image by moving the web page upward using the scroll operation. The server 10 stores the determined position of the advertisement arrangement region in association with the main content ID in the main content database 152.

(4) Setting of Playback Start Condition by Server

When the advertisement arrangement region is set, the controller 11 of the server 10 sets the playback start condition of the partial moving image based on the vertical width of the advertisement arrangement region.

In this example, since the vertical width of the advertisement arrangement region is as large as about ½ of the page display region of the terminal 20, the server 10 sets the playback start condition such that playback of the partial moving image of the partial advertisement image is started when a predetermined percentage (non-limiting examples of which include 70%) of the vertical width of the advertisement arrangement region is displayed in the page display region. The server 10 stores the set playback start condition in association with the main content ID in the main content database 152.

That is, playback of the partial moving image of the partial advertisement image arranged in the advertisement arrangement region is started when the advertisement arrangement region with a vertical width that is 70% of the vertical width of the advertisement arrangement region appears from the lower side of the page display region of the terminal 20. In this example, the size of the advertisement arrangement region and the size of the partial advertisement image are the same, and therefore when the partial advertisement image with a vertical width that is 70% appears from the lower side of the page display region of the terminal 20, playback of the partial moving image of the partial advertisement image that has appeared is started. Alternatively or additionally, since 70% of the vertical width of the partial advertisement image is visible, playback of the partial moving image can be started at the timing when the region to which the attention of the user is to be drawn becomes visible.

### Effects of Sixteenth Embodiment

The sixteenth embodiment shows a configuration in which transmission of the advertisement content data (non-limiting examples of which include the whole advertisement data including the whole advertisement image) to the terminal 20 of the user is requested by the advertiser, and the partial advertisement image of the advertisement content information is set by the advertiser.

As an example of the effect obtained by such a configuration, the region of the first content information that the business operator (non-limiting examples of which include the advertiser) wants to draw the attention of the user to can be set as the first information.

The sixteenth embodiment shows a configuration in which a billing amount based on transmission of the whole advertisement image to the terminal 20 is set based on the length of a side of the partial advertisement image or the size of the partial advertisement image.

As an example of the effect obtained by such a configuration, an appropriate billing amount is set for the first information, which has a high advertisement effect and is likely to be displayed in the first content information, for example, without limitation thereto.

The sixteenth embodiment shows a configuration in which the whole advertisement data includes the data of the whole advertisement image, and the whole advertisement image is associated with the partial advertisement image by the advertisement number.

As an example of the effect obtained by such a configuration, the terminal can first display the first information and thereafter display the first content information corresponding to the first information.

The sixteenth embodiment shows a configuration in which a billing amount based on transmission of the whole advertisement image to the terminal 20 is set based on the length of a side of the partial advertisement image or the size of the partial advertisement image.

As an example of the effect obtained by such a configuration, an appropriate billing amount is set for the first information, which has a high advertisement effect and is likely to be displayed in the first content information, for example, without limitation thereto.

The sixteenth embodiment shows a configuration in which the whole advertisement data includes the data of the whole advertisement image, and the whole advertisement image is associated with information relating to billing in the server 10 that transmits the whole advertisement data to the terminal 20.

As an example of the effect obtained by such a configuration, information relating to billing based on the first content information being displayed can be managed on the server side.

Sixteenth Variation (1)

In the sixteenth embodiment, an example was shown which the vertical width of the advertisement arrangement region is large (approximately ½ of the vertical width of the page display region of the terminal 20), but there is no limitation to such a mode. The vertical width of the advertisement arrangement region may be small.

In this variation, the advertiser sets a partial advertisement image having a vertical width that is approximately ⅙ of the vertical width of the page display region of the terminal 20, for example, without limitation thereto.

The server 10 sets the size of the advertisement arrangement region to the same size as the partial advertisement image, for example, without limitation thereto. Then, the server 10 determines the position of the advertisement arrangement region in the main content information such that, in a state where the web page is in the initial position, the vertical width from the top portion of the web page to the advertisement arrangement region is larger than the vertical width of the page display region, for example, without limitation thereto. The server 10 stores the determined position of the advertisement arrangement region in association with the main content ID in the main content database 152.

Since the vertical width of the advertisement arrangement region is as small as about ⅙ of the page display region of the terminal 20, the server 10 sets the playback start condition such that playback of the partial moving image of the partial advertisement image is started when the entire vertical width of the advertisement arrangement region, that is, 100% of the vertical width is displayed in the page display region, for example, without limitation thereto. The server 10 stores the set playback start condition in association with the main content ID in the main content database 152.

That is, when all of the advertisement arrangement region appears from the lower side of the page display region of the terminal 20, playback of the partial moving image of the partial advertisement image arranged in the advertisement arrangement region is started. In this example, the size of the advertisement arrangement region and the size of the partial advertisement image are the same, and therefore when all of the partial advertisement image appears from the lower side of the page display region of the terminal 20, playback of the partial moving image of the partial advertisement image that has appeared is started. Then, since all of the partial advertisement image is visible, playback of the partial moving image can be started at a timing when the region to which the attention of the user is to be drawn becomes visible.

In the above-described example, if the vertical width of the partial advertisement image is approximately ½ of the vertical width of the page display region, playback of the partial moving image is started when about 70% of the vertical width of the partial advertisement image is displayed in the page display region, whereas if the vertical width of the advertisement arrangement region is approximately ⅙ of the vertical width of the page display region, playback of the partial moving image is started when 100% of the vertical width of the partial advertisement image is displayed in the page display region.

In this manner, if the vertical width of the partial advertisement image is larger than a certain reference, the playback start condition is that a portion of the partial advertisement image is displayed in the page display region, whereas if the vertical width of the partial advertisement image is smaller than a certain reference, the playback start condition can be that the entirety of the partial advertisement image is displayed in the page display region.

Note that instead of setting the threshold value of the playback start condition in the case where the vertical width of the partial advertisement image is narrower than a certain reference to 100%, the threshold value may optionally be set to a value that is about 80% to 90%, for example, without limitation thereto.

In the above description, a coefficient having a negative correlation with the vertical width of the partial advertisement image (a coefficient having a value that decreases the larger the vertical width of the partial advertisement image is; a value of 0 to 1) is introduced, for example, without limitation thereto. Then, the predetermined percentage may optionally be calculated by multiplying the coefficient corresponding to the set vertical width of the partial advertisement image by 100%.

Although an example was shown in which the playback start condition of the partial moving image is determined by the ratio between the vertical width of the partial advertisement image displayed in the page display region and the vertical width of the partial advertisement image, there is no limitation to such a mode. The playback start condition of the partial moving image may be determined by the ratio between the area of the partial advertisement image displayed in the page display region and the area of the entirety of the partial advertisement image.

This variation shows a configuration in which control of playback of the partial moving image of the partial advertisement image 242b is changed based on the size of the partial advertisement image 242b that is a partial moving image or the length of a side of the partial advertisement image 242b that is a partial moving image.

As an example of the effect obtained by such a configuration, the timing of the playback control of the first partial moving image can be changed according to the size of the length of a side of the first partial moving image. It is possible to prevent the start of playback from being delayed due to the size or the length of a side of the first partial moving image being large, and to prevent the start of playback from being too early due to the side of the length of a side of the first partial moving image being small, for example, without limitation thereto.

Sixteenth Variation (2)

In the sixteenth embodiment, an example was shown in which the partial advertisement image is set by the advertiser, but the present disclosure is not limited to such a mode. The partial advertisement image may be set based on the whole advertisement image by the server 10 storing the whole advertisement image.

If the whole advertisement image is a still image, based on a binarized image obtained by binarizing the whole advertisement image using a predetermined threshold value, the controller 11 of the server 10 may recognize a region having a high line segment density in the binarized image as a region of interest, and may set a rectangular region including the region of interest as a partial advertisement image, for example, without limitation thereto.

Alternatively or additionally, if the whole advertisement image is a moving image, the controller 11 of the server 10 may recognize a region where the difference in pixel values is large between prior and subsequent images (or between frames) based on the display order as a region of interest and may set a rectangular region including the region of interest as a partial moving image, for example, without limitation thereto.

Alternatively or additionally, the controller 11 of the server 10 may trim a portion (non-limiting examples of which include the central portion) of the whole advertisement image into a rectangular shape without performing the above-described image processing, and may set the trimmed region as a partial advertisement image, for example, without limitation thereto.

This variation shows a configuration in which the partial advertisement image is set by the server 10 that transmits the whole advertisement data to the terminal 20.

As an example of the effect obtained by such a configuration, it is possible to eliminate the need for an operation of setting the first information performed by the business operator (non-limiting examples of which include the advertiser).

Sixteenth Variation (3)

In the sixteenth embodiment, an example was shown in which one piece of advertisement information is displayed in association with one piece of main content information on the terminal 20, but there is no limitation to such a configuration, and a plurality of pieces of advertisement information may be displayed in association with one piece of main content information.

In the main content database 152, two different advertisement numbers (hereinafter referred to as a first advertisement number and a second advertisement number) may be associated with one main content ID, and if the main content data of that main content ID is distributed to the terminal 20, the first advertisement content data (data of the first whole advertisement image, data of the first partial advertisement image that is a portion of the first whole advertisement image) associated with the first advertisement number, and the second advertisement content data (data of the second whole advertisement image, data of the second partial advertisement image that is a portion of the second whole advertisement image) associated with the second advertisement number may be distributed to the terminal 20, for example, without limitation thereto.

Others

The transparent region described in the above-described embodiment need only be configured such that the user can view the information in the lower layer (first layer). If the opacity (100%: completely opaque, 0%: completely transparent) of the upper layer (second layer) is set, the opacity does not necessarily need to be set to 0%, and the opacity need only be set within a range in which the user can view the information in the lower layer, for example, without limitation thereto. It is sufficient to set the opacity to value that is 50% or less, for example, without limitation thereto.

Note that the transparency may optionally be set instead of the opacity.

Alternatively or additionally, the opacity and transparency may optionally be freely set by the user.

In the above-described embodiment, an example was shown in which the first input for moving a web page (a non-limiting example of second content information) or an advertisement image (a non-limiting example of first content information or first information) is an operation (non-limiting examples of which include a scroll operation, a swipe operation, or a flick operation) of moving a touching finger in the upward direction or the downward direction in a state of touching the screen. However, there is no limitation to this, and the web page or the advertisement image may optionally be moved using a long touch operation of touching the screen for a predetermined amount of time without moving the finger, for example, without limitation thereto. Alternatively or additionally, the web page or advertisement image may optionally move based on voice input performed by the user.

Alternatively or additionally, in the above-described embodiment, an example was shown in which the second input for displaying the entirety of the whole advertisement image (a non-limiting example of the first content information) is a tap operation of tapping the screen once. However, there is no limitation to this, and the second input may optionally be a double tap operation in which the screen is tapped twice, or a long touch operation. Alternatively or additionally, the entirety of the whole advertisement image (a non-limiting example of the first content information) may optionally be displayed based on voice input performed by the user.

What is claimed is:

1. A control method for a terminal for displaying content in a display region of a display of the terminal, the display region having a longitudinal direction and a lateral direction, the control method comprising:
receiving, via a communication device of the terminal, first content data of first content information, the first content information being an image having a first side and a second side that is shorter than the first side;
displaying, in a first area of the display region, first information which is a portion of the first content information that is based on the first content data;
displaying, in a second area of the display region, second content information, the second area being different from the first area;
based on a first input performed by a user of the terminal on the display region, moving, by a controller of the terminal, the first information and the second content information in the display region; and
based on a second input performed by the user on the first information, displaying the first content information in the display region with the first side arranged along the longitudinal direction and the second side arranged along the lateral direction.

2. The control method according to claim 1, wherein the first content data is first moving image data,
the first content information is a first moving image that is based on the first moving image data, and
the first information is a first partial moving image that is a partial region of the first moving image.

3. The control method according to claim 2, wherein the displaying the first content information in the display region comprises:
playing back, by the controller, the first partial moving image based on display of the first partial moving image in the display region, which is based on the first input.

4. The control method according to claim 3, wherein the playing back the first partial moving image comprises:
playing back, by the controller, the first partial moving image based on a size at which the first partial moving image is displayed in the display region.

5. The control method according to claim 3, wherein the playing back the first partial moving image comprises:
playing back, by the controller, the first partial moving image based on at least a length of one side of the first partial moving image being displayed in the display region.

6. The control method according to claim 3, wherein the playing back the first partial moving image comprises:
playing back, by the controller, the first partial moving image based on a partial region of the first partial moving image being displayed in the display region.

7. The control method according to claim 3, wherein the playing back the first partial moving image comprises:
changing, by the controller, a size of the first partial moving image based on the size of the first partial moving image or a length of one side of the first partial moving image.

8. The control method according to claim 1, wherein the receiving the first content data comprises receiving the first content data based on a request by a business operator, and
the first information of the first content information is set by the business operator.

9. The control method according to claim 8, wherein for the business operator, a billing amount associated with display of the first content data in the display region of the display of the terminal is set based on a length of a side of the first information or a size of the first information.

10. The control method according to claim 1, wherein the receiving of the first content data comprises receiving the first content data from a server, the first information is set by the server.

11. The control method according to claim 1, wherein information relating to the first information is associated with the first content data.

12. The control method according to claim 1, wherein billing information relating to billing that is based on a length of a side of the first information or a size of the first information is associated with the first content data.

13. The control method according to claim 12, wherein the receiving the first content data comprises receiving the first content data from a server, and
the billing information is associated with the first content data in the server.

14. The control method according to claim 2, wherein the first partial moving image has a third side that is shorter than the first side and a fourth side that is shorter than the second side, and is displayed in the display region with the third side arranged along the longitudinal direction and the fourth side arranged along the lateral direction.

15. The control method according to claim 1, wherein the first input is a scroll operation performed by the user of the terminal; and
the moving the first information and the second content information comprises, based on a direction of the scroll operation, moving the first information and the second content information in the display region.

16. The control method according to claim 1, wherein the second input an operation of touching the first information displayed in the display region .

17. The control method according to claim 1, wherein the first content information is advertisement information.

18. A non-transitory computer-readable recording medium having recorded thereon a program to be executed by a terminal for displaying content in a display region of a display of the terminal, the display region having a longitudinal direction and a lateral direction, the program, when executed, causing the terminal to:
receive, via a communication device of the terminal, first content data of first content information, the first content information being an image having a first side and a second side that is shorter than the first side;
display, in a first area of the display region, first information which is a portion of the first content information that is based on the first content data;
display, in a second area of the display region, second content information, the second area being different from the first area;
based on a first input performed by a user of the terminal on the display region, move, by a controller of the terminal, the first information and the second content information in the display region; and
based on a second input performed by the user on the first information, display the first content information in the display region with the first side arranged along the longitudinal direction and the second side arranged along the lateral direction.

19. A terminal for displaying content, the terminal comprising:
a communication device configured to receive first content data of first content information, the first content information being an image having a first side and a second side that is shorter than the first side;
a display having a display region having a longitudinal direction and a lateral direction; and
a controller configured to:
control the display to display, in a first area of the display region, first information which is a portion of the first content information that is based on the first content data; and
control the display to display, in a second area of the display region, second content information, the second area being different from the first area; and
based on a first input performed by a user of the terminal on the display region, move the first information and the second content information in the display region, and
based on a second input performed by the user on the first information, display the first content information in the display region with the first side arranged along the longitudinal direction and the second side arranged along the lateral direction.
